(19) United States
(12) Patent Application Publication
(10) Pub. No.: US 2026/0073869 A1
(43) Pub. Date: Mar. 12, 2026

(54) DISPLAY DEVICE

(71) Applicant: Japan Display Inc., Tokyo (JP)

(72) Inventor: Tatsuya ISHII, Tokyo (JP)

(21) Appl. No.: 19/311,638

(22) Filed: Aug. 27, 2025

(30) Foreign Application Priority Data
Sep. 11, 2024 (JP) 2024-157687

(51) Int. Cl. G09G 3/3233; G09G 3/3266

(52) U.S. Cl. CPC G09G 3/3233; G09G 3/3266; G09G 2300/0426; G09G 2300/0819; G09G 2300/0852; G09G 2310/0286; G09G 2310/08; G09G 2330/021

(57) ABSTRACT

A display device includes a plurality of pixels. Each of the plurality of pixels includes a first transistor connected between an image data signal line and a second capacitive element, a second transistor including a gate electrode connected to a first capacitive element and connected between a fourth transistor connected to the second capacitive element and a fifth transistor connected to a light-emitting element, a third transistor connected between the first capacitive element and the fifth transistor, the fourth transistor connected between an initialization voltage power supply line and the second transistor, a sixth transistor connected between a reference voltage power supply line and the first capacitive element, a seventh transistor connected between a reference voltage line and the fourth transistor, an eighth transistor connected between a power supply line and the light-emitting element, and the first capacitive element connected between the second capacitive element and the gate electrode.

### CROSS-REFERENCE TO RELATED APPLICATIONS

This application claims the benefit of priority to Japanese Patent Application No. 2024-157687 filed on Sep. 11, 2024, the entire contents of which are incorporated herein by reference.

### FIELD

An embodiment of the present invention relates to a display device.

### BACKGROUND

In recent years, a display device including a light-emitting element has been mounted on a television, a smartphone, or the like, and is becoming popular. For example, the display device includes a plurality of pixels and a control circuit for driving the plurality of pixels. Each of the plurality of pixels includes a plurality of transistors, a capacitive element, and a light-emitting element. The light-emitting element is an element that emits light in a self-luminous manner, and is, for example, a light-emitting diode (Light Emitting Diode: LED), a minute light-emitting diode (micro-LED), or an organic electroluminescence (Electro Luminescence: EL) element. A control circuit in the display device can supply a voltage to each of the plurality of pixels, and can supply a current corresponding to the supplied voltage to the light-emitting elements included in each of the plurality of pixels. Each of the light-emitting elements emits light with a luminance corresponding to a current flowing through the light-emitting element, and a pixel including the light-emitting element can display an image with a gradation corresponding to the luminance.

For example, a display device (AMOLED) is known. Pixels in an active-matrix organic light-emitting diode display device include seven transistors (T1 to T7), two capacitive elements (CVdt, CVth) connected in series, and one light-emitting element (Pix.OLED). In addition, a driving method for the active matrix type organic light emitting diode display device includes a programming period (Programming phase) in which a driving voltage Vdd is supplied to a contact point (N2) of two capacitive elements by the transistor T5 or T6, and acquisition of image data (Vdt refresh) and detection of a threshold voltage (Vth detection) are executed independently.

### SUMMARY

A display device according to an embodiment of the present invention includes a plurality of pixels arranged in a matrix in a first direction and a second direction intersecting the first direction, an image data signal line, a second terminal of a second capacitive element, and a second terminal of a fourth transistor supplied with a data voltage, an initialization voltage power supply line supplied with an initialization voltage, a reference voltage power supply line and a first terminal of the second capacitive element supplied with a reference voltage, a standard voltage line supplied with a standard voltage, and a power supply line, a first terminal of a first capacitive element, a first terminal of a fifth transistor, and a first terminal of a light-emitting element supplied with a constant voltage. Each of the plurality of pixels includes a first transistor controlled by a first control signal and electrically connected between the image data signal line and the second terminal of the second capacitive element, a second transistor including a gate electrode electrically connected to the first terminal of the first capacitive element and electrically connected between the second terminal of the fourth transistor electrically connected to the second terminal of the second capacitive element and the first terminal of the fifth transistor, a third transistor controlled by a second control signal and electrically connected between the first terminal of the first capacitive element and the first terminal of the fifth transistor, the fourth transistor controlled by a third control signal and electrically connected between the initialization voltage power supply line and a first terminal of the second transistor, the fifth transistor controlled by a fourth control signal and electrically connected between a second terminal of the second transistor and the first terminal of the light-emitting element, a sixth transistor controlled by a fifth control signal and electrically connected between the reference voltage power supply line and the first terminal of the second transistor, a seventh transistor controlled by a sixth control signal and electrically connected between the reference voltage line and the second terminal of the fourth transistor, an eighth transistor controlled by the fifth control signal and electrically connected between the power supply line and the first terminal of the light-emitting element, the first capacitive element electrically connected between the first terminal of the second capacitive element and the gate electrode, the second capacitive element electrically connected between the second terminal of the first capacitive element and the second terminal of the first transistor, and the light-emitting element electrically connected between the power supply line and a second terminal of the fifth transistor.

A display device according to one embodiment of the present invention includes a plurality of pixels arranged in a matrix in a first direction and a second direction intersecting the first direction, an image data signal line, a first terminal of a first capacitive element and a second terminal of a fourth transistor supplied with a data voltage, an initialization voltage power supply line supplied with an initialization voltage, a reference voltage power supply line and a second terminal of the first capacitive element supplied with a reference voltage, a reference voltage line supplied with a reference voltage, a power supply line, a second terminal of the second capacitive element, a first terminal of a fifth transistor and a first terminal of a light-emitting element supplied with a constant voltage, and a reset voltage power supply line supplied with a reset voltage. Each of the plurality of pixels includes a first transistor controlled by a first control signal and electrically connected between the image data signal line and the second terminal of the second capacitive element; a second transistor including a gate electrode electrically connected to the second terminal of the second capacitive element and electrically connected between the second terminal of the fourth transistor and the first terminal of the fifth transistor; a third transistor controlled by a second control signal and electrically connected between the gate electrode and the first terminal of the fifth transistor; the fourth transistor controlled by a third control signal and electrically connected between the initialization voltage power supply line and the first terminal of the second transistor; the fifth transistor controlled by a fourth control signal and electrically connected between the second terminal of the second transistor and the first terminal of the light-emitting element; a sixth transistor controlled by a fifth control signal and electrically connected between the reference voltage power supply line and the second terminal of the first capacitive element; a seventh transistor controlled by the fourth control signal and electrically connected between the reference voltage line and the second terminal of the fourth transistor; an eighth transistor controlled by the fifth control signal and electrically connected between the power supply line and the first terminal of the light-emitting element, a ninth transistor controlled by the second control signal and electrically connected between the reset voltage power supply line and the first terminal of the fifth transistor; the second capacitive element electrically connected between the second terminal of the first capacitive element and the gate electrode; the first capacitive element electrically connected between the first terminal of the second capacitive element and the second terminal of the fourth transistor; and a light-emitting element electrically connected between the power supply line and a second terminal of the fifth transistor.

### BRIEF DESCRIPTION OF DRAWINGS

FIG. 1 is a schematic diagram showing a configuration of a display device according to a first embodiment of the present invention.

FIG. 2 is a schematic diagram showing an input signal to a pixel circuit according to the first embodiment of the present invention.

FIG. 3 is a circuit diagram showing a configuration of the pixel circuit according to the first embodiment of the present invention.

FIG. 4 is a timing chart of the display device according to the first embodiment of the present invention.

FIG. 5 is a timing chart of the display device according to the first embodiment of the present invention.

FIG. 6 is a timing chart of the display device according to the first embodiment of the present invention.

FIG. 7 is a timing chart of the display device according to the first embodiment of the present invention.

FIG. 8 is a timing chart of the display device according to the first embodiment of the present invention.

FIG. 9 is a layout diagram of a pixel according to the first embodiment of the present invention.

FIG. 10 is an end view showing an end face cut along A1-A2 in the layout shown in FIG. 9.

FIG. 11 is an end view showing an end face cut along B1-B2 in the layout shown in FIG. 9.

FIG. 12 is an end view showing an end face cut along C1-C2 in the layout shown in FIG. 9.

FIG. 13 is a sequence diagram showing a method for manufacturing the display device according to the first embodiment of the present invention.

FIG. 14 is a layout diagram of the pixel according to the first embodiment of the present invention.

FIG. 15 is a layout diagram of the pixel according to the first embodiment of the present invention.

FIG. 16 is a layout diagram of the pixel according to the first embodiment of the present invention.

FIG. 17 is a plot showing a relationship between a potential difference and a capacitance value according to the first embodiment of the present invention.

FIG. 18 is a schematic diagram showing a configuration of a display device according to a second embodiment of the present invention.

FIG. 19 is a block diagram showing a configuration of a control circuit according to the second embodiment of the present invention.

FIG. 20 is a circuit diagram showing a circuit configuration of a scan driver according to the second embodiment of the present invention.

FIG. 21 is a schematic diagram showing an input signal to a pixel circuit according to the second embodiment of the present invention.

FIG. 22 is a circuit diagram showing a configuration of the pixel circuit according to the second embodiment of the present invention.

FIG. 23 is a timing chart of the display device according to the second embodiment of the present invention.

FIG. 24 is a timing chart of the display device according to the second embodiment of the present invention.

FIG. 25 is a timing chart of the control circuit according to the second embodiment of the present invention.

FIG. 26 is a timing chart of the pixel circuit according to the second embodiment of the present invention.

FIG. 27 is a timing chart of the pixel circuit according to the second embodiment of the present invention.

FIG. 28 is a timing chart of the pixel circuit according to the second embodiment of the present invention.

FIG. 29 is a schematic diagram showing a configuration of a display device according to a third embodiment of the present invention.

FIG. 30 is a schematic diagram showing an input signal to a pixel circuit according to the third embodiment of the present invention.

FIG. 31 is a circuit diagram showing a configuration of the pixel circuit according to the third embodiment of the present invention.

FIG. 32 is a timing chart of the pixel circuit according to the third embodiment of the present invention.

FIG. 33 is a timing chart of the pixel circuit according to the third embodiment of the present invention.

FIG. 34 is a timing chart of the pixel circuit according to the third embodiment of the present invention.

FIG. 35 is a timing chart of the pixel circuit according to the third embodiment of the present invention.

FIG. 36 is a schematic diagram showing an input signal to a pixel circuit according to a fourth embodiment of the present invention.

FIG. 37 is a circuit diagram showing a configuration of the pixel circuit according to the fourth embodiment of the present invention.

FIG. 38 is a timing chart of a display device according to the fourth embodiment of the present invention.

FIG. 39 is a timing chart of the pixel circuit according to the fourth embodiment of the present invention.

FIG. 40 is a timing chart of the pixel circuit according to the fourth embodiment of the present invention.

FIG. 41 is a timing chart of the pixel circuit according to the fourth embodiment of the present invention.

### DESCRIPTION OF EMBODIMENTS

Hereinafter, embodiments of the present invention will be described with reference to the drawings and the like. However, the present invention can be implemented in many different aspects, and should not be construed as being limited to the description of the embodiments exemplified below. Further, in order to make the description clearer, the drawings may be schematically represented with respect to the width, thickness, shape, configuration, and the like of each part as compared with the actual embodiment, but the drawings are merely examples, and do not limit the interpretation of the present invention. In addition, the terms “first” and “second” attached to each element are convenient labels used to distinguish each element, and do not have any further meaning unless otherwise described.

Also, in the present specification, the expression “a includes A, B, or C,” “a includes any of A, B, or C,” “a includes one selected from a group consisting of A, B, and C,” and the like does not exclude cases where a includes a plurality of combinations of A to C unless otherwise specified. Furthermore, these expressions do not exclude the case where a includes other elements.

In the case where the terms “identical (same)” and “match” are used in the specification of this application, the same and match may include errors within the scope of the design.

For example, a display device according to one embodiment of the present disclosure is a display device using an EL device as a self-luminous light-emitting element. For example, a display device using EL elements may be referred light to as a self-luminous display device, an EL display device, or the like.

### 1. First Embodiment

### [1-1. Overview of Display Device 10]

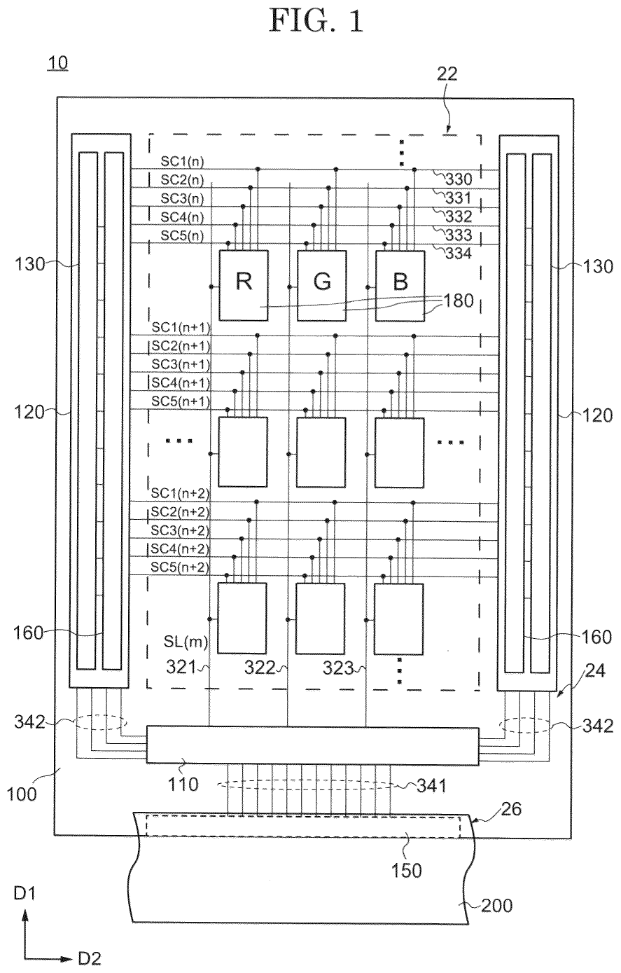

An overview of a display device 10 according to a first embodiment will be described with reference to FIG. 1. FIG. 1 is a schematic diagram showing a configuration of the display device 10. The configuration of the display device 10 shown in FIG. 1 is an example, and the configuration of the display device 10 is not limited to the configuration shown in FIG. 1.

The display device 10 includes an array substrate 100, a flexible printed circuit board 200 (FPC 200), and an IC chip 110. Further, the display device 10 includes a display region 22 arranged on the array substrate 100, a peripheral region 24 surrounding the display region 22, and a terminal region 26.

In the display region 22, a plurality of pixels 180 is arranged in a matrix along a first direction D1 (column direction) and a second direction D2 (row direction) intersecting the first direction D1. The pixel 180 is the smallest unit constituting a part of an image to be displayed in the display region 22. Each of the plurality of pixels 180 may correspond to, for example, a sub-pixel R, a sub-pixel G, and a sub-pixel B. One pixel may be formed by three sub-pixels. The arrangement of the pixels 180 is not limited, and the arrangement of the plurality of pixels 180 is, for example, a stripe arrangement. The arrangement of the display device 10 may be a delta arrangement, a pentile arrangement, or the like.

The sub-pixel R, the sub-pixel G, and the sub-pixel B are configured to display images of different colors. For example, each of the sub-pixel R, the sub-pixel G, and the sub-pixel B includes a light-emitting element including a light-emitting layer that emits red light, green light, and blue light. An arbitrary voltage or current is supplied to each of the three sub-pixels, and the display device 10 can display an image.

The peripheral region 24 is arranged with the IC chip 110 and two control circuit 120. The two control circuits 120 are arranged on the left and right sides of the display region 22. The IC chip 110 is connected to a terminal portion 150 using a connection wiring 341. Each of the two control circuits 120 is connected to the IC chip 110 using a connection wiring 342. The peripheral region 24 may be referred to as a frame region. The connection wiring 341 may be referred to as the connection wiring 341 alone, and a bundle of the plurality of connection wirings 341 may be referred to as the connection wiring 341. Similar to the connection wiring 341, the connection wiring 342 may be referred to as the connection wiring 342 alone, and a bundle of the plurality of connection wirings 342 may be referred to as the connection wiring 342.

The terminal region 26 is arranged with the terminal portion 150 and the FPC 200 electrically connected to the terminal portion 150. The terminal region 26 is a region opposed to a region where the display region 22 is arranged with respect to the peripheral region 24 along the first directional D1.

The FPC 200 is connected to an external device (not shown) outside the display device 10. The display device 10 is connected to an external device via the FPC 200 and the terminal portion 150 connected to the FPC. A control signal and a voltage are transmitted from the external device to the display device 10 via the FPC 200 and the terminal portion 150 connected to the FPC. The display device 10 drives each of the pixels 180 arranged in the display device 10 by using the received control signal and voltage from the external device. As a result, the display device 10 can display an image in the display region 22.

The IC chip 110 supplies signals, voltages, and the like for driving the respective pixels 180 to the two control circuits 120 and the respective pixels 180 (pixel circuits 181) via the FPC 200, the terminal portion 150, and the connection wiring 341.

Each of the IC chip 110 and the two control circuits 120 may be referred to as a control circuit alone, and a circuit group including a part or all of each of the IC chip 110 and the two control circuits 120 may be referred to as a control circuit.

### [1-2. Configuration of IC Chip 110]

Referring to FIG. 1, an overview of the IC chip 110 will be described. The IC chip 110 is arranged at a position adjoining the display region 22 along the first directional D1. Image data signal lines 321, 322, and 323 extend from the IC chip 110 in the first direction D1 and are connected to the plurality of pixels 180 arranged in the first direction D1.

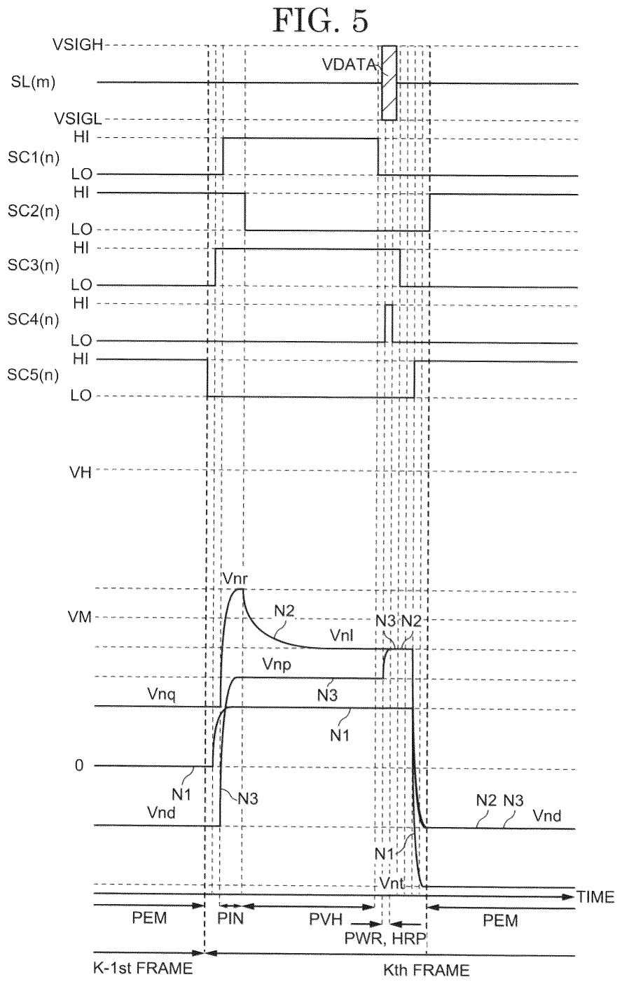

For example, the IC chip 110 includes a plurality of selection circuit (not shown). For example, each of the plurality of selection circuits is a switch controlled based on an on signal and an off signal supplied to a selection signal. The selection circuit is selected by the on signal supplied to the selection signal and supplies an image data signal SL(m) including a data signal VDATA to the image data signal line 321 and the pixel 180 electrically connected to the image data signal line 321. The selection signal and the image data signal SL(m) are transmitted from the external device to the IC chip 110 via the FPC 200 and the terminal portion 150 connected to the FPC. For example, the data signal VDATA (the image data signal SL(m)) includes a data voltage equal to or higher than a voltage VSIGL (see FIG. 5) and equal to or lower than a voltage VSIGH (see FIG. 5). The voltage VSIGH is greater than the voltage VSIGL. The voltage VSIGL may be referred to as a first voltage and the voltage VSIGH may be referred to as a second voltage.

For example, the on signal is a signal including a voltage that conducts the selection circuit (switch), and the off signal is a signal including a voltage that cuts off the selection circuit (switch). In the present disclosure, the on signal may be a high-level voltage (potential) (high, High, HI), the off signal may be a low-level voltage (potential) (low, Low, LO), the on signal may be a low-level voltage (potential) (low, Low, LO), and the off signal may be a high-level voltage (potential) (high, High, HI). The high level voltage is greater (higher) than the low level voltage. In the display device according to one embodiment of the present specification, as an example, the on signal is a high-level voltage and the off signal is a low-level voltage.

### [1-3. Configuration of Control Circuit 120]

An overview of the control circuit 120 will be described with reference to FIG. 1. The two control circuits 120 are arranged at positions adjoining both sides of the display region 22 along the second direction D2. A scan signal line 330, a scan signal line 331, a scan signal line 332, a scan signal line 333, and a scan signal line 334 extend from the control circuit 120 in the second direction D2 and are connected to the plurality of pixels 180 arranged in the second direction D2. As an example, each scan signal line of the display device 10 shown in FIG. 1 is connected to both of the two control circuits 120. Each scan signal line may be connected to one control circuit 120 of the two control circuits 120. That is, an n-th scan signal line may be electrically connected to the control circuit 120 on the right side of the display region 22 along the second direction D2, and an n+1-th scan signal line may be electrically connected to the control circuit 120 on the left side of the display region 22 along the second direction D2. The number n is a positive integer.

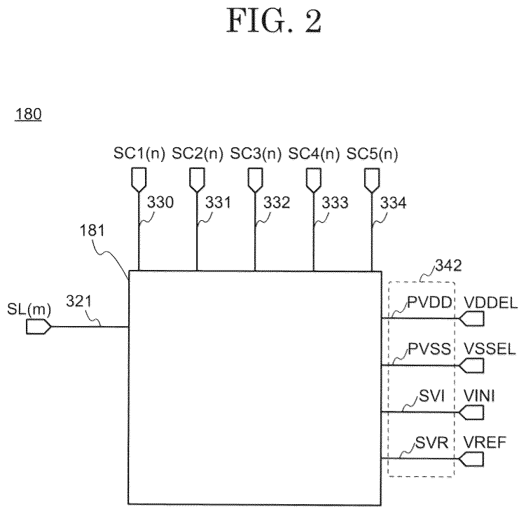

The control circuit 120 includes a shift register circuit 130 and a scan driver circuit 160. For example, the control circuit 120 is a gate driver, and receives a control signal including a clock signal, a start pulse, a plurality of enable signals, and the like, and voltages such as a driving voltage VDDEL (see FIG. 2) and a standard voltage VSSEL (see FIG. 2). The control circuit 120 can sequentially select the scanning lines according to inputs of the control signal and power supply.

The shift register circuit 130 is electrically connected to the scan driver circuit 160. The shift register circuit 130 includes a plurality of shift registers (not shown). Further, the shift register circuit 130 is supplied with a plurality of control signals described above via the plurality of connection wirings 342, the driving voltage VDDEL is supplied via a drive power supply line PVDD (see FIG. 2), and the standard voltage VSSEL is supplied via a standard voltage line PVSS (see FIG. 2). The shift register circuit 130 has a role of generating a plurality of output signals (not shown) shifted at different timings based on the plurality of control signals described above, and sequentially outputting the output signals to the scan driver circuit 160.

The scan driver circuit 160 includes a plurality of scan drivers. For example, the plurality of scan drivers is supplied with a plurality of output signals from the shift register circuit 130, the plurality of enable signals described above are supplied from the IC chip 110 via the plurality of connection wirings 342, the driving voltage VDDEL is supplied via the drive power line PVDD, and the standard voltage VSSEL is supplied via the standard voltage line PVSS. The plurality of scan drivers sequentially supply scan signals having different timings (for example, a first scan signal SC1(n), a second scan signal SC2(n), a third scan signal SC3(n), a fourth scan signal SC4(n)), and a scan signal SC5(n)) to the respective scan signal lines based on the plurality of output signals and the plurality of enable signals, and drive the pixels 180 (the pixel circuits 181) electrically connected to the respective scan signal lines. For example, the fourth scan signal SC4(n) and the scan signal line 333 to which the fourth scan signal SC4(n) is supplied are a so-called scan signal and scan signal line.

### [1-4. Configuration of Pixel 180]

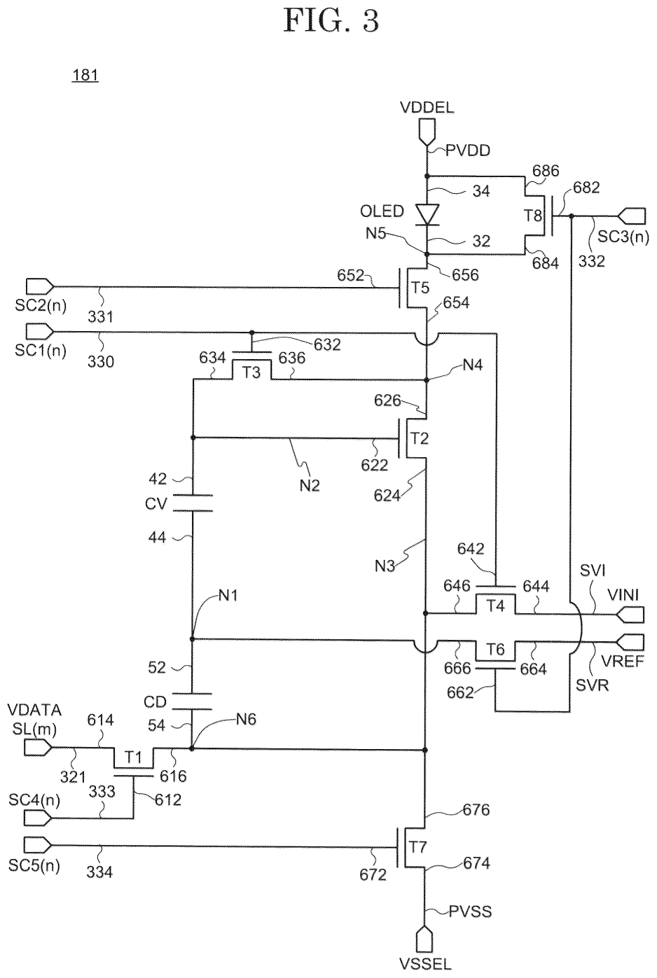

Referring to FIG. 1 to FIG. 3, an overview of the pixel 180 and the pixel circuit 181 will be described. FIG. 2 is a schematic diagram showing an input signal to the pixel circuit 181 included in the pixel 180. FIG. 3 is a circuit diagram showing a configuration of the pixel circuit 181. As an example, FIG. 2 and FIG. 3 show the configuration of the pixel circuit 181 of the pixel 180 shown in FIG. 1. The configuration of the pixel 180 and the pixel circuit 181 is not limited to the configuration shown in FIG. 1 to FIG. 3. Configurations that are the same as or similar to those in FIG. 1 will be described as necessary.

The pixel circuit 181 is a circuit for driving the pixel 180. The pixel circuits of the sub-pixel R, the sub-pixel G, and the sub-pixel B included in the pixel 180 are the same as those of the pixel circuit 181, and differ in the colors emitted by light-emitting elements OLED. In the following explanation, the light-emitting element OLED that emits red light will be described as an example.

As shown in FIG. 2, the pixel circuit 181 is supplied with the image data signal SL(m), the first scan signal SC1(n), the second scan signal SC2(n), the third scan signal SC3(n), the fourth scan signal SC4(n), the fifth scan signal SC5(n), a reference voltage VREF, and an initialization voltage VINI. Further, as a power source for driving the pixel 180, the driving voltage VDDEL and the standard voltage VSSEL are supplied to the pixel circuit 181. For example, the reference voltage VREF, the initialization voltage VINI, the driving voltage VDDEL, and the standard voltage VSSEL may be constant voltages, and may be variable voltages that vary depending on the timings of the respective signals.

The first scan signal SC1(n) is supplied to the scan signal line 330, the second scan signal SC2(n) is supplied to the scan signal line 331, the third scan signal SC3(n) is supplied to the scan signal line 332, the fourth scan signal SC4(n) is supplied to the scan signal line 333, and the fifth scan signal SC5(n) is supplied to the scan signal line 334. The first scan signal SC1(n) also functions as a seventh scan signal SC7(n) to be described later. The first scan signal SC1(n) may be referred to as a second control signal, the second scan signal SC2(n) may be referred to as a fourth control signal, the third scan signal SC3(n) may be referred to as a fifth control signal, the fourth scan signal SC4(n) may be referred to as a first control signal, and the fifth scan signal SC5(n) may be referred to as a sixth control signal.

Further, the reference voltage VREF is supplied to a reference voltage power supply line SVR, the initialization voltage VINI is supplied to an initialization voltage power supply line SVI, the driving voltage VDDEL is supplied to the drive power supply line PVDD, and the standard voltage VSSEL is supplied to the standard voltage line PVSS. For example, the reference voltage power supply line SVR, the initialization voltage power supply line SVI, the drive power supply line PVDD, and the standard voltage line PVSS are electrically connected to the connection wirings 342. Further, for example, each of the reference voltage power supply line SVR, the initialization voltage power supply line SVI, the drive power supply line PVDD, and the standard voltage line PVSS may be a separate connection wiring 342.

For example, the reference voltage VREF, the initialization voltage VINI, the driving voltage VDDEL, and the standard voltage VSSEL are supplied from an external device to the IC chip 110 via the FPC 200, the terminal portion 150, and the connection wiring 341. Further, for example, the reference voltage VREF, the initialization voltage VINI, the driving voltage VDDEL, and the standard voltage VSSEL are supplied from the IC chip 110 to the plurality of pixels 180 (pixel circuits 181) via the connection wiring 342, a precharge voltage power supply line SVP, the reference voltage power supply line SVR, the initialization voltage power supply line SVI, the drive power supply line PVDD, and the standard voltage line PVSS. In addition, although not shown, the reference voltage VREF, the initialization voltage VINI, the driving voltage VDDEL, and the standard voltage VSSEL may be connected from an external device to the plurality of pixels 180 (pixel circuit 181) via the FPC 200, the terminal portion 150, and the connection wiring 341, and may be connected to the reference voltage power supply line SVR, the initialization voltage power supply line SVI, the drive power supply line PVDD, and the standard voltage line PVSS without passing through the IC chip 110 and the connection wiring 342. For example, the reference voltage VREF, the initialization voltage VINI, and the standard voltage VSSEL are smaller than the driving voltage VDDEL.

As shown in FIG. 3, a semiconductor device includes a first transistor T1, a second transistor T2, a third transistor T3, a fourth transistor T4, a fifth transistor T5, a sixth transistor T6, a seventh transistor T7, an eighth transistor T8, a capacitive element CV, a capacitive element CD, and a light-emitting element OLED. Each of these transistors includes a gate electrode and a pair of electrodes (a source electrode and a drain electrode) including a first electrode and a second electrode. Each of the capacitive element CV, the capacitive element CD, and the light-emitting element OLED has a pair of electrodes including a first electrode and a second electrode. In addition, the capacitive element CV may be referred to as a first capacitive element, and the capacitive element CD may be referred to as a second capacitive element.

For example, the first transistor T1 is a selection transistor. The first transistor T1 has a function of supplying the image data signal SL(m) to a sixth node N6. Since the sixth node N6 of the pixel circuit 181 is connected to a third node N3, the first transistor T1 has a function of supplying the image data signal SL(m) to the third node N3.

For example, the second transistor T2 is a drive transistor. A threshold voltage VTH is acquired between a gate electrode 622 of the second transistor T2 and a first electrode (source) 624 based on the initialization voltage VINI, and the acquired threshold voltage VTH is applied to the capacitive element CV, whereby an operation of acquiring and storing the threshold voltage VTH is performed. Further, the second transistor T2 controls an amount of current flowing from the drive power supply line PVDD to the light-emitting device OLED based on the gate voltage (voltage between the gate electrode 622 and the first electrode (source) 624) and the inputted image-data signal SL(m) in which the variation in the threshold voltage VTH is corrected. That is, the second transistor T2 has a function of causing the light-emitting element OLED to emit light by causing the light-emitting element VDDEL to flow a current corresponding to a displayed gradation (luminance) from the driving voltage VDDEL to the light-emitting element OLED.

The third transistor T3 serves to conduct a second node N2 and a fourth node N4, to turn a potential difference between the gate electrode 622 of the second transistor T2 and a second electrode 626 to 0 V, to transmit a decrease in drain potential (potential of the node N4) due to discharge to the gate (the node N2) when the threshold voltage VTH is acquired, and to stop the discharge when Vgs (a difference (a potential difference) between gate potential and source potential) reaches the threshold voltage Vth.

The fourth transistor T4 has a function of conducting the third node N3 and the initialization voltage power supply line SVI, and initializing the third node N3 (the sixth node N6) by supplying the initialization voltage VINI to the third node N3 (sixth node N6).

The fifth transistor T5 has a function of conducting the fourth node N4 (the second electrode 626 of the second transistor T2) and the fifth node N5 (a first electrode 32 of the light-emitting element OLED).

The sixth transistor T6 has a function of conducting a first node N1 and the reference voltage power supply line SVR, supplying the reference voltage power supply line SVR to the first node N1, and fixing a potential of the first node N1 at the time of acquiring the threshold voltage VTH and writing the image data signal SL(m).

The seventh transistor T7 has a function of conducting the third node N3 (the sixth node N6) and the standard voltage line PVSS to provide the standard voltage VSSEL to the third node N3.

The eighth transistor T8 has a function of conducting the first electrode 32 and a second electrode 34 of the light-emitting element OLED, setting a potential difference between the light-emitting element OLED electrodes to zero, and suppressing light emission of the light-emitting element OLED in a period other than the light-emitting period, and supplying a driving voltage VDDEL to a source/drain electrode (that is, the node N4) of the second transistor T2 via the fifth transistor T5 during an initialization period prior to the operation of acquiring the threshold voltage VTH.

As will be described later, the capacitive element CV has a function of holding (storing) a charge corresponding to the threshold voltage VTH of the second transistor T2.

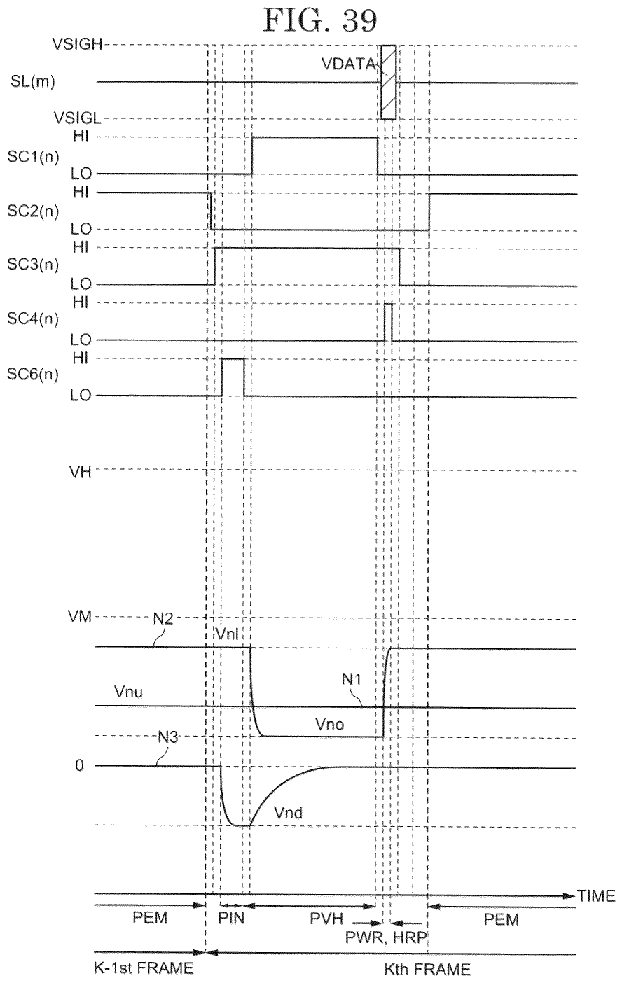

The capacitive element CD has a function of holding (storing) charges corresponding to a data voltage (a voltage equal to or higher than the voltage VSIGL (see FIG. 39) and equal to or lower than the voltage VSIGH (see FIG. 39)) included in the image data signal SL(m) supplied to the third node N3 (the sixth node N6).

The light-emitting element OLED has diode characteristics and has a function of emitting light based on a current flowing through the light-emitting element OLED. A current flowing through the light-emitting element OLED is a drain current (current Ion) of the second transistor T2. The first electrode 32 of the light-emitting element OLED is a cathode electrode, and the second electrode 34 of the light-emitting element OLED is an anode electrode.

The first transistor T1 includes a gate electrode 612, a first electrode 614, and a second electrode 616. The gate electrode 612 is electrically connected to the scan signal line 333. The first electrode 614 is electrically connected to the image data signal line 321. The second electrode 616 is electrically connected to the third node N3 (the sixth node N6), the first electrode 624 of the second transistor T2, a second electrode 646 of the fourth transistor T4, and a second electrode 54 of the capacitive element CD. The fourth scan signal SC4(n) is supplied to the scan signal line 333. Switching of the first transistor T1 is controlled using the fourth scan signal SC4(n). In other words, in the first transistor T1, a conduction state (on state) and a non-conduction state (off state) are controlled by the fourth scan signal SC4(n). In the case where the signal supplied to the fourth scan signal SC4(n) is LO, the first transistor T1 becomes non-conductive. In the case where the signal supplied to the fourth scan signal SC4(n) is HI, the first transistor T1 becomes conductive.

The second transistor T2 includes the gate electrode 622, the first electrode 624, and the second electrode 626. The gate electrode 622 is electrically connected to the second node N2, a first electrode 42 of the capacitive element CV, and a first electrode 634 of the third transistor T3. The second electrode 626 is electrically connected to the fourth node N4, a second electrode 636 of the third transistor T3, and a first electrode 654 of the fifth transistor T5. The threshold voltage of the second transistor T2 is the threshold voltage VTH. The second transistor T2 controls the amount of current flowing through the light-emitting element OLED in accordance with a potential difference Vgs between a voltage supplied to the gate electrode 622 (second node N2) and a voltage supplied to the first electrode 624 (third node N3) and a potential difference Vds between the second electrode 626 (fourth node N4) and the first electrode 624. For example, in the case where the potential difference Vgs between the voltage supplied to the second node N2 and the voltage supplied to the third node N3 is smaller than the threshold voltage VTH, the second transistor T2 becomes non-conductive and no current flows through the light-emitting element OLED, so that the pixel 180 displays black. For example, the potential difference Vgs between the voltage supplied to the second node N2 and the voltage supplied to the third node N3 is equal to or higher than the threshold voltage VTH, and the potential difference Vgs between the voltage supplied to the fourth node N4 and the voltage supplied to the third node N3 is greater than 0 V, the second transistor Tr2 becomes conductive, the current flowing through the light-emitting element OLED is controlled according to the magnitude of the potential difference Vgs between the voltage supplied to the third node N3, which is based on the gradation of the display, and the light-emitting element OLED emits light with a luminance based on the gradation of the display.

The third transistor T3 includes a gate electrode 632, the first electrode 634, and the second electrode 636. The gate electrode 632 is electrically connected to the scan signal line 330. The first scan signal SC1(n) is supplied to the scan signal line 330. The third transistor T3 is switched using the first scan signal SC1(n). In other words, the third transistor T3 is controlled to be in the conductive state (on state) or the non-conductive state (off state) by the first scan signal SC1(n). In the case where the signal supplied to the first scan signal SC1(n) is LO, the third transistor T3 becomes non-conductive, and in the case where the signal supplied to the first scan signal SC1(n) is HI, the third transistor T3 becomes conductive.

The fourth transistor T4 includes a gate electrode 642, a first electrode 644, and the second electrode 646. The gate electrode 642 is electrically connected to the scan signal line 330. The first electrode 644 is electrically connected to the initialization voltage power supply line SVI. The fourth transistor T4 is switched using the first scan signal SC1(n). In other words, the fourth transistor T4 is controlled to be in the conductive state (on state) or the non-conductive state (off state) by the first scan signal SC1(n). In the case where the signal supplied to the first scan signal SC1(n) is LO, the fourth transistor T4 becomes non-conductive, and in the case where the signal supplied to the scan signal line 330 is HI, the fourth transistor T4 becomes conductive

The fifth transistor T5 includes a gate electrode 652, the first electrode 654, and a second electrode 656. The gate electrode 652 is electrically connected to the scan signal line 331. The second electrode 656 is electrically connected to the first electrode 32 of the light-emitting element OLED and a first electrode 684 of the eighth transistor T8. The second scan signal SC2(n) is supplied to the scan signal line 331. The fifth transistor T5 is switched using the second scan signal SC2(n). In other words, in the fifth transistor T5, the conduction state (on state) and the non-conduction state (off state) are controlled by the second scan signal SC2(n). In the case where the signal supplied to the second scan signal SC2(n) is LO, the fifth transistor T5 becomes non-conductive, and in the case where the signal supplied to the second scan signal SC2(n) is HI, the fifth transistor T5 becomes conductive.

The sixth transistor T6 includes a gate electrode 662, a first electrode 664, and a second electrode 666. The gate electrode 662 is electrically connected to the scan signal line 332. The first electrode 664 is electrically connected to the reference voltage power supply line SVR. The second electrode 666 is electrically connected to the first node N1, a second electrode 44 of the capacitive element CV, and a first electrode 52 of the capacitive element CD. The third scan signal SC3(n) is supplied to the scan signal line 332. The sixth transistor T6 is switched using the third scan signal SC3(n). In other words, in the sixth transistor T6, the conduction state (on state) and the non-conduction state (off state) are controlled by the third scan signal SC3(n). In the case where the signal supplied to the third scan signal SC3(n) is LO, the sixth transistor T6 becomes non-conductive, and in the case where the signal supplied to the third scan signal SC3(n) is HI, the sixth transistor T6 becomes conductive.

The seventh transistor T7 includes a gate electrode 672, a first electrode 674, and a second electrode 676. A gate electrode 672 is electrically connected to the scan signal line 334. The first electrode 674 is electrically connected to the standard voltage line PVSS. The fifth scan signal SC5(n) is supplied to the scan signal line 334. The seventh transistor T7 is switched using the fifth scan signal SC5(n). In other words, in the seventh transistor T7, the conduction state (on state) and the non-conduction state (off state) are controlled by the fifth scan signal SC5(n). In the case where the signal supplied to the fifth scan signal SC5(n) is LO, the seventh transistor T7 becomes non-conductive, and in the case where the signal supplied to the fifth scan signal SC5(n) is HI, the seventh transistor T7 becomes conductive.

The eighth transistor T8 includes a gate electrode 682, the first electrode 684, and a second electrode 686. The gate electrode 682 is electrically connected to the scan signal line 332 and the gate electrode 662 of the sixth transistor T6. The second electrode 686 is electrically connected to the second electrode 34 of the light-emitting element OLED and the drive power supply line PVDD. As described above, the third scan signal SC3(n) is supplied to the scan signal line 332. The eighth transistor T8 is switched using the third scan signal SC3(n). In other words, in the eighth transistor T8, the conduction state (on state) and the non-conduction state (off state) are controlled by the third scan signal SC3(n). In the case where the signal supplied to the third scan signal SC3(n) is LO, the eighth transistor T8 becomes non-conductive, and in the case where the signal supplied to the third scan signal SC3(n) is HI, the eighth transistor T8 becomes conductive.

As will be described later, the capacitive element CV has a function of holding (storing) a charge corresponding to the threshold voltage VTH of the second transistor T2.

The capacitive element CD has a function of holding (storing) charges corresponding to a data voltage (a voltage equal to or higher than the voltage VSIGL (see FIG. 5) and equal to or lower than the voltage VSIGH (see FIG. 5)) included in the image data signal SL(m) supplied to the first node N1.

The first electrode 32 of the light-emitting element OLED is a cathode electrode, and the second electrode 34 of the light-emitting element OLED is an anode electrode.

For example, it is assumed that the conductive state of the transistor in the display device 10 indicates a state in which the source electrode and the drain electrode of the transistor are conductive and the transistor is on (ON), and the non-conductive state of the transistor in the display device 10 indicates a state in which the source electrode and the drain electrode of the transistor are non-conductive and the transistor is off (OFF). In addition, in each transistor, the source electrode and the drain electrode may be interchanged depending on a voltage or a potential supplied to each electrode. In addition, even if the transistor is in the off state, it can be easily understood by a person skilled in the art that a slight current flows, such as a leakage current.

Each of the transistors shown in FIG. 3 is an n-channel field effect transistor, and includes a Group 14 element such as silicon or germanium, or an oxide exhibiting semiconductor characteristics in a channel region. For example, crystalline silicon can be used as a channel region having the Group 14 element. The crystalline silicon may be low temperature polysilicon (LTPS) or single crystal silicon. Further, for example, a metal oxide having semiconductor characteristics can be used as an oxide exhibiting semiconductor characteristics. As an exemplary metal oxide having semiconductor characteristics, an oxide semiconductor containing two or more metals including indium (In) is used. As the metal oxide having semiconductor characteristics, in addition to indium, gallium (Ga), zinc (Zn), aluminum (Al), hafnium (Hf), yttrium (Y), zirconia (Zr), and lanthanoids may be used. Further, the metal oxide having semiconductor characteristics may be amorphous, may be crystalline, or may be a mixed phase of amorphous and crystalline.

For example, the transistors in the display device 10 are formed using thin film transistors (TFT). The channel regions of the transistors may be formed using single crystal silicon, such as silicon wafers or SOI boards. In addition, in the case where the display device 10 includes both a transistor including the Group 14 element in the channel region and a transistor including an oxide including a semiconductor characteristic in the channel region, a method for manufacturing the display device 10 includes forming a semiconductor layer including the Group 14 element and forming a semiconductor layer (for example, an oxide semiconductor layer) including an oxide having a semiconductor characteristic. The display device 10 may appropriately adapt a configuration of the transistor, connection of the storage capacitive element, the power supply voltage, and the like according to the application and specifications.

For example, a leakage current of a transistor including a metal oxide having semiconductor characteristics is extremely small. Therefore, a charge corresponding to a voltage (potential) written in the capacitive element using a transistor having a metal oxide having semiconductor characteristics is unlikely to escape from a capacitive element. As a result, by using the transistor having the metal oxide having the semiconductor characteristics, it is possible to hold the charge written in the capacitive element for a long time. Also, under the same gate-source voltage (a potential difference between a gate electrode and a source electrode (Vgs)) and source-drain voltage (for example, a potential difference between a source electrode and a drain electrode (Vds)) conditions, a drain current of a transistor having a metal oxide having semiconductor characteristics may be greater than a drain current of the transistor having the crystalline silicon (for example, low-temperature polysilicon (LTPS)). As a result, under the same drain current conditions, the gate-source voltage and the source-drain voltage of the transistor having the metal oxide having the semiconductor characteristics can be made smaller than those of the transistor having the crystalline silicon. Therefore, by using a transistor having a metal oxide having semiconductor characteristics, power consumption of the display device 10 can be suppressed.

### [1-5. Method for Driving Display Device 10]

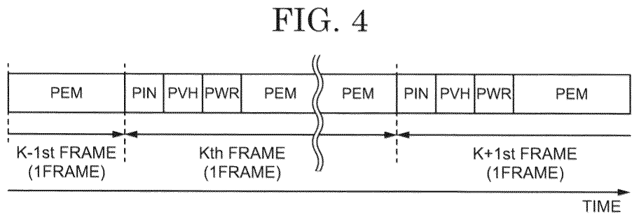

A method for driving the display device 10 will be described with reference to FIG. 4 to FIG. 8. FIG. 4 to FIG. 8 are schematic diagrams showing timing charts of the display device 10. Configurations that are the same as or similar to those in FIG. 1 to FIG. 3 will be described as necessary.

In addition, the horizontal axis of the timing charts in the respective embodiments represents time (TIME). Further, in the image data signal SL(m) including the data signal VDATA in the respective embodiments, for example, the data signal VDATA supplied to the selected pixel (pixel circuit) is indicated by a hatched line as a data voltage equal to or higher than the voltage VSIGL and equal to or lower than the voltage VSIGH, and the data signal VDATA supplied to a pixel (pixel circuit) other than the selected pixel (pixel circuit) is omitted and indicated by a solid line. In practice, the data signal VDATA supplied to the pixels (pixel circuits) other than the selected pixels (pixel circuits) is continuously or intermittently supplied to the image data signal SL(m) including the data signal VDATA in the respective embodiments.

For example, frequency at which the display device 10 is driven is 60 Hz, and one frame (1FRAME) is driven at 60 Hz. For example, FIG. 4 shows a current frame (Kth FRAME), a part of a frame before the current frame (K-1st FRAME), and a part of a frame after the current frame (K+1st FRAME). Also, FIG. 5 to FIG. 8 show an emission period PEM of the frame before current frame (K−1st FRAME), a period PIN, a period PVH, a period PWR, and the period PEM of the current frame (Kth FRAME), and the period PIN, the period PVH, and the period PEM of the frame after the current frame. Further, FIG. 5 to FIG. 8 show one horizontal period (horizontal period HRP) for one pixel 180 (pixel circuit 181).

First, an overview of a method for driving the display device 10 will be described with reference to FIG. 4. As shown in FIG. 4, the method for driving the display device 10 includes at least the initialization period PIN, the threshold voltage acquiring and holding period PVH, and the write period PWR in one frame. In the pixel 180 (pixel circuit 181) included in the display device 10, the period PWR is executed after the period PVH. Further, after the light emission period PEM of the frame before the current frame, the period PIN, the period PVH, and the period PWR of the current frame are executed, and after the light emission period PEM of the current frame, the period PIN, the period PVH, and the period PWR of the frame after the current frame are executed.

The period PIN is a period in which the second node, the third node N3 (the sixth node N6), and the fourth node N4 are initialized. The period PVH is a period in which the threshold voltage of the second transistor T2 is acquired by performing an operation in which the potential difference Vgs of the second transistor T2 becomes equal to the threshold voltage, and a charge corresponding to the threshold voltage is held in the second node N2 (the first electrode 42 of the capacitive element CV). The period PWR is a period in which the data signal VDATA is written to the pixel 180 (the pixel circuit 181). That is, the period PWR is a period in which a data voltage is supplied to the sixth node N6 (the second electrode 54 of the capacitive element CD) and charges corresponding to the data voltage are held. Further, the light emission period PEM is a period in which the pixel 180 emits light based on the written data voltage and the acquired threshold voltage of the second transistor T2 (threshold voltage correction).

Next, a specific method for driving the pixel 180 (the pixel circuit 181) of the display device 10 will be described with reference to FIG. 4 to FIG. 8.

The pixel 180 (pixel circuit 181) receives the first scan signal SC1(n), the second scan signal SC2(n), the third scan signal SC3(n), the fourth scan signal SC4(n), the fifth scan signal SC5(n), the image data signal SL(m) including the data signal VDATA, the initialization voltage VINI, and the reference voltage VREF. For example, the pixel 180 (the pixel circuit 181) is selected according to the timings of the first scan signal SC1(n), the second scan signal SC2(n), the third scan signal SC3(n), and the fourth scan signal SC4(n). The image data signal SL(m), the initialization voltage VINI, and the reference voltage VREF are input to the selected pixel 180 (pixel circuit 181) in accordance with the timings of the respective signals. A similar operation is performed on all the pixels 180 (the pixel circuit 181), and an image of the frame corresponding to the 1FRAME is displayed in the display region 22 of the display device 10 on the basis of the image data signal SL(m) input to all the pixels 180 (the pixel circuit 181).

For example, the voltages (potentials) supplied to the respective signals and the respective nodes in the respective periods of the respective frames of the timing charts shown in FIG. 4 to FIG. 8 are shown in Table 1.

TABLE 1

| | Setting Value [V] |
|---|---|
| VTH | 1 |
| VSIGL(black) | 4 |
| VSIGH(white) | 0 |
| HI | 8 |
| LO | −5 |
| VINI | 3 |
| VREF | 2 |
| VDDEL | 6 |
| VSSEL | −2 |

For example, as shown in Table 1, the voltage VSIGH is 4 V, and the pixel 180 to which the voltage VSIGH is supplied becomes non-light emitting and becomes black. Further, for example, the voltage VSIGL is 0 V, and the pixel 180 to which the voltage VSIGL is supplied emits light and emits white color. For example, the threshold voltage VTH of the second transistor T2 is 1 V, the voltage VH (HI) is 8 V, the voltage VL (LO) is −5 V, the initialization voltage VINI is 3 V, the reference voltage VREF is 2 V, the driving voltage VDDEL is 6 V, the standard voltage VSSEL is −2 V, the voltage VM is 5 V, and the voltage VN is −5 V. That is, the reference voltage VREF is different from the initialization voltage VINI, and the reference voltage VREF and the initialization voltage VINI are larger than the standard voltage VSSEL and smaller than the driving voltage VDDEL.

### [1-5-1. First Example of Method for Driving Display Device 10]

A first example of the method for driving the display device 10 will be described with reference to FIG. 5 and Table 1. The driving method shown in the first example includes the pixel 180 (pixel circuit 181) displaying a white image based on the voltage VSIGH of the data signal VDATA in the frame (K−1 st FRAME) immediately preceding the current frame (Kth FRAME), and then the pixel 180 (pixel circuit 181) displaying a black image based on the voltage VSIGL of the data signal 180 (pixel circuit 181). In other words, the driving method shown in the first example includes displaying images of different colors in successive frames.

The image data signal SL(m) including the data signal VDATA is input to each pixel 180 (pixel circuit 181) in accordance with each period. The data signal VDATA is analog data (analog voltage) including a voltage equal to or higher than the voltage VSIGL and equal to or lower than the voltage VSIGH. For example, in the period PWR, a voltage equal to or higher than the voltage VSIGL and equal to or lower than the voltage VSIGH is selected by using a selection signal (not shown), and is supplied to the image data signal SL(m). For example, in a period excluding the period PWR, the data signal VDATA is supplied with a voltage other than the selected pixel 180 (the pixel circuit 181).

The light emission period PEM of the K−1st FRAME is a period in which the pixel 180 (the pixel circuit 181) emits light in accordance with the potential difference Vgs (a voltage supplied to the second node N2 (voltage V (N2))−(a voltage supplied to the third node N3 (voltage V (N3))) of the second transistor T2. For example, the pixel 180 (the pixel circuit 181) emits red light, and emits white light by three pixels using the pixel 180 emitting red light, the pixel 180 emitting blue light, and the pixel 180 emitting green light.

For example, in the light emission period PEM of the K−1st FRAME, the image data signal SL(m) (data signal VDATA) is supplied with the voltage of the data signal VDATA supplied to pixels other than the selected pixel 180 (pixel circuit 181), the first scan signal SC1(n), the third can signal SC3(n), and the fourth scan signal SC4(n) are supplied with LO, and the second scan signal SC2(n) and the fifth scan signal SC5(n) are supplied with HI. The first transistor T1, the third transistor T3, the fourth transistor T4, the sixth transistor T6, and the eighth transistor T8 are in the off state, and the fifth transistor T5 and the seventh transistor T7 are in the on state. Further, for example, the voltage held in the third node N3 (the sixth node N6) is a voltage Vnd (−2 V), the voltage held in the second node N2 is a voltage Vnq (2 V), and the potential difference Vgs is 4 V. Therefore, the second transistor T2 is in the on state, and the current Ion based on the potential difference Vgs and the potential difference Vds according to the voltage VSIGH input in the horizontal period HRP of the K−1st FRAME can be passed from the drive power line PVDD to the light emitting element OLED and the reference voltage line PVSS. Consequently, the light-emitting element OLED emits light. In addition, the voltage held in the first node N1 is 0 V by capacitive coupling by the capacitive element CV and the capacitive element CD. For example, the pixel 180 (the pixel circuit 181) emits red light, and emits white light by three pixels using the pixel 180 emitting red light, the pixel 180 emitting blue light, and the pixel 180 emitting green light.

In the period between the light emission period PEM of the K−1st FRAME and the period PIN of the Kth FRAME following the light emission period PEM of the K−1st FRAME, or in the period PIN of the Kth FRAME, the image data signal SL(m) (data signal VDATA) is supplied with the voltage of the data signal VDATA supplied to pixels other than the selected pixel 180 (pixel circuit 181). First, the fifth scan signal SC5(n) is supplied with LO from a state where HI is supplied. When LO is supplied to the fifth scan signal SC5(n), the third scan signal SC3(n) changes from a state in which LO is supplied to a state in which HI is supplied. When the third scan signal SC3(n) is supplied with HI, the first scan signal SC1(n) changes from a state where LO is supplied to a state where HI is supplied. The second scan signal SC2(n) is in a state where HI is supplied, and the fourth scan signal SC4(n) is in a state where LO is supplied.

Consequently, in a period between the light emission period PEM of the K−1st FRAME and the period PIN of the Kth FRAME or in the period PIN of the Kth FRAME, the seventh transistor T7 is turned from the on state to the off state, and the current Ion does not flow from the drive power supply line PVDD to the light-emitting element OLED and the standard voltage line PVSS. The sixth transistor T6 and the eighth transistor T8 are turned from the off state to the on state, a potential difference between the first electrode 32 and the second electrode 34 of the light-emitting element OLED becomes 0 V, the light emission of the light-emitting element OLED is stopped, and a voltage supplied to the first node N1 rises from 0 V toward the voltage Vnq (reference voltage VREF, 2 V) and becomes the voltage Vnq. The third transistor T3 is turned from the off state to the on state, the fifth transistor T5 is maintained in the on state, the first transistor T1 is maintained in the off state, the second node N2 and the fourth node N4 are conducted, and a voltage Vnr (driving voltage VDDEL, 6 V) is supplied to the second node N2 (the gate electrode 622 of the second transistor T2) and the fourth node N4 (the second electrode 626 of the second transistor T2). Further, the fourth transistor T4 is turned from the off state to the on state, and a voltage Vnp (initialization voltage VINI, 3 V) is supplied to the third node N3 (the first electrode 624 of the second transistor T2) and the sixth node N6 (the second electrode 616 of the first transistor T1). The potential difference Vgs is 3 V (6 V−3 V) and the second transistor T2 is in the on state.

As described above, in the period PIN, the second node N2 and the fourth node N4 are initialized by the driving voltage VDDEL, the first node N1 is initialized by the reference voltage VREF, and the third node N3 (the sixth node N6) is initialized by the initialization voltage VINI.

In the period PVH following the period PIN, the image data signal SL(m) (data signal VDATA) is supplied with the voltage of the data signal VDATA other than the selected pixel 180 (pixel circuit 181). The second scan signal SC2(n) changes from a state in which HI is supplied to a state in which LO is supplied. The rest of the scan signals are in the same condition as the period PIN. The fifth transistor T5 is turned from the on state to the off state, and the rest of the transistors are in the same state as the period PIN.

Consequently, in the period PVH, the first node N1 maintains the voltage Vnq and the third node N3 (sixth node N6) maintains the voltage Vnp. The second transistor T2 is in the on state, the current Ion flows, the first node N1 maintains the voltage Vnq, and the third node N3 (the sixth node N6) maintains the voltage Vnp. In addition, due to the off state of the fifth transistor T5, the voltage supplied to the second node N2 and the fourth node N4 is released, and gradually decreases (discharges) from the voltage Vnr. When the potential difference Vgs between the voltage supplied to the second node N2 and the fourth node N4 and the voltage supplied to the third node N3 (the sixth node N6) becomes the threshold voltage VTH, the second transistor T2 is turned off. In this case, the voltage supplied to the second node N2 and the fourth node N4 is a voltage Vnl, for example, 4 V. In practice, the threshold voltage VTH may vary in manufacturing, for example, 3.8 V or 4.1 V, and the threshold voltage VTH may be acquired by the operation during the period PVH, and correction is performed using the acquired threshold voltage VTH.

As described above, in the period PVH, by making the potential difference Vgs of the second transistor T2 equal to the threshold voltage VTH, the threshold voltage VTH of the second transistor T2 is acquired, and a charge equivalent to the threshold voltage VTH is held in the capacitive element CV.

In a period between the period PVH and the period PWR following the period PVH, or in the period PWR, the image data signal SL(m) (the data signal VDATA) is supplied with a voltage VSIGH (4 V). First, LO is supplied from the state where HI is supplied to the first scan signal SC1(n). When the first scan signal SC1(n) is supplied with LO, the fourth scan signal SC4(n) changes from the state where LO is supplied to a state where HI is supplied. The third scan signal SC3(n) is supplied with HI, and the second scan signal SC2(n) and the fifth scan signal SC5(n) are supplied with LO. The first transistor T1 is turned from the off state to the on state, and the third transistor T3 and the fourth transistor T4 are turned from the on state to the off state. The rest of the transistors are similar to the period PVH. The voltage supplied to the second node N2 maintains the voltage Vnl (for example, 4 V), and the voltage supplied to the first node N1 maintains the voltage Vnq (the reference voltage VREF, 2 V). The voltage supplied to the third node N3 (the sixth node N6) gradually increases from the voltage Vnp to the voltage Vnl (the voltage VSIGH, for example, 4 V). In this case, the capacitive element CD maintains the potential difference (−2 V with respect to the sixth node N6) by holding a charge corresponding to the potential difference between Vnq (the reference voltage VREF, 2 V) supplied to the first node N1 and the voltage Vnl (the voltage VSIGH, for example, 4 V) supplied to the third node N3 (sixth node N6). That is, the potential difference Vgs is 0 V.

As described above, in the period PWR, the data signal VDATA is written to the pixel 180 (the pixel circuit 181). The capacitive element CD maintains (holds) the voltage included in the data signal VDATA.

During a period after the period PWR, the fourth scan signal SC4(n) changes from a state where HI is supplied to a state where LO is supplied. In the case where the fourth scan signal SC4(n) is supplied with LO, the third scan signal SC3(n) changes from a state where HI is supplied to a state where LO is supplied. In the case where the third scan signal SC3(n) is supplied with LO, the fifth scan signal SC5(n) changes from a state where LO is supplied to a state where HI is supplied. The first transistor T1, the sixth transistor T6, and the eighth transistor T8 are turned from the on state to the off state, and the seventh transistor T7 is turned from the off state to the on state. The other scan signals and the other transistors are the same as the period PWR. The voltage supplied to the second node N2 and the voltage supplied to the third node N3 (the sixth node N6) drop from the voltage Vnl to the voltage Vnd (−2 V). That is, the potential difference Vgs is maintained at 0 V. In this case, the voltage supplied to the first node N1 capacitively coupled by the capacitive element CV and the capacitive element CD drops from the voltage Vnq to a voltage Vnt (−4 V).

In the light emission period PEM of the Kth FRAME following the period PWR of the Kth FRAME, the image data signal SL(m) (data signal VDATA) is supplied with the voltage of the data signal VDATA supplied to a pixel other than the selected pixel 180 (pixel circuit 181). The second scan signal SC2(n) changes from a state where LO is supplied to a state where HI is supplied. Therefore, the fifth transistor T5 is turned from the off state to the on state. The other scan signals and the other transistors are in the same condition as the period after the period PWR of the Kth FRAME. The fifth transistor T5 is turned on, and the first electrode 32 of the light-emitting element OLED is electrically connected to the second electrode 626 (fourth node N4) of the second transistor T2. The potential difference Vgs is a sum of the potential difference held in the capacitive element CD and the potential difference held in the capacitive element CV (the initialization voltage VINI (3 V)−the voltage of the data signal VDATA (voltage VSIGH, 4 V)+the threshold voltage VTH (1 V)=0 V). In the pixel 180 (the pixel circuit 181) in which the data signal VDATA includes the voltage VSIGH, the potential difference Vgs is 0 V and the second transistor T2 is in the off state, so that the current Ion does not flow. Therefore, the light-emitting element OLED does not emit light. As a result, the pixel 180 (the pixel circuit 181) emitting red light becomes black. Similar to the pixel 180 that emits red light, the pixel 180 that emits blue light and the pixel 180 that emits green light do not emit light, and therefore, the three pixels using the pixel 180 that emits red light, the pixel 180 that emits blue light, and the pixel 180 that emits green light become black.

The display device 10 is capable of independently controlling each node. The display device 10 includes a configuration in which the first node N1, the second node N2, the third node N3 (the sixth node N6), the capacitive element CV, and the capacitive element CD are not directly connected to the light-emitting element OLED. Further, the voltages supplied to the first node N1, the second node N2, the third node N3 (the sixth node N6), the capacitive element CV, and the capacitive element CD are constant voltages such as the driving voltage VDDEL, the initialization voltage VINI, the reference voltage VREF, or a data signal VDATA. Thus, for example, no charge redistribution occurs between the first node N1, the second node N2, and the third node N3 (the sixth node N6), and the parasitic capacitive element CD, the capacitive element CV, and the parasitic capacitance added to the light-emitting element OLED. Consequently, the display device 10 can suppress variations in the voltages of the first node N1, the second node N2, and the third node N3 (the sixth node N6) due to redistribution of charges. In addition, the threshold voltage VTH in the period PVH is acquired using the initialization voltage VINI supplied to the third node N3 as a reference voltage. As a consequence, the display device 10 can acquire the threshold voltage VTH while being less susceptible to the potential fluctuation caused by the driving voltage VDDEL. Therefore, the display device 10 can suppress a decrease in the holding potential due to the redistribution of the electric charge, and can acquire the threshold voltage at high speed and with high accuracy. Therefore, the display device 10 can accurately store and hold the data signal VDATA voltage (potential difference) in which the threshold voltage is corrected, and can be supplied as the potential difference Vgs of the second transistor T2.

In addition, in the display device 10, the reference voltage VREF differs from the initialization voltage VINI. The reference voltage VREF is an intermediate voltage (intermediate voltage, intermediate potential) between the voltage VSIGH and the voltage VSIGL. Consequently, the potential difference between the voltage supplied to the first electrode 52 of the capacitive element CD and the voltage supplied to the second electrode 54 is the same as the potential difference between the voltage supplied to the first electrode 42 of the capacitive element CV and the voltage supplied to the second electrode 44. Therefore, it is possible to suppress the potential difference of the capacitive element CD of the display device 10 from significantly deviating from the potential difference of the capacitive element CV. In other words, the display device 10 can reduce the load applied to the capacitive element CD and the capacitive element CV by dispersing the voltages applied to the capacitive element CD and the capacitive element CV, and can suppress the reduction in the breakdown voltage of the capacitive element CD and the capacitive element CV. In addition, since the display device 10 can suppress a decrease in the breakdown voltage of the capacitive element CD and the capacitive element CV, the insulating film for forming the capacitive element CD and the capacitive element CV can be made thin. Therefore, in the display device 10, the region required for the capacitive element CD and the capacitive element CV can be reduced, and therefore, even if the region of the pixel is small, the capacitance can be sufficiently secured.

### [1-5-2. Second Example of Method for Driving Display Device 10]

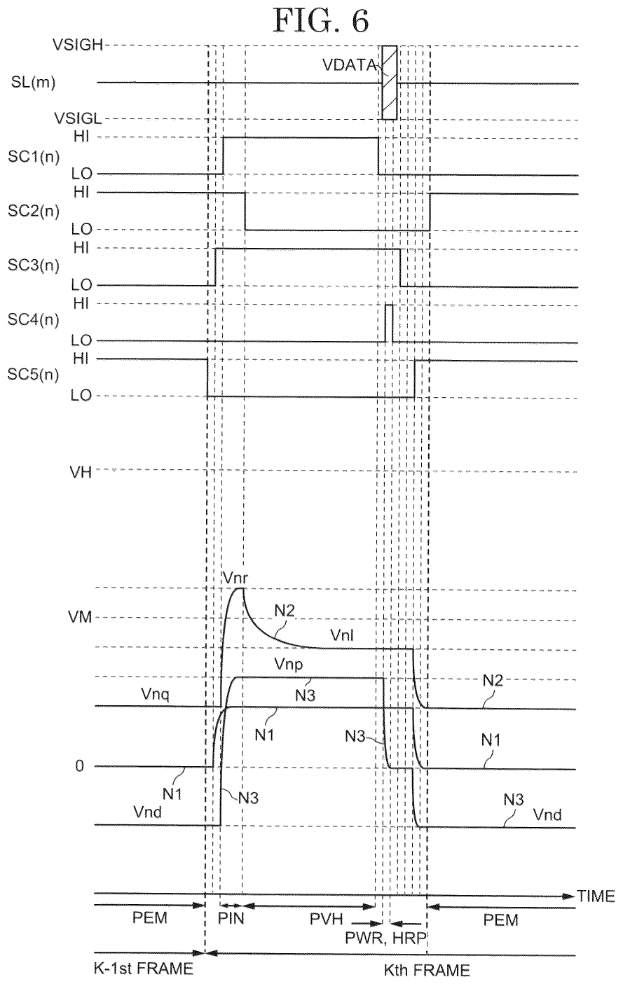

A second example of the method for driving the pixel circuit 181 will be described with reference to FIG. 6. The driving methods shown in the second example include displaying a white image based on the voltage VSIGH included in the data signal VDATA in the frame (K−1st FRAME) immediately preceding the current frame (Kth FRAME) by the pixel 180 (the pixel circuit 181), and then displaying a white image based on the voltage VSIGH included in the data signal VDATA by the pixel 180 (the pixel circuit 181). In other words, the driving method shown in the second example includes displaying images of the same color (white) in consecutive frames. Configurations that are the same as or similar to those in FIG. 1 to FIG. 5 will be described as necessary.

The voltage (potential) of the respective nodes in the light emission period PEM of the K−1thFRAME to the period PVH of the Kth FRAME and a period between the period PVH of the Kth FRAME and the period PWR of Kth FRAME are the same as the configurations described in section of “1-5-1. First Example of Method for Driving Display Device 10”. The configuration of each scan signal and the operation of each transistor in each period are the same as the configuration described in section of “1-5-1. First Example of Method for Driving Display Device 10”. Therefore, configurations and the like similar to those described in section of “1-5-1. First Example of Method for Driving Display Device 10” will be described as necessary. In addition, the image data signal SL(m) is supplied in the period PWR of the Kth FRAME with the data signal VDATA including VSIGL (0 V) corresponding to the white color, and the same data signal VDATA as the configuration described in section of “1-5-1. First Example of Driving Display Device 10” is supplied in the period other than the period PWR of the Kth FRAME.

In the emission period PEM of the K−1st FRAME, similar to the configuration described in section of “1-5-1. First Example of Method for Driving Display Device 10”, the pixel 180 (pixel circuit 181) emits red light, and emits white light in three pixels using the pixel 180 emitting red light, the pixel 180 emitting blue light, and the pixel 180 emitting green light.

In the period PIN of the Kth FRAME, similar to the configuration described in section of “1-5-1. First Example of Method for Driving Display Device 10”, the second node N2 and the fourth node N4 are initialized by the driving voltage VDDEL, the first node N1 is initialized by the reference voltage VREF, and the third node N3 (sixth node N6) is initialized by the initialization voltage VINI.

In the period PVH following the period PIN, by making the potential difference Vgs of the second transistor T2 equal to the threshold voltage VTH, the threshold voltage VTH of the second transistor T2 is acquired, and a charge equivalent to the threshold voltage VTH is held in the capacitive element CV, similar to the configuration described in section of “1-5-1. First Example of Method for Driving Display Device 10”.

In a period between the period PVH and the period PWR following the period PVH, or in the period PWR, the image data signal SL(m) (the data signal VDATA) is supplied with the voltage VSIGL (0 V). The voltage supplied to the second node N2 maintains the voltage Vnl (for example, 4 V), and the voltage supplied to the first node N1 maintains the voltage Vnq (reference voltage VREF, 2 V). The voltage supplied to the third node N3 (the sixth node N6) gradually drops from the voltage Vnp (the initialization voltage VINI, 3 V) and becomes 0 V (the voltage VSIGL). In this case, the capacitive element CD maintains the potential difference (2 V with respect to the sixth node N6) by holding charges corresponding to the potential difference between the voltage Vnq (the reference voltage VREF, 2 V) supplied to the first node N1 and 0 V (the voltage VSIGL) supplied to the third node N3 (the sixth node N6). Further, the capacitive element CV maintains the potential difference (2 V with respect to the first node N1) by holding a charge corresponding to the potential difference between the voltage Vnl (for example, 4 V) supplied to the second node N2 and the voltage Vnq (reference voltage VREF, 2 V) supplied to the first node N1. That is, the potential difference Vgs is 4 V acquired by combining the potential difference held in the capacitive element CD and the capacitive element CV. For example, in the case where the threshold voltage VTH varies and the voltage Vnl supplied to the second node N2 becomes 3.9 V, the potential difference Vgs becomes 3.9 V (Vgs=(Vnl (3.9 V)−VREF (2 V) (VREF (2 V)−VSIL (0 V))

As described above, in the period PWR, the data signal VDATA is written to the pixel 180 (the pixel circuit 181). In addition, the capacitive element CD maintains (holds) the voltage included in the data signal VDATA.

During a period after the period PWR, when the fifth scan signal SC5(n) is supplied with HI, the seventh transistor T7 is turned from the off state to the on state, and the third node N3 (the sixth node N6) is connected to the standard voltage VSSEL, so that the voltage supplied to the third node N3 (the sixth node N6) drops from 0 V to the voltage Vnd (−2 V). Accordingly, the voltage of the second node N2 capacitively coupled by the capacitive element CV and the capacitive element CD drops from the voltage Vnl to the voltage Vnq (2 V). That is, the potential difference Vgs is maintained at 4 V. In this case, the voltage supplied to the first node N1 capacitively coupled by the capacitive element CV and the capacitive element CD drops from the voltage Vnq to 0 V.

In the emission period PEM of the Kth FRAME following the period PWR of the Kth FRAME, the potential difference Vgs becomes a sum of the potential difference held in the capacitive element CD and the potential difference held in the capacitive element CV (reference voltage VREF (2 V)−the voltage (voltage VSIGL, 0 V)+(initialization voltage VINI (3 V)+threshold voltage VTH (1 V)−reference voltage VREF (2 V) included in the data signal VDATA=4 V. In other words, the pixel 180 (pixel circuit 181) can display images based on the data signal VDATA and the corrected threshold voltage. In the case where the data signal VDATA includes the voltage VSIGL, the potential difference Vgs is 4 V and the second transistor T2 is in the on state, so that the light-emitting element OLED emits light when the current Ion flows from the drive power supply line PVDD to the light-emitting element OLED and the standard voltage line PVSS. For example, the pixels 180 that emit red light, the pixels 180 that emit blue light, and the pixels 180 that emit green light emit light, respectively, and become white by three pixels using the pixels 180 that emit red light, the pixels 180 that emit blue light, and the pixels 180 that emit green light.

The second example of the method for driving the display device 10 has the same effects as those described in section of “1-5-1. First Example of Method for Driving Display device 10”.

### [1-5-3. Third Example of Method for Driving Display Device 10]

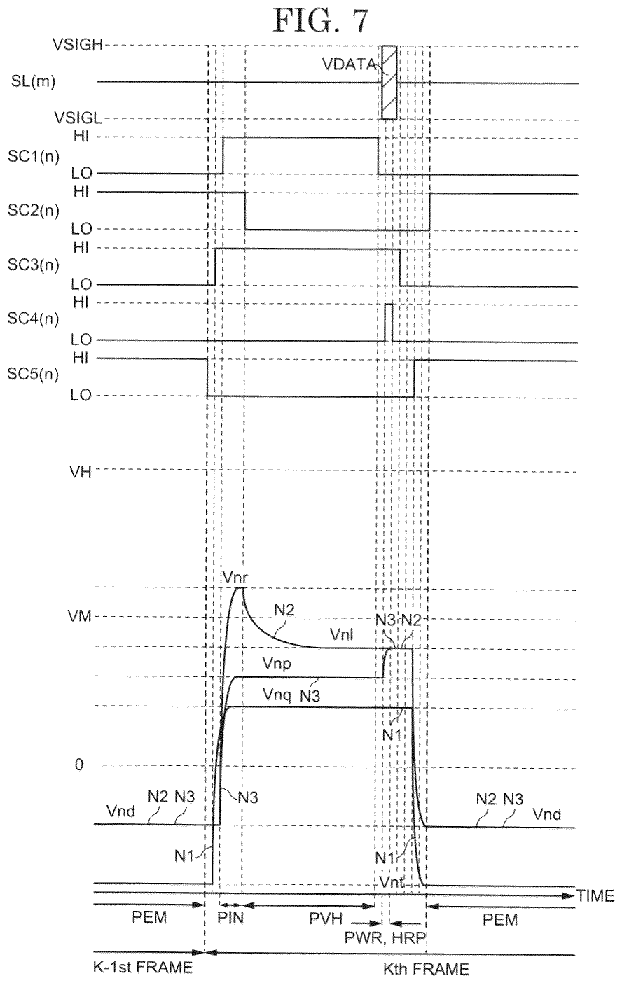

A third example of the method for driving the display device 10 will be described with reference to FIG. 7. The driving method shown in the third example includes the pixel 180 (the pixel circuit 181) displaying a black image based on the voltage VSIGL included in the data signal VDATA in the frame (K−1 st FRAME) immediately preceding the current frame (Kth FRAME), and then pixel 180 (pixel circuit 181) also displays a black image in Kth FRAME based on the voltage VSIGH included in data signal VDATA. In other words, the driving method shown in the third example includes displaying images of the same color (black) in consecutive frames. Configurations that are the same as or similar to those in FIG. 1 to FIG. 6 will be described as necessary.

The voltages (potentials) and the like of the respective nodes in the period PVH of the Kth FRAME to the light emission period PEM of the Kth FRAME are the same as the configurations described in section of “1-5-1. First Example of Method for Driving Display Device 10”. The configuration of each scan signal and the operation of each transistor in each period are the same as the configuration described in section of “1-5-1. First Example of Method for Driving Display Device 10”. Therefore, configurations and the like similar to those described in section of “1-5-1. First Example of Method for Driving Display Device 10” will be described as necessary.

In the emission period PEM of the K−1st FRAME, for example, the voltage held in the first node N1 is the voltage Vnt (−4 V). The voltage supplied to the second node N2 and the voltage held at the third node N3 are voltages Vnd (−2 V), and the potential difference Vgs is 0 V. Therefore, the second transistor T2 is in the off state, the current Ion does not flow, and the light-emitting element OLED does not emit light.

As a result, the pixel 180 (the pixel circuit 181) emitting red light becomes black. Similar to the pixel 180 that emits red light, the pixel 180 that emits blue light and the pixel 180 that emits green light do not emit light, and therefore, the three pixels using the pixel 180 that emits red light, the pixel 180 that emits blue light, and the pixel 180 that emits green light become black.

Subsequent to the emission period PEM of the K−1st FRAME, the period between the emission period PEM of the K−1st FRAME and the period PIN of the Kth FRAME, or, in the period PIN of the Kth FRAME, the sixth transistor T6 and the transistor T8 are turned from the off state to the on state, the potential difference between the first electrode 32 and the second electrode 34 of the light emitting element OLED becomes 0 V, the light emitting element OLED is stopped, and the voltage supplied to the first node N1 rises from the voltage Vnt (−4 V) toward the voltage Vnq (reference voltage VREF, 2 V), and becomes the voltage Vnq. The third transistor T3 is turned from the off state to the on state, the fifth transistor T5 is maintained in the on state, the first transistor T1 is maintained in the off state, the second node N2 and the fourth node N4 are conducted, and the voltage Vnr (driving voltage VDDEL, 6 V) is supplied to the second node N2 (the gate electrode 622 of the second transistor T2) and the fourth node N4 (the second electrode 626 of the second transistor T2). Further, the fourth transistor T4 is turned from the off state to the on state, and the voltage Vnp (initialization voltage VINI, 3 V) is supplied to the third node N3 (the first electrode 624 of the second transistor T2) and the sixth node N6 (the second electrode 616 of the first transistor T1). The potential difference Vgs is 3 V (6 V−3 V) and the second transistor T2 is in the on state.

As described above, in the same manner as in the configuration described in section of “1-5-1. First Example of Method for Driving Display Device 10”, in the period PIN, the second node N2 and the fourth node N4 are initialized by the driving voltage VDDEL, the first node N1 is initialized by the reference voltage VREF, and the third node N3 (sixth node N6) is initialized by the initialization voltage VINI.

In the period PVH following the period PIN, similar to the configuration described in section of “1-5-1. First Example of Method for Driving Display Device 10”, the threshold voltage VTH of the second transistor T2 is acquired by the operation in which the potential difference Vgs of the second transistor T2 becomes the same as the threshold voltage VTH, and a charge corresponding to the threshold voltage VTH is held in the capacitive element CV.

In the period PWR following the period PVH, the data signal VDATA is written to the pixel 180 (the pixel circuit 181) in the same manner as in the configuration described in section of “1-5-1. First Example of Method for Driving Display Device 10”. The capacitive element CD maintains (holds) the voltage included in the data signal VDATA.

In the period after the period PWR and the emission period PEM of the Kth FRAME following the period PWR, the pixel circuit 181 operates in the same manner as the configuration described in “1-5-1. First Example of Method for Driving Display Device 10”, and since the potential difference Vgs is 0 V and the second transistor T2 is in the off state, the current Ion does not flow and the light-emitting element OLED does not emit light. As a result, three pixels using the pixel 180 emitting red light, the pixel 180 emitting blue light, and the pixel 180 emitting green light become black.

The third example of the method for driving the display device 10 has the same effects as those described in section of “1-5-1. First Example of Method for Driving Display Device 10”.

### [1-5-4. Fourth Example of Method for Driving Display Device 10]

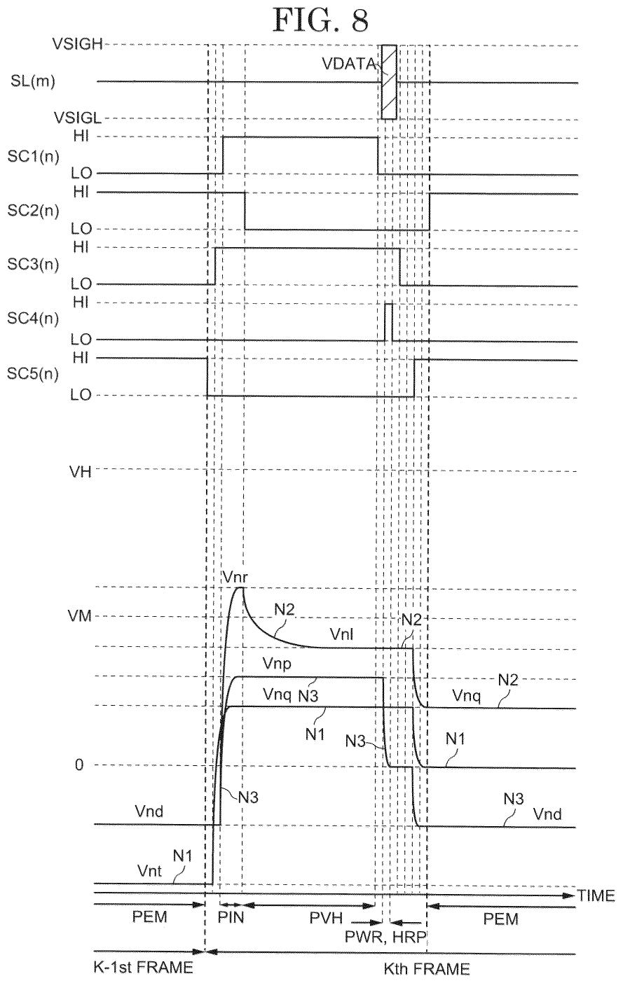

A fourth example of the method for driving the display device 10 will be described with reference to FIG. 8. The driving method shown in the fourth Example includes the pixel 180 (pixel circuit 181) displaying a black image based on the voltage VSIGL of the data signal VDATA in the frame (K-1st FRAME) immediately preceding the current frame (Kth FRAME), and then the pixel 180 (pixel circuit 181) displaying a white image based on the voltage VSIGH of the data signal VDATA in the Kth FRAME. In other words, the driving method shown in the fourth example includes displaying images of different colors in successive frames. Configurations that are the same as or similar to those in FIG. 1 to FIG. 7 will be described as necessary.

The voltage (potential) of each node in the emission period PEM of the K−1st FRAME to the period PVH of the Kth FRAME, the configuration of each scan signal, the operation of each transistor, and the like are the same as those described in section of “1-5-3. Third Example of Method for Driving Display Device 10”. Further, the voltage (potential) of each node in the period after the period PVH of the Kth FRAME to the emission period PEM of the Kth FRAME, the configuration of each scan signal, the operation of each transistor, and the like are the same as those described in section of “1-5-2. Second Example of Method for Driving Display Device 10”. Therefore, the description thereof will be omitted.

The fourth example of the method for driving the display device 10 has the same effects as those described in section of “1-5-1. First Example of Method for Driving Display Device 10”.

### [1-6. End Face Structure of Pixel 180]

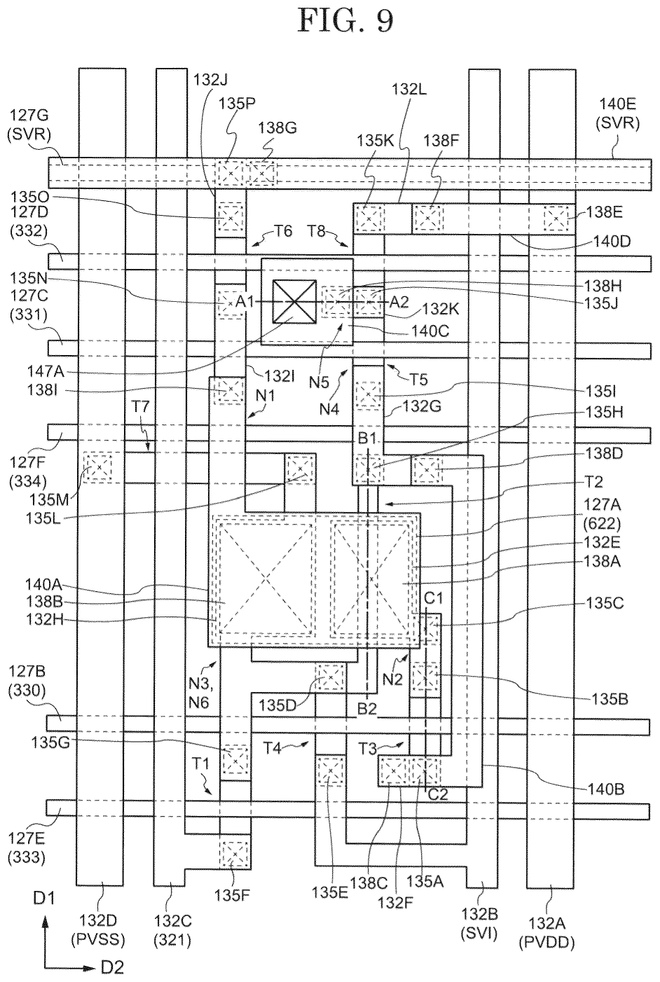

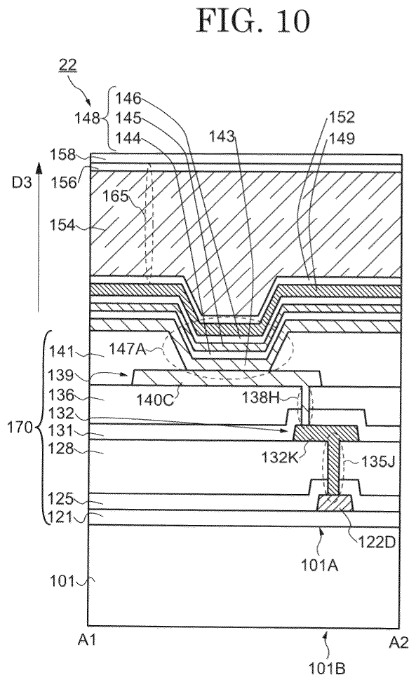

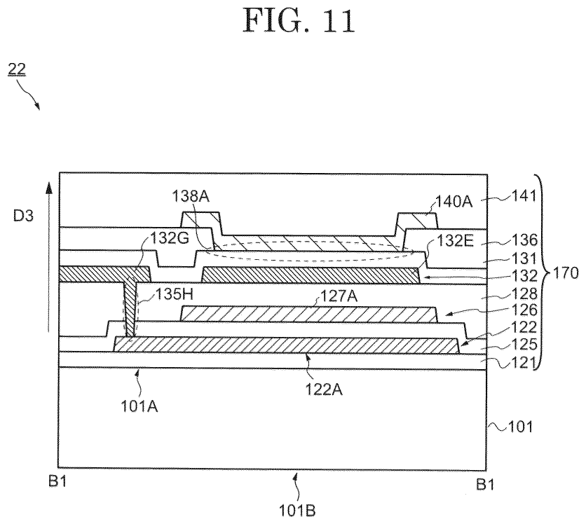

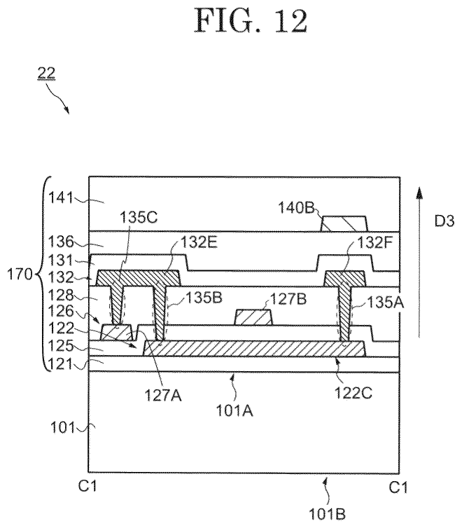

With reference to FIG. 9 to FIG. 12, an end face structure of the pixel 180 will be described. FIG. 9 is a layout diagram of the pixels 180. FIG. 10 is an end view showing an end face cut along A1-A2 in the layout shown in FIG. 9. FIG. 11 is an end view showing an end face cut along B1-B2 in the layout shown in FIG. 9. FIG. 12 is an end view showing an end face cut along C1-C2 in the layout shown in FIG. 9. The layout of the pixels 180 shown in FIG. 9 and the end faces of the pixels 180 shown in FIG. 10 to FIG. 12 are examples, and the planar layout and the end faces of the pixels 180 are not limited to the examples shown in FIG. 9 to FIG. 12. Configurations that are the same as or similar to those in FIG. 1 to FIG. 8 will be described as necessary.

In addition, in the end faces of the pixels 180 shown in FIG. 11 and FIG. 12, a configuration of a layer above the insulating layer 141 (opposite to a substrate 101) is omitted along a direction D3.

Further, the end face of the pixel 180 shown in FIG. 10 is an end face along a functional layer 148, a second wiring 140C, a contact hole opening 147 for the cathode electrode, a second contact hole opening 138H, a first wiring 132K, a first contact hole opening 135J, and a semiconductor layer 122D, as an exemplary end face of the pixel 180. The end face of the pixel 180 shown in FIG. 11 is an end face along a first wiring 132G, a first contact hole opening 135H, a semiconductor layer 122A, a second wiring 140A, an organic insulating film opening 138A for a capacitive element CS, a gate wiring 127A, and a first wiring 132E, as an exemplary end face of the pixel 180. The end face of the pixel 180 shown in FIG. 12 is an end face along the first wiring 132E, a first contact hole opening 135C, the gate wiring 127A, a first contact hole opening 135B, a semiconductor layer 122C, a gate wiring 127B, a second wiring 140B, a first wiring 132F, and the first contact hole opening 135A, as an exemplary end face of the pixel 180.

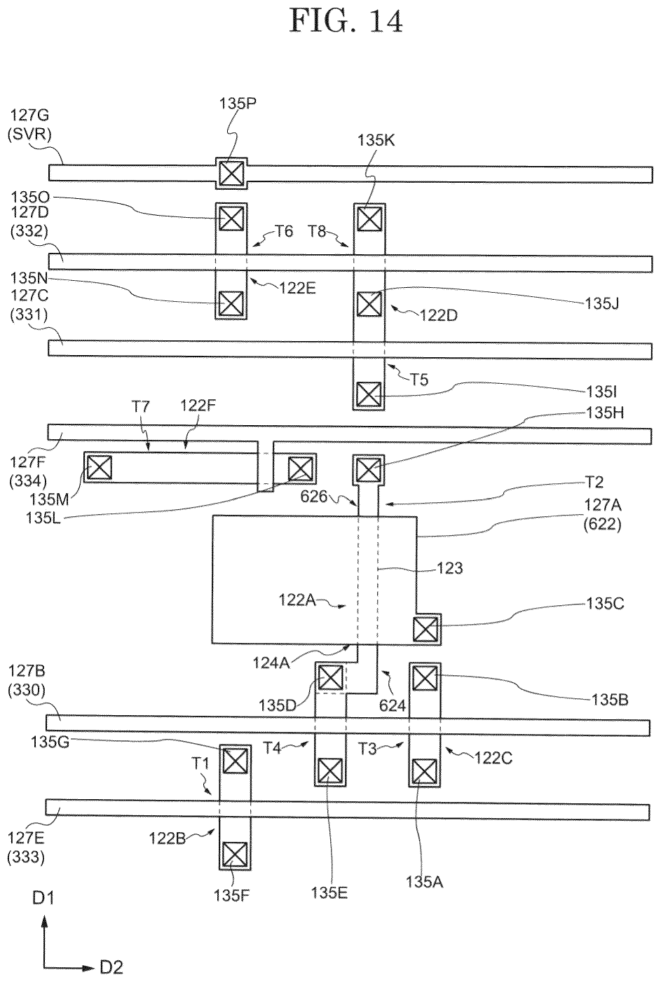

The substrate 101 includes a first surface 101A and a second surface 101B opposed to the first surface 101A. The semiconductor layer 122 is arranged on the first surface 101A of the substrate 101 via a base layer 121. The semiconductor layer 122 includes the semiconductor layer 122A, and the semiconductor layer 122A includes a channel region 123 (see FIG. 14) and an impurity region 124A (see FIG. 14). The semiconductor layer 122 includes the semiconductor layer 122D and the semiconductor layer 122C. For example, the impurity region is referred to as a source region or a drain region. Further, for example, the second transistor T2 includes the semiconductor layer 122A, and the first electrode 624 and the second electrode 626 include the impurity regions 124A. In other words, the semiconductor layer 122A includes the channel region of the second transistor T2.

Similar to the semiconductor layer 122A, the third transistor T3 includes the semiconductor layer 122C, and the first electrode 634 and the second electrode 636 include impurity regions. In other words, the semiconductor layer 122C includes the channel region of the third transistor T3. The fifth transistor T5 includes the semiconductor layer 122D, the first electrode 654 and the second electrode 656 include the impurity region, the eighth transistor T8 includes the semiconductor layer 122D, and the first electrode 684 and the second electrode 686 include the impurity regions. In other words, the semiconductor layer 122D includes a channel region of the fifth transistor T5 and a channel region of the eighth transistor T8. That is, the semiconductor layer 122D also serves as channel regions of the fifth transistor T5 and the eighth transistor T8.

A gate insulating layer 125, a conductive layer 126, an insulating layer 128, and a conductive layer 132 are arranged in this order on the semiconductor layer 122. The conductive layer 126 includes the gate wiring 127A (the gate electrode 622) and the gate wiring 127B (the scan signal line 330 and the gate electrode 632). The conductive layer 132 includes the first wiring 132K, the first wiring 132G, the first wiring 132E (the first electrode 42), and the first wiring 132F. In addition, a region where the conductive layer 126 and the semiconductor layer 122 overlap is a channel region. In other words, a region where the gate electrode and the semiconductor layer of each transistor overlap each other is a channel region.

Each of the transistors of the pixel 180 is formed using the semiconductor layer 122 (the channel region 123 and the impurity region 124A), the gate insulating layer 125, and the conductive layer 126 (for example, the gate wiring 127A).

The first contact hole openings 135J, 135H, 135B, and 135A that reach the semiconducting layer 122 pass through the gate insulating layer 125 and the insulating layer 128, and are arranged in the gate insulating layer 125 and the insulating layer 128. For example, the first contact hole opening 135J exposes the semiconductor layer 122D (for example, the second electrode 626 and the first electrode 684), and the first wiring 132K is electrically connected to the semiconductor layer 122D by the first contact hole opening 135J. Further, the first contact hole opening 135H exposes the semiconductor layer 122A (for example, the second electrode 626), and the first contact hole opening 135H electrically connects the first wiring 132G to the semiconductor layer 122A. The first contact hole opening 135C exposes the conductive layer 126 (the gate wiring 127A), and the first contact hole opening 135B exposes the semiconductor layer 122 (the semiconductor layer 122C). The first wiring 132E is electrically connected by the first contact hole opening 135C to the gate wiring 127A, and the first wiring 132E is electrically connected by the first contact hole opening 135B to the semiconductor layer 122D. That is, an opening portion reaching the conductive layer 126 or the semiconductor layer 122 may be arranged in the insulating layer 128. Further, the first contact hole opening 135A exposes the semiconductor layer 122C (for example, the second electrode 636), and the first contact hole opening 135A electrically connects the first wiring 132F to the semiconductor layer 122C.

An insulating layer 131 is arranged to cover the conductive layer 132 and the insulating layer 131 where the conductive layer 132 is not exposed. An insulating layer 136 is arranged to cover the insulating layer 131.

A second contact hole opening is arranged in the insulating layer 131 and the insulating layer 136. For example, the second contact hole opening includes the second contact hole opening 138H. In addition, the organic insulating film opening 138A for the capacitive element CS is arranged in the insulating layer 136. A conductive layer 139 is arranged on the insulating layer 136 in the organic insulating film opening 138A and the second contact hole opening 138H for the capacitive element CS. The conductive layer 139 includes the second wiring 140C (first electrode 32), the second wiring 140A (first electrode 52 and second electrode 44), and the second wiring 140B. The second contact hole opening 138H exposes the first wiring 132K. The second contact hole opening 138H electrically connects the second wiring 140C (the first electrode 32) and the first wiring 132K. The organic insulating film opening 138A for the capacitive element exposes the insulating layers 131. For example, the capacitive element CV is formed using the insulating layer 131 as a dielectric and using the first wiring 132E (the first electrode 42) and the second wiring 140A (the first electrode 52 and the second electrode 44), and the capacitive element CD is formed using the insulating layer 131 as a dielectric and using the first wiring 132H (the second electrode 54) and the second wiring 140A (the first electrode 52 and the second electrode 44). For example, the second wiring 140A also serves as a pixel electrode. Further, although not shown, for example, a second contact hole opening 138 exposes a part of a plurality of terminals (not shown) included in the terminal portion 150. Part of the exposed terminals is electrically connected to the FPC 200 using a conductive film such as an anisotropic conductive film (not shown). Further, the pixel electrodes are arranged independently for each pixel.

An insulating layer 141 is arranged to cover the conductive layer 139.

The underlayer 121, the semiconductor layer 122, the gate insulating layer 125, the conductive layer 126, the insulating layer 128, the conductive layer 132, the insulating layer 131, the insulating layer 136, the conductive layer 139, and the insulating layer 141 are collectively referred to as an array unit 170.

Next, layers above the insulating layer 141 will be described. The contact hole opening 147 for the cathode electrode is arranged in the insulating layer 141. The contact hole opening 147 for the cathode exposes the conductive layer 139 (for example, the second wiring 140C).

A cathode electrode 143 is arranged so as to cover the exposed conductive layer 139, the contact hole opening 147 for the cathode electrode, and the insulating layer 141. The functional layer 148 is arranged over the cathode electrode 143. A common electrode 149 is arranged on the functional layer 148 so as to cover the functional layer 148. The common electrode 149 is electrically connected to a cathode electrode (the first electrode 32 of the light-emitting element OLED). Here, the light-emitting element OLED includes the cathode electrode 143, the functional layer 148, and the common electrode 149 (anode electrode).

The configuration of the functional layer 148 can be selected as appropriate. For example, the functional layer 148 may be formed by combining a carrier injection layer, a carrier transport layer, a light emitting layer, a carrier blocking layer, an exciton blocking layer, and the like. For example, the functional layer 148 shown in FIG. 9 includes a first layer 144, a second layer 145, and a third layer 146. For example, the first layer 144 is a carrier (electron) injection and transport layer, the second layer 145 is a light emitting layer, and the third layer 146 is a carrier (hole) injection and transport layer. For example, the functional layer 148 is provided independently for each pixel, similar to the pixel electrode.

A sealing film 165 is arranged on the common electrode 149. For example, the sealing film 165 includes a first inorganic insulating layer 152, an organic insulating layer 154, and a second inorganic insulating layer 156. The first inorganic insulating layer 152 and the second inorganic insulating layer 156 are formed so as to cover at least the display region 22. A cover film 158 is arranged over the second inorganic insulating layer 156.

For example, the first layer 144, the second layer 145 (light-emitting layer) and the third layer 146, and the common electrode 149 included in the functional layer 148 are not arranged on the IC chip 110 and the control circuit 120. The sealing film 165 and the cover film 158 are arranged above the IC chip 110 and the control circuit 120. The sealing film 165 and the cover film 158 prevent impurities (for example, water and oxygen) from entering the light-emitting element OLED and the transistors from outside of the display device 10.

A general metal material is used as the conductive layer 126, the conductive layer 132, the conductive layer 139, and the common electrode 149. For example, aluminum (Al), titanium (Ti), chromium (Cr), cobalt (Co), nickel (Ni), molybdenum (Mo), hafnium (Hf), tantalum (Ta), tungsten (W), bismuth (Bi), silver (Ag), copper (Cu), and alloys or compounds thereof are used as general metal materials.

For example, the semiconductor layer 122 may include crystalline silicon and may include a metal oxide.

A general insulating material can be used as a material for forming the base layer 121, the gate insulating layer 125, the insulating layer 131, the first inorganic insulating layer 152, and the second inorganic insulating layer 156. For example, inorganic insulating layers such as silicon oxide (SiOₓ), silicon oxynitride (SiOₓN_{y}), silicon nitride (SiNₓ), and silicon nitride oxide (SiNₓO_{y}) are used as the insulating layers.

For example, an organic compound material having excellent surface flatness can be used as a material for forming the insulating layer 128, the insulating layer 136, the insulating layer 141, and the organic insulating layer 154. The insulating layer 128, the insulating layer 136, and the insulating layer 141 may be referred to as an organic insulating layer.

### [1-7. Method for Manufacturing Display Device 10]

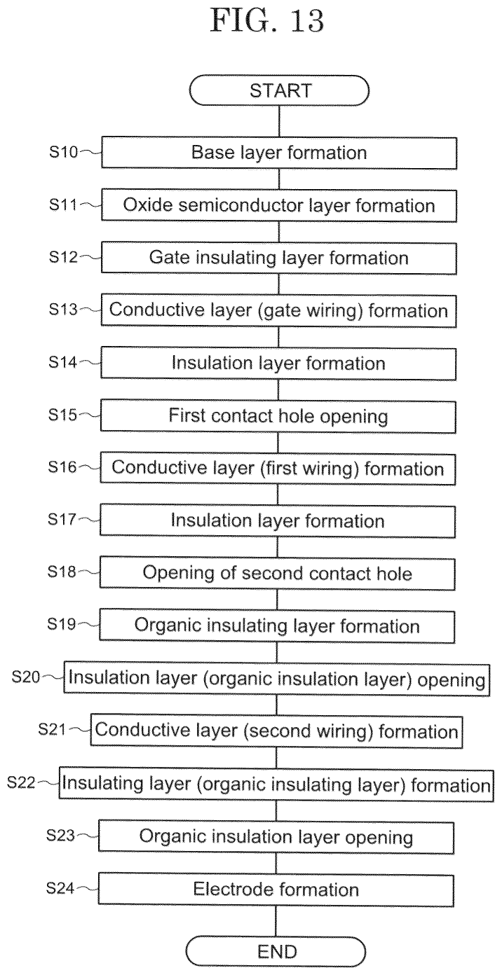

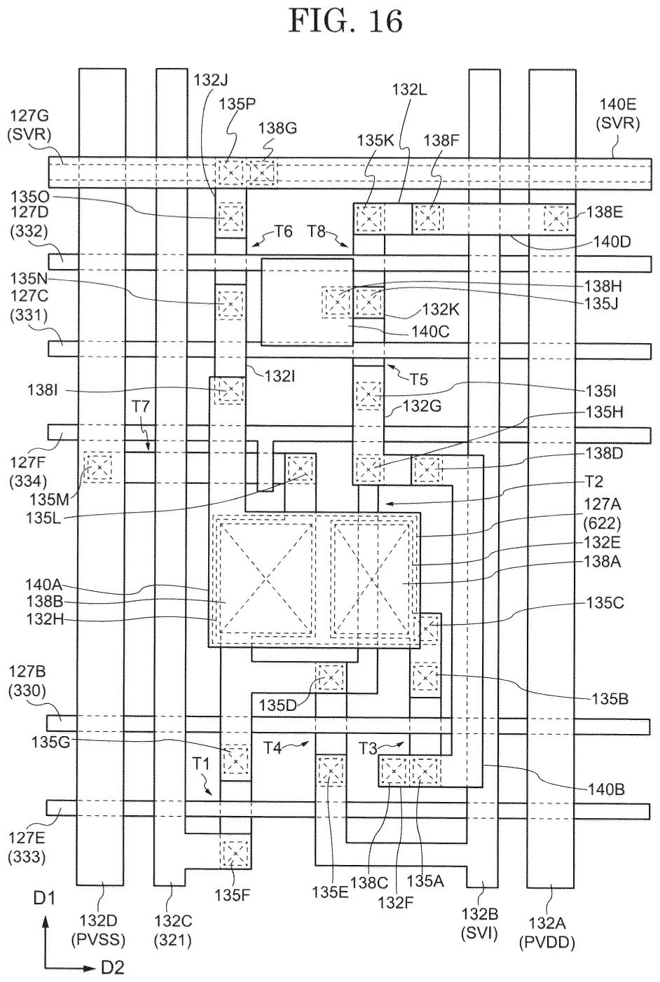

A method for manufacturing the display device 10 (the pixel 180) will be described with reference to FIG. 9, FIG. 13, and FIG. 16. FIG. 13 is a sequence diagram showing a method for manufacturing the display device 10. Configurations that are the same as or similar to those in FIG. 1 to FIG. 12 will be described as necessary. The manufacturing method shown in FIG. 13 includes, for example, that the semiconductor layer is an oxide semiconductor layer formed using an oxide semiconductor.

As shown in FIG. 10 to FIG. 12, when the manufacturing of the display device 10 (the pixel 180) is started, the base layer 121 is formed on the first surface 101A of the substrate 101.

As shown in FIG. 9, FIG. 13, or FIG. 14, the semiconducting layer 122 is formed on the base layer 121 (step 10 (S10) in FIG. 13). The semiconductor layer 122 includes semiconductor layers 122A, 122B, 122C, 122D, 122E, and 122F. The semiconductor layer 122A also serves as a semiconductor layer of the second transistor T2 and a semiconductor layer of the fourth transistor T4. The semiconductor layer 122B is a semiconductor layer of the first transistor T1. The semiconductor layer 122C is a semiconductor layer of the third transistor T3. The semiconductor layer 122D also serves as a semiconductor layer of the fifth transistor T5 and a semiconductor layer of the eighth transistor T8. The semiconductor layer 122E is a semiconductor layer of the sixth transistor T6. The semiconductor layer 122F is a semiconductor layer of the seventh transistor T7. In other words, the semiconductor layer 122A includes the channel region of the second transistor T2 and the channel region of the fourth transistor T4, the semiconductor layer 122B includes the channel region of the first transistor T1, the semiconductor layer 122C includes the channel region of the third transistor T3, the semiconductor layer 122D includes the channel region of the fifth transistor T5 and the channel region of the eighth transistor T8, the semiconductor layer 122E includes the channel region of the sixth transistor T6, and the semiconductor layer 122F includes the channel region of the seventh transistor T7.

The gate insulating layer 125 (FIG. 10 to FIG. 12) is formed on the semiconductor layer 122 and on the base layer 121 on which the semiconductor layer 122 is not formed (step 12 (S12) in FIG. 13).

The conductive layer 126 (FIG. 10 to FIG. 12) is formed over the gate insulating layer 125 (step 13 (S13) of FIG. 13). As shown in FIG. 9, FIG. 13, and FIG. 14, the conductive layer 126 includes the gate wiring 127A (the gate electrode 622), the gate wiring 127B (the scan signal line 330), a gate wiring 127C (scan signal line 331), a gate wiring 127D (the scan signal line 332), a gate wiring 127E (the scan signal line 333), a gate wiring 127F (the scan signal line 334), and a gate wiring 127G (the reference voltage power supply line SVR). The gate wiring 127B (the scan signal line 330) includes gate electrodes 632 and 642, the gate wiring 127C (the scan signal line 331) includes the gate electrode 652, the gate wiring 127D (the scan signal line 332) includes the gate electrodes 662 and 682, the gate wiring 127E (the scan signal line 333) includes the gate electrode 612, and the gate wiring 127F (the scan signal line 334) includes the gate electrode 672.

A region where the gate electrode 622 of the second transistor T2 and the semiconductor layer 122A overlap each other is the channel region 123, and the channel region 123 corresponds to a channel length of the second transistor T2. Similar to the second transistor T2, a region where the gate electrode 612 of the first transistor T1 and the semiconductor layer 122B overlap each other is a channel region of the first transistor T1 and corresponds to a channel length. Similar to the second transistor T2, the transistor other than the second transistor T2 and the first transistor T1 has a region where the gate electrode and the semiconductor layer overlap each other, which is a channel region of the transistor and corresponds to a channel length.

As shown in FIG. 14, in a plan view, the channel region 123 of the second transistor T2 is larger (longer) than the channel region of the first transistor T1, the channel region of the third transistor T3, the channel region of the fourth transistor T4, the channel region of the fifth transistor T5, the channel region of the sixth transistor T6, and the channel region of the seventh transistor T7. That is, the channel length of the second transistor T2 is longer than the channel length of the first transistor T1, a channel length of the third transistor T3, a channel length of the fourth transistor T4, a channel length of the fifth transistor T5, a channel length of the sixth transistor T6, and a channel length of the seventh transistor T7. Since the second transistor T2 operates in the saturated range, a kink effect needs to be suppressed. Furthermore, the resistance of the second transistor T2 to hot carriers needs to be higher than the resistance of other transistors in the pixel 180 to hot carriers. The channel length of the second transistor T2 is longer than the channel length of the other transistors in the pixel 180 in order to suppress the kink effect and ensure reliability (hot carrier resistance).

The insulating layer 128 (FIG. 10 to FIG. 12) is formed over the conductive layer 126 and over the gate insulating layer 125 where the conductive layer 126 is not formed (step 14 (S14) of FIG. 13).

As shown in FIG. 9, FIG. 13, or FIG. 14, first contact hole openings 135A to 1350 are opened (step 15 (S15) in FIG. 13). Each opening opens the gate insulating layer 125 and the insulating layer 128, and exposes a wiring, a semiconductor layer, or an electrode corresponding to each opening. For example, the first contact hole opening 135A exposes the semiconductor layer 122C, and the first contact hole opening 135C exposes the gate wiring 127A. Other openings also expose corresponding wirings, semiconductor layers, or electrodes.

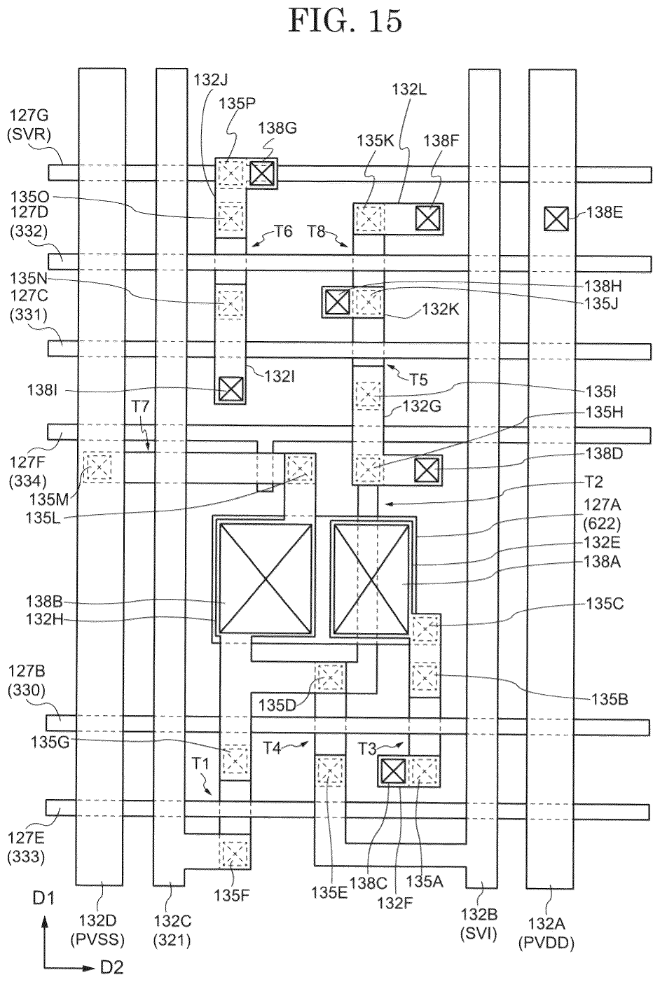

The conductive layer 132 (FIG. 10 to FIG. 12) is formed over the insulating layer 128 (step 16 (S16) of FIG. 13). As shown in FIG. 9, FIG. 13, or FIG. 15, the conductive layer 132 includes a first wiring 132A (the drive power supply line PVDD), a first wiring 132B (the initialization voltage power supply line SVI), a first wiring 132C (the image data signal line 321), a first wiring 132D (the standard voltage line PVSS), the first wiring 132E (first electrode 42), the first wiring 132F, a first wiring 132G a first wiring 132H (the second electrode 54), a first wiring 132I, a first wiring 132J, a first wiring 132K, and a first wiring 132L.

As shown in FIG. 15, in a plan view, for example, the first wiring 132B is electrically connected to the second transistor T4 via the first contact hole opening 135E, and the first wiring 132C is electrically connected to the first transistor T1 via the first contact hole opening 135F. The first wiring 132D is electrically connected to the seventh transistor T7 via the first contact hole opening 135M. The first wiring 132E is electrically connected to the gate wiring 127A via the first contact hole opening 135C, and is electrically connected to the third transistor T3 via the first contact hole opening 135B. The other first wirings are also electrically connected to the gate wiring or the transistor (the semiconductor layer 122) through the corresponding opening.

In addition, as shown in FIG. 15, the first wiring 132E (the first electrode 42), the gate wiring 127A (the gate electrode 622), and the semiconductor layer 122A (the channel region 123) overlap each other. That is, the second transistor T2 (the channel region and the gate electrode 622) overlaps the first electrode 42 of the capacitive element CV. The first electrode 42 and the first wiring 132H (the second electrode 54) are arranged adjacently on the gate electrode 622.

An insulating layer 131 (FIG. 10 to FIG. 12) is formed on the conductive layer 132 and on the insulating layer 128 on which the conductive layer 132 is not formed (step 17 (S17) of FIG. 13).

As shown in FIG. 9, FIG. 13, or FIG. 15, second contact hole openings 138C to 138H are opened (step 18 (S18) in FIG. 13). Each opening opens the insulating layer 131 to expose a wiring, a semiconductor layer, or an electrode corresponding to each opening.

The insulating layer 136 (organic insulating layer) (FIG. 10 to FIG. 12) is formed on the insulating layer 131 (step 19 (S19) in FIG. 13).

As shown in FIG. 9, FIG. 13, or FIG. 15, the insulating layer 136 (organic insulating layer) is opened (step 20 (S20) in FIG. 13). In the opening of S20, organic insulating film openings 138A and 138B for the capacitive element are opened. In addition, in the opening of S20, the second contact hole openings 138C to 138H are opened similar to the opening of S18. That is, the second contact hole openings 138C to 138H are opened twice. Each opening opens the insulating layer 136 to expose an insulating layer, a wiring, or an electrode corresponding to each opening. For example, the organic insulating film opening 138A for the capacitive element removes only the insulating layer 136 on the first wiring 132E (the first electrode 42) to expose the insulating layer 131. On the other hand, the organic insulating film opening 138B for the capacitive element removes only the insulating layer 136 on the first wiring 132H (the second electrode 54) to expose the first wiring 132H. Other openings also expose corresponding insulating layers, wires, or electrodes.

The conductive layer 139 (FIG. 10 to FIG. 12) is formed on the insulating layer 136, on the insulating layer 131 exposed by the organic insulating film opening 138A for the capacitive element, and on the insulating layer 131 exposed by the organic insulating film opening 138B for the capacitive element (step 21 (S21) in FIG. 13). As shown in FIG. 9 or FIG. 16, the conductive layer 139 includes the second wiring 140A (the first electrode 52 and the second electrode 44), the second wiring 140B, the second wiring 140C (the first electrode 32), a second wiring 140D, and a second wiring 140E (the reference voltage power supply line SVR).

As shown in FIG. 16, in a plan view, the second wiring 140A (the first electrode 52 and the second electrode 44) is electrically connected to the sixth transistor T6 via a second contact hole opening 138I, the first wiring 132I, and the first contact hole opening 135N. The second wiring 140C is electrically connected to the first wiring 132K, the fifth transistor T5, and the eighth transistor T8 via the second contact hole opening 138H and the first contact hole opening 135J. The second wiring 140E is electrically connected to the first wiring 132J, the sixth transistor T6, and the gate wiring 127G via the second contact hole opening 138G and a first contact hole opening 135P. The other second wirings are also electrically connected to the first wiring, the gate wiring or the transistor (the semiconductor layer 122) via the respective openings.

In addition, as shown in FIG. 16, the second wiring 140A (the first electrode 52 and the second electrode 44), the first wiring 132E (the first electrode 42), the gate electrode 622, and the semiconductor layer 122A (the channel region 123) overlap each other. That is, the second transistor T2 overlaps the capacitive element CV. The first electrode 42 and the first wiring 132H (the second electrode 54) are arranged adjacently on the gate electrode 622. That is, the capacitive element CV and the capacitive element CD are arranged adjacently.

The insulating layer 141 (organic insulating layer) (FIG. 10 to FIG. 12) is formed on the conductive layer 139 and on the insulating layer 136 on which the conductive layer 139 is not formed (step 22 (S22) in FIG. 13).

As shown in FIG. 9 and FIG. 10, the insulating layer 141 (organic insulating layer) is opened (step 23 (S23) in FIG. 13). In the opening of S23, a contact hole opening 147A for the cathode is opened. The contact hole opening 147A for the cathode removes the insulating layer 141 on the second wiring 140C to expose the second wiring 140C. The contact hole opening 147A for the cathode may be referred to as an organic insulating layer opening. In addition, as illustrated in FIG. 9 and FIG. 10, the contact hole opening 147A for the cathode electrode overlaps the second wiring 140C in a plan view.

The cathode electrode 143 is arranged on the exposed second wiring 140C, on the contact hole opening 147A for the cathode electrode, and on the insulating layer 141. In addition, the functional layer 148 is arranged on the cathode electrode 143 (FIG. 10). The common electrode 149 is arranged on the functional layer 148 (step 24 (S24) in FIG. 13). In addition, for example, the cathode electrode 143 and the functional layer 148 are arranged for each pixel, and the common electrode 149 is arranged so as to overlap the display region 22.

After S24, the sealing film 165 and the covering film 158 are arranged on the common electrode 149 in this order (FIG. 10).

As described above, the manufacturing of the display device 10 (the pixel 180) is completed.

### [1-8. Relationship Between Potential Difference and Capacitance Value]

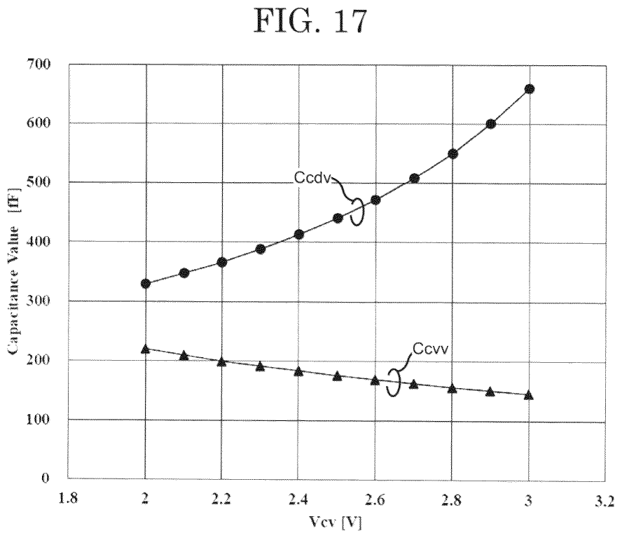

Referring to FIG. 17, a relationship between an absolute value of a potential difference between a voltage supplied to the first electrode 42 of the capacitive element CV and a voltage supplied to the second electrode 44 (potential difference Vcv) and a capacitance value Ccvv of the capacitive element CV, and a relationship between the potential difference Vcv and a capacitance value Ccdv of the capacitive element CD will be described.

Ideally, the capacitance value Ccvv and the capacitance value Ccdv are estimated such that the absolute value of the potential difference between the electrodes of the capacitive element CV is the same as an absolute value of the potential difference between the electrodes of the capacitive element CD, and the withstand voltages of the capacitive element CV and the capacitive element CD are the same or approximately the same. In this case, the second electrode 44 and the first electrode 52 are electrically connected to the first node N1, and the reference voltage VREF (2 V) is supplied.

For example, it is assumed that a ratio of leakage charges (leakage currents) of the capacitive element CV and the capacitive element CD is 2:3, a charge amount Qcv that the capacitive element CV can hold is 440 fC, and a charge amount Qcd that the capacitive element CD can hold is 660 fC. Further, for example, it is assumed that the second electrode 54 is supplied with the voltage VSIGL (4 V) at most, and a potential difference between the electrodes of the capacitive element CD (a potential difference between the voltage supplied to the first electrode 52 and the voltage supplied to the second electrode 54) is a potential difference Vcd (4 V−potential difference Vcv).

As shown in FIG. 17, for example, in the case where the potential difference Vcv is 2.2 V, the capacitance value Ccvv needs to be 200 fF. In this case, the potential difference Vcd is 1.8 V (4 V−2.2 V) and the capacitance value Ccdv is 370 fF. For example, in order to quickly obtain the threshold voltage VTH, it is desirable to estimate the capacitance value Ccvv to be smaller than the capacitance value Ccdv.

As described above, the relationship between the potential difference Vcv and the capacitance value Ccvv and the relationship between the potential difference Vcd and the capacitance value Ccdv can be estimated, and can be designed using the estimated capacitance value Ccvv and capacitance value Ccdv.

Further, by using the estimated capacitance value Ccvv and capacitance value Ccdv, the withstand voltage required for the capacitive element CV and the capacitive element CD can be balanced, and the threshold voltage VTH can be acquired at high speed.

### 2. Second Embodiment

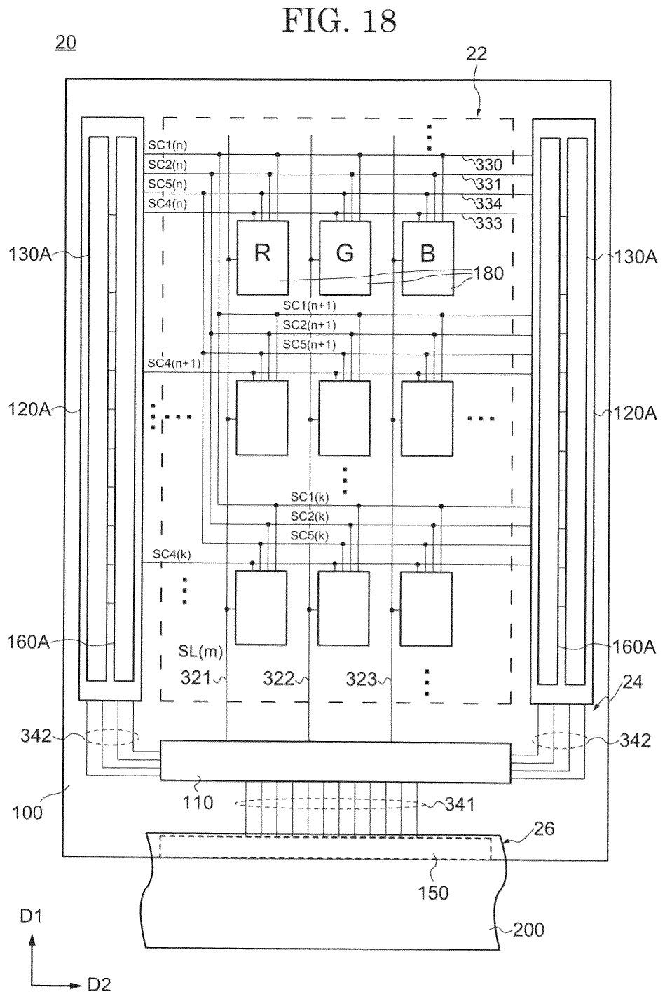

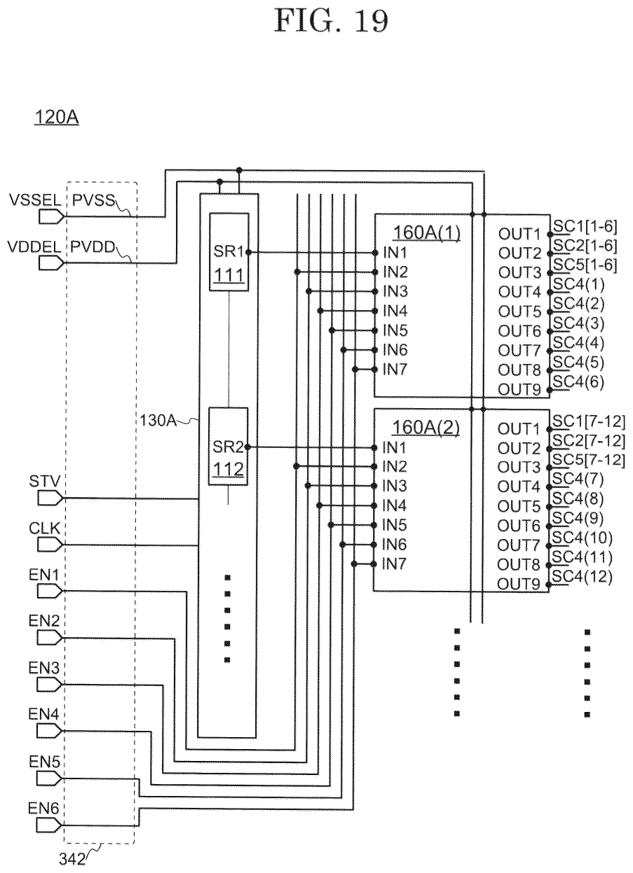

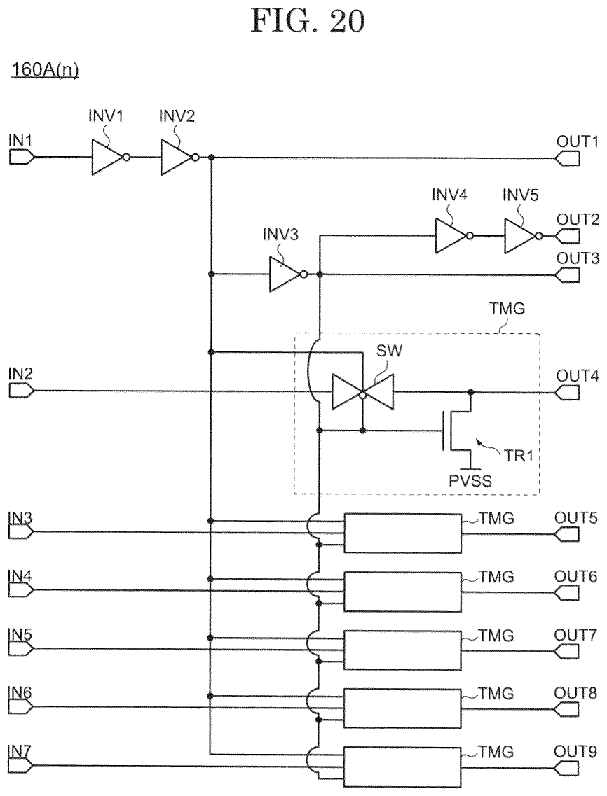

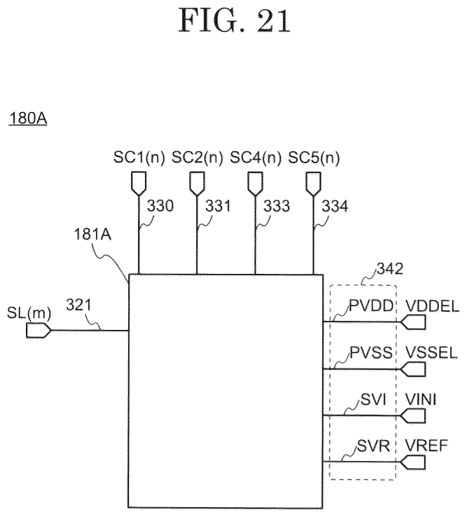

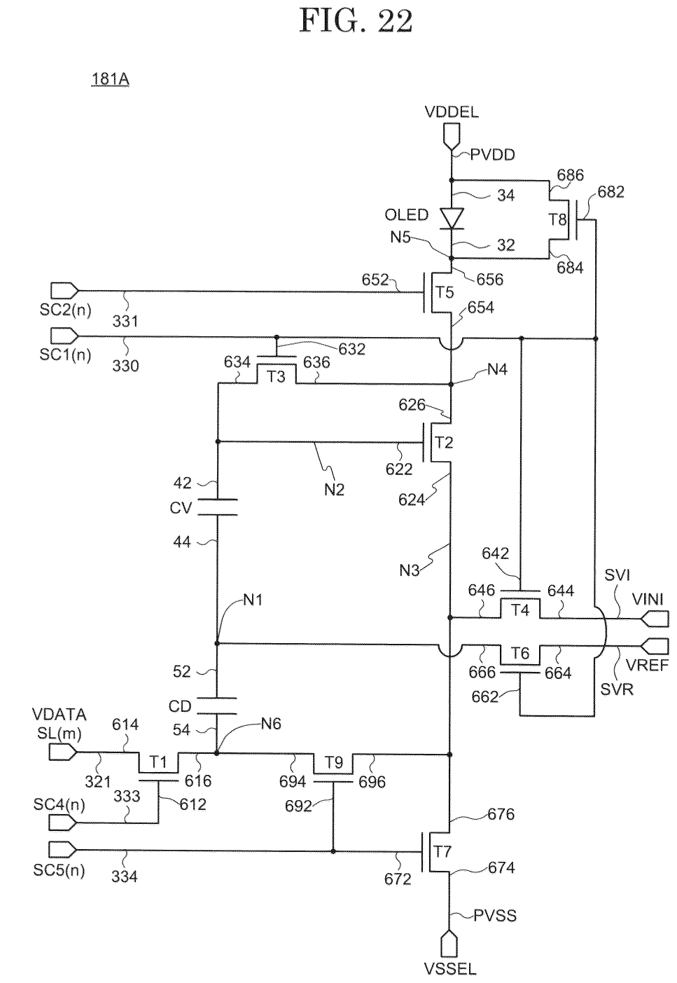

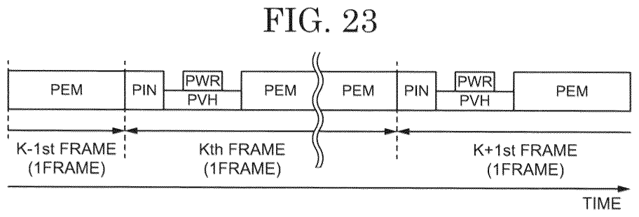

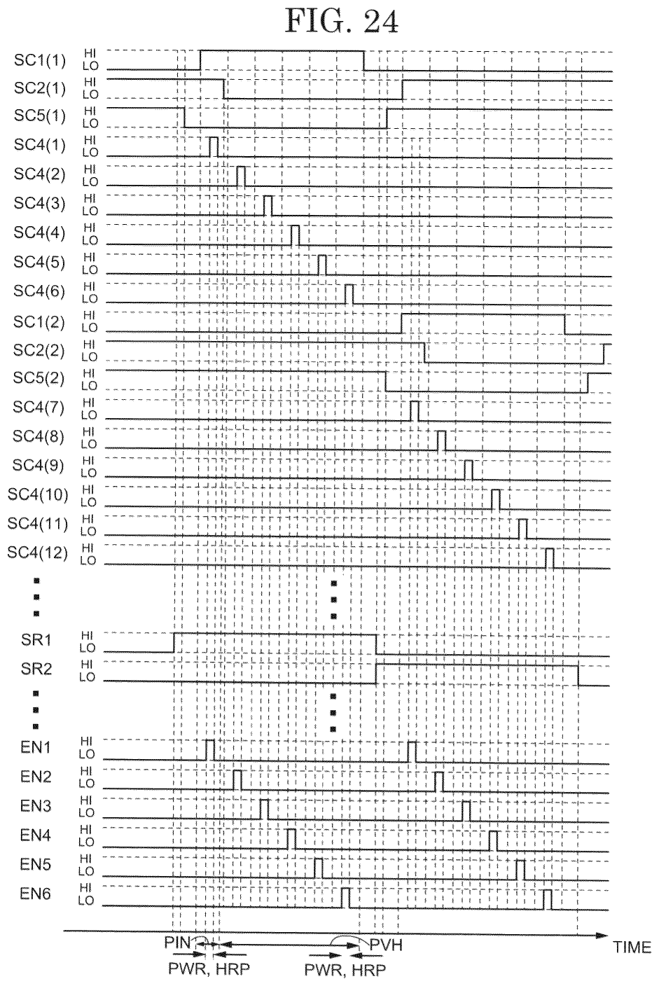

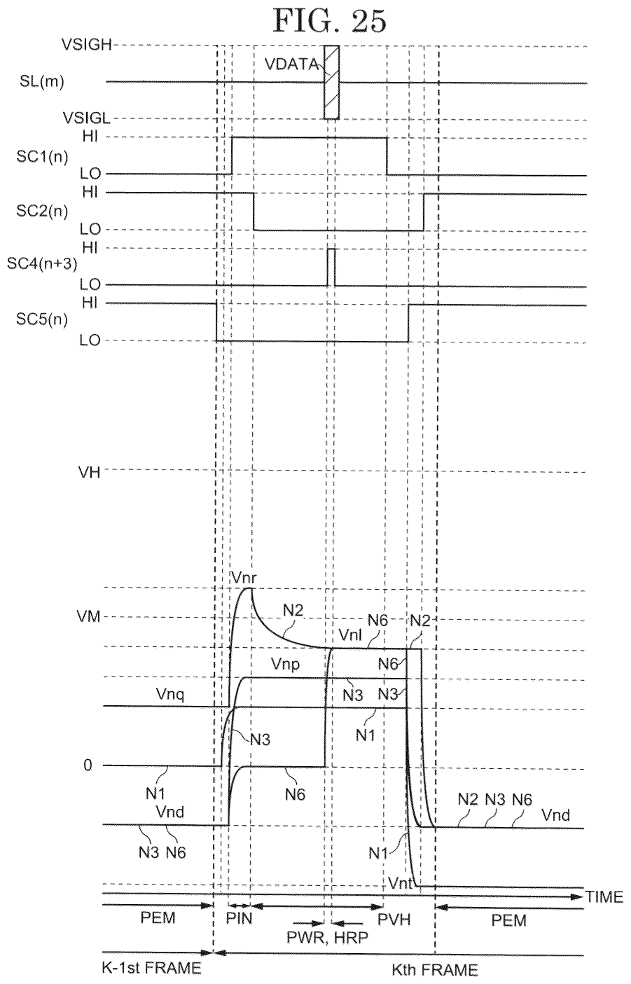

Referring to FIG. 18 to FIG. 28, a display device 20 according to a second embodiment will be described. FIG. 18 is a schematic diagram showing a configuration of the display device 20. FIG. 19 is a schematic diagram showing a configuration of a control circuit 120A according to the second embodiment, and FIG. 20 is a circuit diagram showing a configuration of a scan driver 160A(n) according to the second embodiment. FIG. 21 is a schematic diagram showing an input signal to a pixel 180A (pixel circuit 181A) according to the second embodiment, and FIG. 22 is a circuit diagram showing a configuration of the pixel circuit 181A. FIG. 23, FIG. 25 to FIG. 28 are timing charts of the display device 20, and FIG. 24 is a timing chart of the control circuit 120A. Configurations that are the same as or similar to those in FIG. 1 to FIG. 17 will be described as necessary, and descriptions of the same or similar configurations as those in FIG. 1 to FIG. 17 may be omitted.

The display device 20 includes the control circuit 120A, the pixel 180A, and the pixel circuit 181A. Specifically, the display device 20 includes the following configurations (1) to (6). Mainly, the configurations shown in (1) to (6) are different from the configuration of the display device 10 according to the first embodiment.
(1) A configuration and function in which the control circuit 120 of the display device 10 according to the first embodiment is replaced with the control circuit 120A, and a configuration and function related to the control circuit 120A differ from the configuration and the function related to the control circuit 120.
(2) The electrical connection between the control circuit 120A and the pixel 180A (pixel circuit 181A) differs from the electrical connection between the control circuit 120 and the pixel 180 (pixel circuit 181).
(3) The first scan signal SC1(n) also serves as the scan signal SC3(n). That is, the display device 20 does not include the scan signal SC3(n) and the scan signal line 332 to which the scan signal SC3(n) is supplied.
(4) The pixel 180A (pixel circuit 181A) includes a ninth transistor T9. The ninth transistor T9 is electrically connected between the sixth node N6 and the third node N3, and a gate electrode 692 of the ninth transistor T9 is electrically connected to the scan signal line 334.
(5) A method for driving the display device 20 includes executing the period PWR and the period PVH in parallel.
(6) A method for driving the display device 20 includes executing the period PIN and the period PWR in parallel.

Configurations other than those shown in (1) to (6) in the display device 20 and configurations other than those related to the configurations shown in (1) to (6) in the display device 20 are the same as those of the display device 10 according to the first embodiment. In describing the configuration and function of the display device 20, the same configuration and function as those of the display device 10 will be described as necessary.

### [2-1. Configuration of Control Circuit 120A]

Referring to FIG. 18 to FIG. 20, an overview of the control circuit 120A will be described.

As shown in FIG. 18, the two control circuit 120A are provided at positions adjoining both sides of the display region 22 along the second direction D2 of the display region 22. The scan signal line 330, the scan signal line 331, the scan signal line 333, and the scan signal line 334 extend from the control circuit 120A along the second direction D2 and are connected to a plurality of pixels 180A arranged along the second direction D2.

As shown in FIG. 19, the control circuit 120A includes a shift register circuit 130A and a plurality of scan drivers 160A(n). For example, the control circuit 120A is a gate driver. The number n is a positive integer. For example, the control circuit 120A receives control signals such as a clock signal CLK, a start pulse STV, enable signals EN1 to EN6, and voltages such as the driving voltage VDDEL and the standard voltage VSSEL. The control circuit 120A can select the scan lines sequentially by inputting a control signal and a power supply.

The shift register 130A is electrically connected to the plurality of scan drivers 160A(n). The shift register circuit 130A includes a plurality of shift registers (for example, shift registers 111 and 112). Further, the shift register circuit 130A is supplied with the clock signal CLK, the start pulse STV, and the like via a plurality of connection wirings 342, the driving voltage VDDEL is supplied via the drive power supply line PVDD, and the standard voltage VSSEL is supplied via the standard voltage line PVSS. The shift register circuit 130A has a role of generating a plurality of output signals shifted at different timings (an output signal SR1, an output signal SR2, . . . ) based on a control signal such as the clock signal CLK and a start pulse STV, and sequentially outputting a plurality of scan drivers (for example, the scan driver 160A (1), the scan driver 160A (2), . . . ).

For example, the shift register 111 is electrically connected to the shift register 112. The shift register 111 is electrically connected to the scan driver 160A (1) and supplies the output signal SR1 to an input terminal IN1 of the scan driver 160A (1). The shift register 112 is electrically connected to the scan driver 160A (2) and supplies the output signal SR2 to an input terminal IN1 of the scan driver 160A (2).

The scan driver 160A(n) has seven input terminals (input terminals IN1 to IN7) and nine output terminals (output terminals OUT1 to OUT9). The plurality of scan drivers 160A(n) is supplied with enable signals EN1 to EN6 from the IC chip 110 via the plurality of connection wirings 342, with the driving voltage VDDEL via the drive power line PVDD, and with the standard voltage VSSEL via the standard voltage line PVSS. The scan driver 160A(n) has a function of sequentially supplying scan signals having different timings (for example, the first scan signal SC1(n), the second scan signal SC2(n), the fourth scan signal SC4(n), and the fifth scan signal SC5(n)) to the respective scan signal lines based on the plurality of output signals and the enable signals EN1 to EN6, and driving the pixel 180A (pixel circuit 181A) electrically connected to the respective scan signal lines.

For example, as shown in FIG. 20, the scan driver 160A(n) includes inverter circuits INV1 to INV5 and six transmission gates TMG. Each of the six transmission gates TMG includes a switch SW and a transistor TR1. The switch SW has a configuration in which an n-channel field effect transistor and a p-channel field effect transistor are electrically connected to each other. The transistor TR1 is electrically connected to the inverter circuit INV3, the standard voltage line PVSS, the p-channel field effect transistor, and a corresponding output terminal (transmission gate TMG). The inverter circuit INV1 is electrically connected to the input terminal IN1 and the inverter circuit INV2. The inverter circuit INV2 is electrically connected to the output terminal OUT1, the inverter circuit INV3, and the switches SW (n-channel field effect transistors) in the six transmission gates TMG. The inverter circuit INV3 is electrically connected to the inverter circuit INV4, the switches SW (p-channel field effect transistors) in the six transmission gates TMG, and the output terminal OUT3. The inverter circuit INV4 is electrically connected to the inverter circuit INV5, and the inverter circuit INV5 is electrically connected to the output terminal OUT2. The six transmission gates TMG are electrically connected to the input terminals IN2 to IN7 in a one-to-one manner, and are electrically connected to the output terminals OUT4 to OUT9 in a one-to-one manner. Specifically, the transmission gate TMG electrically connected to the input terminal IN2 is electrically connected to the output terminal OUT4, the transmission gate TMG electrically connected to the input terminal IN3 is electrically connected to the output terminal OUT5, the transmission gate TMG electrically connected to the input terminal IN4 is electrically connected to the output terminal OUT6, the transmission gate TMG electrically connected to the input terminal IN5 is electrically connected to the output terminal OUT7, the transmission gate TMG electrically connected to the input terminal IN6 is electrically connected to the output terminal OUT8, and the transmission gate TMG electrically connected to the input terminal IN7 is electrically connected to the output terminal OUT9.

For example, as shown in FIG. 18 and FIG. 19, the scan signal SC1(n), the scan signal SC2(n), and the scan signal SC5(n) are input for every k rows. The scan signal lines 330 in n-th to k-th rows are electrically connected along the second direction D2. Similar to the scan signal line 330, the scan signal lines 331 in the n-th to k-th rows are electrically connected, and the scan signal lines 334 in the n-th to k-th rows are electrically connected. That is, the plurality of pixels 180A (pixel circuits 181A) electrically connected to the scan signal lines 330, 331, and 334 in the n-th to k-th rows are input with the scan signal SC1(n) supplied to the common scan signal line 330 at the same timing, with the scan signal SC2(n) supplied to the common scan signal line 331 at the same timing, and with the scan signal SC5(n) supplied to the common scan signal line 334 at the same timing.

For example, as shown in FIG. 18 and FIG. 19, the scan signal SC4(n) is input for each row. That is, the plurality of pixels 180A (pixel circuits 181A) electrically connected to the scan signal line 333 of the n-th row are input with the scan signal SC4(n) supplied to the scan signal line 333 of the n-th row. Similar to the plurality of pixels 180A (pixel circuit 181A) electrically connected to the scan signal line 333 of the n-th row, the plurality of pixels 180A (pixel circuit 181A) electrically connected to the scan signal line 333 of an n+1-th row are input with a scan signal SC4(n+1) supplied to the scan signal line 333 of the n+1-th row, and the plurality of pixels 180A (pixel circuit 181A) electrically connected to the respective scan signal lines 333 of an n+2-k-th row are input with scan signals SC4(n+2) to SC4(k) supplied to the respective scan signal lines 333 of the n+2-k-th row.

The control circuit 120A shown in FIG. 19, as an example, n is 1, k is 6. That is, the plurality of pixels 180A (pixel circuits 181A) electrically connected to the scan signal lines 330, 331, and 334 in the first to sixth rows are input with a scan signal SC1(1) supplied to the common scan signal line 330 at the same timing, with a scan signal SC2(1) supplied to the common scan signal line 331 at the same timing, and with a scan signal SC5(1) supplied to the common scan signal line 334 at the same timing. In addition, the plurality of pixels 180A (pixel circuits 181A) electrically connected to the scan signal line 333 of the first row are input with a scan signal SC4(1) supplied to the scan signal line 333 of the first row, and similar to the plurality of pixels 180A (pixel circuits 181A) electrically connected to the scan signal line 333 of the first row, the plurality of pixels 180A (pixel circuits 181A) electrically connected to the scan signal line 333 of the second to sixth rows are input with the scan signals SC4(n) (scan signals SC4(2) to SC4(6)) supplied to the scan signal line 333 of the corresponding row, respectively.

In the plurality of pixels 180A (pixel circuits 181A) of the seventh to twelfth rows corresponding to the six rows following the sixth row, a scan signal SC1(2) is input at the same timing, a scan signal SC2(2) is input at the same timing, a scan signal SC5(2) is input at the same timing, and scan signals SC4(7) to SC4(12) respectively supplied to the scan signal lines 333 of the corresponding rows are input at the same timing similar to the plurality of pixels 180A (pixel circuits 181A) up to the sixth row.

In addition, in the control circuit 120A shown in FIG. 19, the scan signal SC1(n), the scan signal SC2(n), and the scan signal SC5(n) supplied to each of the scan signal lines 330, 331, and 334 in the first to sixth rows are described as the scan signal SC1[1-6], the scan signal SC2[1-6], and the scan signal SC5[1-6], and the scan signal SC1(n), the scan signal SC2(n), and the scan signal SC5(n) supplied to each of the scan signal lines 330, 331, and 334 in the seventh to twelfth rows are described as the scan signal SC1 [7-12], the scan signal SC2[7-12], and the scan signal SC5[7-12].

### [2-2. Configuration of Pixel 180A]

Referring to FIG. 21 and FIG. 22, an overview of the pixel 180A and the pixel circuit 181A will be described.

As described in (3) above, the pixel 180A (pixel circuit 181A) does not include the scan signal SC3(n) and the scan signal line 332 to which the scan signal SC3(n) is supplied, and the first scan signal SC1(n) also serves as the scan signal SC3(n) included in the pixel 180 (pixel circuit 181).

The gate electrode 662 of the sixth transistor T6 and the gate electrode 682 of the eighth transistor T8 are electrically connected to the scan signal line 330 to which the first scan signal SC1(n) is supplied. The sixth transistor T6 and the eighth transistor T8 are switched using the first scan signal SC1(n). In other words, the conduction state (on state) and the non-conduction state (off state) of the sixth transistor T6 and the eighth transistor T8 are controlled by the first scan signal SC1(n). In the case where the signal supplied to the first scan signal SC1(n) is LO, the sixth transistor T6 and the eighth transistor T8 become non-conductive, and in the case where the signal supplied to the first scan signal SC1(n) is HI, the sixth transistor T6 and the eighth transistor T8 become conductive.

In addition, as described in (4) above, the pixel 180A (pixel circuit 181A) includes the ninth transistor T9.

The ninth transistor T9 has a function of conducting the sixth node N6 and the third node N3. The ninth transistor T9 includes the gate electrode 692, a first electrode 694, and a second electrode 696. The gate electrode 692 is electrically connected to the scan signal line 334. The first electrode 694 is electrically connected to the second electrode 616 of the first transistor T1, the second electrode 54 of the capacitive element CD, and the sixth node N6. The second electrode 696 is electrically connected to the third node N3, the first electrode 624 of the second transistor T2, the second electrode 646 of the fourth transistor T4 and the second electrode 676 of the seventh transistor T7. The switching of the ninth transistor T9 is controlled using the fifth scan signal SC5(n). In other words, in the ninth transistor T9, the conduction state (on state) and the non-conduction state (off state) are controlled by the fifth scan signal SC5(n). In the case where the signal supplied to the fifth scan signal SC5(n) is LO, the ninth transistor T9 becomes non-conductive, and in the case where the signal supplied to the fifth scan signal SC5(n) is HI, the ninth transistor T9 becomes conductive.

The first transistor T1 to the ninth transistor T9 in the display device 20 are n-channel field effect transistors, and the channel regions of the first transistor T1 to the ninth transistor T9 are formed using oxide semiconductor layers having semiconductor characteristics.

The configuration and the function of the pixel circuit 181A other than the configuration and the function described in section of “2-2. Configuration of Pixel 180A” are the same as those of the pixel circuit 181.

### [2-3. Method for Driving Display Device 20]

Referring to FIG. 23 to FIG. 28, a method for driving the display device 20 will be described. The horizontal axis of the timing charts indicates time (TIME).

For example, the method for driving the display device 20 based on the timing chart shown in FIG. 23 includes executing the threshold voltage acquisition and holding period PVH after executing the initialization period PIN, and executing the writing period PWR in parallel with the period PVH as compared with the method for driving the display device 10 based on the timing chart shown in FIG. 4. In other words, the period PWR overlaps the period PVH and is executed during the period PVH. In addition, the period PWR may be executed in the period PIN.

For example, FIG. 19, FIG. 20, and FIG. 24 show a case where the period between the light emission period PEM in the K−1st FRAME period and the light emission period PEM in the Kth FRAME period includes the period PIN and the period PVH, and the period between the light emission period PEM in the K−1st FRAME period and the light emission period PEM in the Kth FRAME period is the horizontal period HRP of 6 cycles (6 horizontal periods (6HRP)).

As described in section of “2-1. Control Circuit 120A”, the output signals SR1 and SR2 (see FIG. 24) are generated based on control signals such as a clock signal CLK (see FIG. 19) and a start pulse STV (see FIG. 19). The output signals SR1 and SR2 are signals shifted at different timings. Specifically, the output signal SR2 is a signal in which the output signal SR1 is shifted. In addition, respective pulse widths of the output signals SR1 and SR2 are equal widths.

As described in section of “2-1. Control Circuit 120A”, the first scan signal SC1(n), the second scan signal SC2(n), the fourth scan signal SC4(n), and the fifth scan signal SC5(n) are generated based on the output signal SR1, the output signal SR2, and the enable signals EN1 to EN6.

For example, referring to FIG. 19, FIG. 20, and FIG. 24, the first scan signal SC1(1), the second scan signal SC2(1), and the fifth scan signal SC5(1) will be generated based on the rise and fall of the output signal SR1, the fourth scan signal SC4(1) will be generated based on the output signal SR1 and the enable signal EN1, and the fourth scan signal SC4(2) will be generated based on the output signal SR1 and the enable signal EN2, the fourth scan signal SC4(3) is generated based on the output signal SR1 and the enable signal EN3, the fourth scan signal SC4(4) is generated based on the output signal SR1 and the enable signal EN4, the fourth scan signal SC4(5) is generated based on the output signal SR1 and the enable signal EN5, and the fourth scan signal SC4(6) is generated based on the output signal SR1 and the enable signal EN6.

The fourth scan signal SC4(1) is generated in the period PIN, and the pixel 180A (pixel circuit 181A) electrically connected with the fourth scan signal SC4(1) is input with the image data signal SL(m) in the period PIN overlapping the period HRP (period PWR) in advance of the period PVH.

Further, referring to FIG. 19, FIG. 20, and FIG. 24, the first scan signal SC1(2), the second scan signal SC2(2), and the fifth scan signal SC5(2) are generated based on the rise and fall of the output signal SR2, the fourth scan signal SC4(8) is generated based on the output signal SR2 and the enable signal EN2, the fourth scan signal SC4(9) is generated based on the output signal SR2 and the enable signal EN3, the fourth scan signal SC4(10) is generated based on the output signal SR2 and the enable signal EN4, the fourth scan signal SC4(11) is generated based on the output signal SR2 and the enable signal EN5, and the fourth scan signal SC4(12) is generated based on the output signal SR2 and the enable signal EN6.

Although not shown in FIG. 24 for ease of viewing, similar to the fourth scan signal SC4(1), the fourth scan signal SC4(7) is generated in the period PIN, and the pixel 180A (pixel circuit 181A) electrically connected to the fourth scan signal SC4(7) is input with the image data signal SL(m) in the period HRP (period PWR) overlapping the period PIN.

The method for driving the display device 20 includes shifting the first scan signal SC1(n), the second scan signal SC2(n), the fifth scan signal SC5(n), and fourth scan signals SC4(n) to SC4(n+k) by k rows using the output signals SR1 and SR2 to drive the pixel 180A (pixel circuit 181A) for the corresponding k rows. Therefore, the control circuit 120A can drive the pixel 180A (the pixel circuit 181A) for k rows at a timing using a common control signal. As a result, the display device 20 includes a configuration in which the control circuit can be simplified as compared with a case where the pixels are driven for each row. In addition, the display device 20 includes a configuration capable of reducing power consumption by simplifying the control circuit, and includes a configuration capable of simplifying the control circuit as compared with a case where a pixel is driven for each row.

Next, referring to FIG. 25 to FIG. 28, one horizontal period (horizontal period HRP) of the method for driving the pixels 180 (pixel circuits 181) of the display device 20 will be described. In addition, the method for driving the pixels 180 (pixel circuits 181) of the display device 20 referring to FIG. 25 to FIG. 28 will be described with reference to a fourth scan signal SC4(n+3) among the fourth scan signals SC4(n) to SC4(n+k).

The horizontal period HRP in the method for driving the display device 20 includes the period PWR and the period PVH. The pixel 180A (pixel circuit 181A) receives the first scan signal SC1(n), the second scan signal SC2(n), the fourth scan signal SC4(n+3), and the image data signal SL(m) in the horizontal period HRP. For example, the pixel 180A (pixel circuit 181A) is selected corresponding to the timings of the first scan signal SC1(n), the second scan signal SC2(n), the fourth scan signal SC4(n), and the fifth scan signal SC5(n). The image data signal SL(m) is input to the selected pixel 180A (pixel circuit 181A) corresponding to the timings of the respective signals. A similar operation is performed on all pixels 180A (pixel circuits 181A), and an image of the current frame corresponding to 1FRAME is displayed in the display region 22 of the display device 20 based on the image data signal SL(m) input to all the pixels 180A (pixel circuits 181A).

Voltages (potentials) supplied to the respective signals and the respective nodes in the respective periods of the respective frames in the timing charts shown in FIG. 23 to FIG. 28 are the same as in Table 1.

### [2-3-1. First Example of Method for Driving Display Device 20]

A first example of a method for driving the display device 20 will be described with reference to FIG. 25. The first example of the method for driving the display device 20 includes displaying images of different colors in consecutive frames as in the first example of the method for driving the display device 10 according to the first embodiment.

As in the first example of the method for driving the display device 10 according to the first embodiment, the image data signal SL(m) including the data signal VDATA is input to each pixel 180 (the pixel circuit 181) in accordance with each period. The data signal VDATA is analog data including a voltage equal to or higher than the voltage VSIGL and equal to or lower than the voltage VSIGH. For example, in the period PWR, a voltage equal to or higher than the voltage VSIGL and equal to or lower than the voltage VSIGH is selected by using a selection signal (not shown), and is supplied to the image data signal SL(m). For example, in a period excluding the period PWR, the data signal VDATA is supplied with a voltage other than the selected pixel 180 (the pixel circuit 181).

In the light emission period PEM of the K−1 st FRAME, the image data signal SL(m) (data signal VDATA) is supplied with the voltage of the data signal VDATA other than the selected pixel 180A (pixel circuit 181A), the first scan signal SC1(n) and the fourth scan signal SC4(n+3) are supplied with LO, and the second scan signal SC2(n) and the fifth scan signal SC5(n) are supplied with HI. The first transistor T1, the third transistor T3, the fourth transistor T4, the sixth transistor T6, and the eighth transistor T8 are in the off state, and the fifth transistor T5, the seventh transistor T7, and the ninth transistor T9 are in the on state. Further, for example, the voltage supplied to the third node N3 and the sixth node N6 is the voltage Vnd (−2 V), the voltage supplied to the second node N2 is the voltage Vnq (2 V), and the potential difference Vgs is 4 V. Therefore, the second transistor T2 is in the on state, and the current Ion based on the potential difference Vgs and the potential difference Vds according to the voltage VSIGH input during the horizontal period HRP of the K−1st FRAME can be supplied from the drive power supply line PVDD to the light-emitting element OLED and the reference voltage line PVSS. Consequently, the light-emitting element OLED emits light. The voltage supplied to the first node N1 is 0 V by capacitive coupling by the capacitive element CV and the capacitive element CD. For example, the pixel 180 (the pixel circuit 181) emits red light, and emits white light by three pixels using the pixel 180 emitting red light, the pixel 180 emitting blue light, and the pixel 180 emitting green light.

In a period between the emission period PEM of the K−1st FRAME and period PIN of the Kth FRAME following the emission period PEM of the K−1st FRAME, or in the period PIN of the Kth FRAME, the image data signal SL(m) (data signal VDATA) is supplied with a voltage of the data signal VDATA supplied to a pixel other than the selected pixel 180A (pixel circuit 181A). First, the fifth scan signal SC5(n) changes from a state where HI is supplied to a state where LO is supplied. In the case where LO is supplied to the fifth scan signal SC5(n), the first scan signal SC1(n) changes from a state where LO is supplied to a state where HI is supplied. The second scan signal SC2(n) is in a state where HI is supplied, and the fourth scan signal SC4(n+3) is in a state where LO is supplied.

Consequently, in a period between the light emission period PEM of the K−1st FRAME and the period PIN of the Kth FRAME, or in period PIN of the Kth FRAME, the seventh transistor T7 and the ninth transistor T9 changes from the on state to the off state, and the current Ion does not flow from the drive power supply line PVDD to the light-emitting element OLED and the standard voltage line PVSS. In addition, the sixth node N6 becomes non-conductive with the third node N3. The third transistor T3, the fourth transistor T4, the sixth transistor T6, and the eighth transistor T8 are turned from the off state to the on state, the potential difference between the first electrode 32 and the second electrode 34 of the light-emitting element OLED is turned 0 V, the light emission of the light-emitting element OLED is stopped, and the voltage supplied to the first node N1 rises toward the voltage Vnq (the reference voltage VREF, 2 V) from 0 V and becomes the voltage Vnq. The sixth node N6 (the second electrode 616 of the first transistor T1) is in a floating state, and the voltage supplied to the sixth node N6 becomes 0V from the voltage Vnd (−2 V) so that the voltage supplied to the first node N1 is maintained by the increased amount (2 V−0 V) by capacitive coupling between the first node N1 and the sixth node N6 via the capacitive element CD. The third transistor T3, the eighth transistor T8, and the fifth transistor T5 are in the on state, the first transistor T1 remains in the off state, the second node N2 and the fourth node N4 are conducted, and the voltage Vnr (driving voltage VDDEL, 6 V) is supplied to the second node N2 (the gate electrode 622 of the second transistor T2) and the fourth node N4 (the second electrode 626 of the second transistor T2). Further, the fourth transistor T4 is turned from the off state to the on state, and the voltage Vnp (initialization voltage VINI, 3 V) is supplied to the third node N3 (the first electrode 624 of the second transistor T2). The potential difference Vgs is 3 V (6 V−3 V) and the second transistor T2 is in the on state.

As described above, in the period PIN, the second node N2 and the fourth node N4 are initialized by the driving voltage VDDEL, the first node N1 is initialized by the reference voltage VREF, and the third node N3 is initialized by the initialization voltage VINI.

In the period PVH following the period PIN, the image data signal SL(m) (data signal VDATA) is supplied with the voltage of the data signal VDATA supplied pixels to other than the selected pixel 180 (pixel circuit 181). The second scan signal SC2(n) changes from a state where HI is supplied to a state where LO is supplied. The rest of the scan signals are in the same condition as the period PIN. The fifth transistor T5 is turned from the on state to the off state, and the rest of the transistors are in the same state as the period PIN.

Consequently, in the period PVH, the first node N1 maintains the voltage Vnq and the third node N3 maintains the voltage Vnp. The second transistor T2 is in the on state, the current Ion flows, the first node N1 maintains the voltage Vnq, the third node N3 maintains the voltage Vnp, and the sixth node N6 maintains 0 V. In addition, due to the off state of the fifth transistor T5, voltages supplied to the second node N2 and the fourth node N4 are released, and gradually decrease (discharge) from the voltage Vnr. When the potential difference Vgs between the voltage supplied to the second node N2 and the voltage supplied to the fourth node N4 and the voltage supplied to the third node N3 becomes the threshold voltage VTH, the second transistor T2 is turned off. In this case, the voltage supplied to the second node N2 and the fourth node N4 is the voltage Vnl (for example, 4 V).

As described above, in the period PVH, by the operation in which the potential difference Vgs of the second transistor T2 becomes the same as the threshold voltage VTH, the threshold voltage VTH of the second transistor T2 is acquired, and a charge corresponding to the threshold voltage VTH is held in the capacitive element CV.

In the period PWR executed in parallel with the period PVH, the image data signal SL(m) (the data signal VDATA) is supplied with the voltage VSIGH (4 V). The fourth scan signal SC4(n+3) changes from a state where LO is supplied to a state where HI is supplied. The first scan signal SC1(n) is supplied with HI, and the second scan signal SC2(n) and the fifth scan signal SC5(n) are supplied with LO. The first transistor T1 is turned from the off state to the on state. The rest of the transistors are similar to the period PVH. The voltage supplied to the first node N1 maintains the voltage Vnq (reference voltage VREF, 2 V), the voltage supplied to the second node N2 maintains the voltage Vnl (for example, 4 V), the voltage supplied to the third node N3 maintains the voltage Vnp, and the voltage supplied to the sixth node N6 gradually rises from 0 V to the voltage Vnl (voltage VSIGH, for example, 4 V). In this case, the capacitive element CD maintains the potential difference (−2 V with respect to the sixth node N6) by holding the charge corresponding to the potential difference between the voltage Vnq (reference voltage VREF, 2 V) supplied to the first node N1 and the voltage Vnl (voltage VSIGH, for example, 4 V) supplied to the sixth node N6. The potential difference Vgs is 1 V and is the same as the threshold voltage VTH.

As described above, in the period PWR, the data signal VDATA is written to the pixel 180A (pixel circuit 181A). The capacitive element CD maintains (holds) the voltage included in the data signal VDATA.

In the period PVH after the period PWR, the image data signal SL(m) (data signal VDATA) is supplied with the voltage of the data signal VDATA supplied to pixels other than the selected pixel 180 (pixel circuit 181). The fourth scan signal SC4(n+3) changes from a state where HI is supplied to a state where LO is supplied. The first scan signal SC1(n) is supplied with HI, and the second scan signal SC2(n) and the fifth scan signal SC5(n) are supplied with LO. The first transistor T1 is turned from the on state to the off state. The rest of the transistors are similar to the period PWR. The voltage supplied to the first node N1 maintains the voltage Vnq (reference voltage VREF, 2 V), the voltages supplied to the second node N2 and the voltage supplied to the sixth node N6 maintain the voltage Vnl (for example, 4 V), and the voltage supplied to the third node N3 maintains the voltage Vnp. In this case, the capacitive element CD maintains the potential difference (−2 V with respect to the sixth node N6) by holding a charge corresponding to the potential difference between Vnq (reference voltage VREF, 2 V) supplied to the first node N1 and the voltage Vnl (voltage VSIGH, for example, 4 V) supplied to the sixth node N6. The potential difference Vgs is 1 V and is the same as the threshold voltage VTH.

As described above, in the period PVH, by the operation in which the potential difference Vgs of the second transistor T2 becomes the same as the threshold voltage VTH, the threshold voltage VTH of the second transistor T2 is acquired, and a charge corresponding to the threshold voltage VTH is held in the capacitive element CV.

During a period between the period PVH and the emission period PEM, the first scan signal SC1(n) changes from a state where HI is supplied to a state where LO is supplied. In the case where the first scan signal SC1(n) is supplied with LO, the fifth scan signal SC5(n) changes from a state where LO is supplied to a state where HI is supplied. In the case where LO is supplied to the fifth scan signal SC5(n), the second scan signal SC2(n) changes from a state where LO is supplied to a state where HI is supplied. The third transistor T3, the fourth transistor T4, the sixth transistor T6, and the eighth transistor T8 are turned from the on state to the off state, and the fifth transistor T5, the seventh transistor T7, and the ninth transistor T9 are turned from the off state to the on state. The other scan signals and the other transistors are the same as the period PVH. The voltage supplied to the third node N3 drops from the voltage Vnp to the voltage Vnd (−2 V), whereby the voltage supplied to the second node N2 and the voltage supplied to the sixth node N6 drop from the voltage Vnl to the voltage Vnd (−2 V) by capacitive coupling of the capacitive element CD and the capacitive element CV. That is, the potential difference Vgs is 0 V, and the second transistor T2 is in the off state. In this case, the voltage supplied to the first node N1 capacitively coupled by the capacitive element CV and the capacitive element CD drops from the voltage Vnq to the voltage Vnt (−4 V).

In the light emission period PEM, the image data signal SL(m) (data signal VDATA) is supplied with the voltage of the data signal VDATA supplied to pixels other than the selected pixel 180A (pixel circuit 181A). The scan signal and other transistors are in the same state as in a period between the period PVH and the light emission period PEM. Since the potential difference Vgs is 0 V and the second transistor T2 is in the off state, the current Ion does not flow. Therefore, the light-emitting element OLED does not emit light. Consequently, the pixel 180A (pixel circuit 181A) emitting red light becomes black. Similar to the pixel 180A that emits red light, the pixel 180A that emits blue light and the pixel 180A that emits green light do not emit light, and therefore, three pixels using the pixel 180A that emit red light, the pixel 180A that emits blue light, and the pixel 180A that emits green light become black.

The display device 20 has the same operational effects as those of the display device 10. In addition, each node can be controlled independently. In addition, the method for driving the display device 20 includes executing the period PWR in parallel with the period PIN, and includes executing the period PWR in parallel with the period PVH. That is, the method for driving the display device 20 can write the data voltage to the pixel circuit at an arbitrary timing. Consequently, the method for driving the display device 20 can make the light emission period PEM longer than a driving method that does not provide a dedicated period for executing the period PWR. Therefore, the display device 20 can maintain the light emission period for a long time, and can suppress the luminance within the unit period, so that the reliability is high.

### [2-3-2. Second Example of Method for Driving Display Device 20]

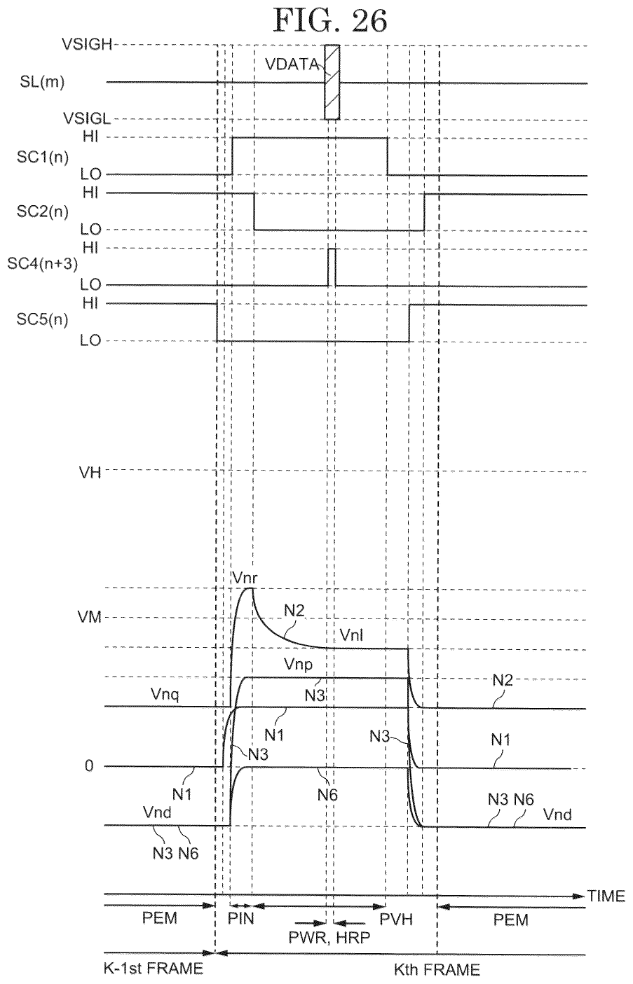

A second example of the method for driving the display device 20 will be described with reference to FIG. 26. The driving method shown in the second example of the display device 20 includes displaying an image of the same color (white color) in consecutive frames as in the second example of the method for driving the display device 10 according to the first embodiment.

The voltages (potentials) and the like of the respective nodes in the period up to the period PWR to be executed in parallel with the light emission period PEM of the K−1thFRAME to the period PVH of the Kth FRAME are the same as the configurations described in section of “2-3-1. First Example of Method for Driving Display Device 20”. Further, the configuration of each scan signal and the operation of each transistor in each period are the same as the configuration described in section of “2-3-1. First Example of Method for Driving Display Device 20”. Therefore, configurations and the like similar to those described in section of “2-3-1. First Example of Method for Driving Display Device 20” will be described as necessary. In addition, the image data signal SL(m) is supplied with the data signal VDATA including the VSIGL (0 V) corresponding to white in the period PWR of the Kth FRAME, and is supplied with the data signal VDATA similar to the configuration described in section of “2-3-1. First Example of Method for Driving Display Device 20” in a period other than the period PWR of the Kth FRAME.

In the emission period PEM of the K−1st FRAME, as in the configuration described in section of “2-3-1. First Example of Method for Driving Display Device 20”, the pixel 180A (pixel circuit 181A) emits red light and emits white light in three pixels using the pixel 180A that emits red light, the pixel 180A that emits blue light, and the pixel 180A that emits green light.

In the period PIN of the Kth FRAME, similar to the configuration described in section of “2-3-1. First Example of Method for Driving Display Device 20”, the second node N2 and the fourth node N4 are initialized by the driving voltage VDDEL, the first node N1 is initialized by the reference voltage VREF, and the third node N3 is initialized by the initialization voltage VINI.

In the period PVH of the Kth FRAME, similar to the configuration described in section of “2-3-1. First Example of Method for Driving Display Device 20”, by the operation in which the potential difference Vgs of the second transistor T2 becomes the same as the threshold voltage VTH, the threshold voltage VTH of the second transistor T2 is acquired, and a charge corresponding to the threshold voltage VTH is held in the capacitive element CV.

In the period PWR of the Kth FRAME executed in parallel with the period PVH of the Kth FRAME, the image data signal SL(m) (data signal VDATA) is supplied with a voltage VSIGL (0 V). The voltage supplied to the first node N1 maintains the voltage Vnq (reference voltage VREF, 2V), the voltage supplied to the second node N2 maintains the voltage Vnl (for example, 4 V), the voltage supplied to the third node N3 maintains the voltage Vnp, and the voltage VSIGL (0 V) is supplied to the sixth node N6, so that the capacitive element CD maintains a charge corresponding to a potential difference between the voltage Vnq (reference voltage VREF, 2 V) supplied to the first node N1 and 0 V that is supplied to the sixth node N6, thereby maintaining the potential difference (2 V). The potential difference Vgs is 1 V and is the same as the threshold voltage VTH.

As described above, in the period PWR of the Kth FRAME, the data signal VDATA is written to the pixel 180A (pixel circuit 181A). Further, the capacitive element CD maintains (holds) the voltage included in the data signal VDATA.

In the period PVH of the Kth FRAME after the period PWR of the Kth FRAME, similar to the period PWR of the Kth FRAME, the voltage supplied to the first node N1 maintains the voltage Vnq (reference voltage VREF, 2 V), the voltage supplied to the second node N2 maintains the voltage Vnl (for example, 4 V), the voltage supplied to the third node N3 maintains the voltage Vnp, the voltage supplied to the sixth node N6 maintains 0 V, and the capacitive element CD holds a charge equivalent to the potential difference between Vnq supplied to the first node N1 and 0 V supplied to the sixth node N6, thereby maintaining the potential difference (2 V with the sixth node N6 as the reference). The potential difference Vgs is 1 V and is the same as the threshold voltage VTH.

As described above, in the period PVH of the Kth FRAME, by the operation in which the potential difference Vgs of the second transistor T2 becomes the same as the threshold voltage VTH, the threshold voltage VTH of the second transistor T2 is acquired, and a charge corresponding to the threshold voltage VTH is held in the capacitive element CV.

In a period between the period PVH of the Kth FRAME and the emission period PEM of the Kth FRAME, by dropping the voltage supplied to the third node N3 from the voltage Vnp (3 V) to the voltage Vnd (−2 V), the voltage supplied to the second node N2 drops from the voltage Vnl (for example, 4 V) to the voltage Vnq (2 V) by capacitive coupling of the capacitive element CD and the capacitive element CV. That is, the potential difference Vgs is 4 V and the second transistor T2 is in the on state. In this case, the voltage supplied to the first node N1 capacitively coupled by the capacitive element CV and the capacitive element CD drops from the voltage Vnq (2 V) to 0 V.

In the light emission period PEM, the potential difference Vgs is 4 V and the second transistor T2 is in the on state, so that the current Ion flows. Therefore, the light-emitting element OLED emits light. For example, the pixel 180A that emits red light, the pixel 180A that emits blue light, and the pixel 180A that emits green light each emit light, and three pixels using the pixel 180A that emits red light, the pixel 180A that emits blue light, and the pixel 180A that emits green light become white.

The second example of the method for driving the display device 20 has the same effects as those described in section of “2-3-1. First Example of Method for Driving Display Device 20”.

### [2-3-3. Third Example of Method for Driving Display Device 20]

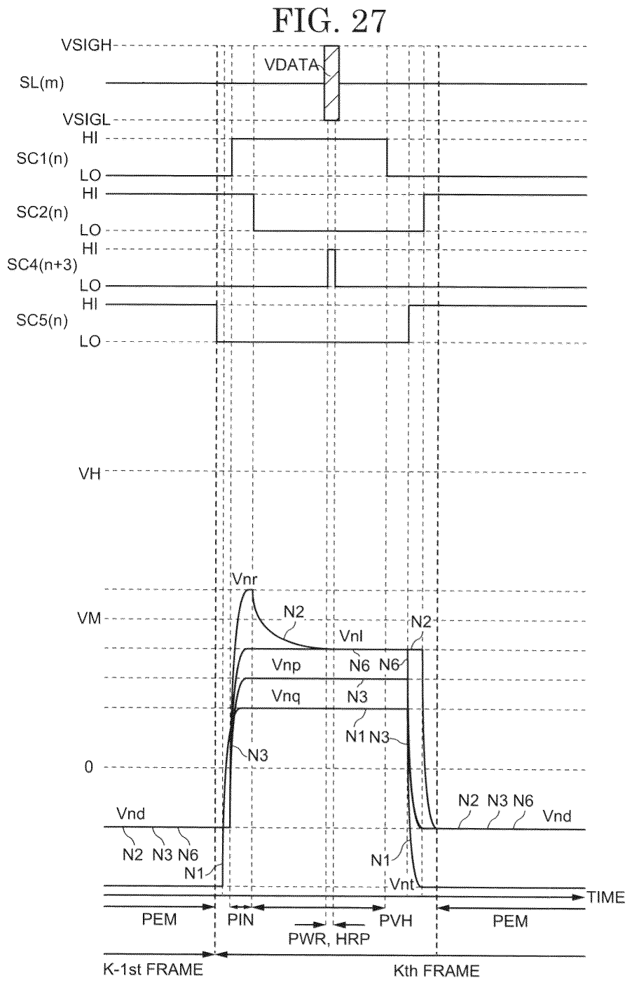

A third example of a method for driving the display device 20 will be described with reference to FIG. 27. A driving method shown in a third example of a method for driving the pixel circuit 181A includes displaying images of the same color (black) in consecutive frames, similar to the third example of the driving method of the display device 10 according to the first embodiment.

The voltages (potentials) and the like of the respective nodes in the period PWR executed in parallel with the period PVH of the Kth FRAME to the emission period PEM of the period PWR of the Kth FRAME are the same as those described in section of “2-3-2. Second Example of Method for Driving Display Device 20”. The configuration of each scan signal and the operation of each transistor in each period are the same as the configuration described in section of “2-3-1. First Example of Method for Driving Display Device 20”. Therefore, configurations and the like similar to those described in sections of “2-3-1. First Example of Method for Driving Display Device 20” and “2-3-2. Second Example of Method for Driving Display Device 20” will be described as necessary.

In the emission period PEM of the K−1st FRAME, for example, the voltage supplied to the first node N1 is the voltage Vnt (−4 V). The voltage supplied to the second node N2, the voltage supplied to the third node N3, and the voltage supplied to the sixth node N6 are the voltage Vnd (−2 V), and the potential difference Vgs is 0 V. Therefore, the second transistor T2 is in the off state, the current Ion does not flow, and the light-emitting element OLED does not emit light.

Consequently, the pixel 180A (pixel circuit 181A) emitting red light becomes black. Similar to the pixel 180A that emits red light, the pixel 180A that emits blue light and the pixel 180A that emits green light do not emit light, and therefore, three pixels using the pixel 180A that emits red light, the pixel 180A that emits blue light, and the pixel 180A that emits green light become black.

Following the emission period PEM of the K−1st FRAME, the period between the emission period PEM of the K−1st FRAME and the period PIN of the Kth FRAME, or in the Kth FRAME period PIN, the voltage supplied to the first node N1 rises from the voltage Vnt (−4 V toward the voltage Vnq (reference voltage VREF, 2 V) and becomes the voltage Vnq. The second node N2 is electrically connected to the fourth node N4, and the voltage Vnr (driving voltage VDDEL, 6 V) is supplied to the second node N2 (the gate electrode 622 of the second transistor T2) and the fourth node N4 (the second electrode 626 of the second transistor T2). The voltage Vnp (initialization voltage VINI, 3 V) is supplied to the third node N3 (first electrode 624 of the second transistor T2). The sixth node N6 (second electrode 616 of the first transistor T1) is floating, due to the capacitive coupling between the first node N1 and the sixth node N6 via the capacitive element CD, the voltage supplied to the sixth node N6 becomes the voltage Vnl (for example, 4 V) from the voltage Vnd (−2 V) so as to maintain the increase in the voltage (2 V−(−4 V)) supplied to the first node N1. The potential difference Vgs is 3 V (6 V−3 V) and the second transistor T2 is in the on state.

As described above, in the period PIN of the Kth FRAME, the second node N2 and the fourth node N4 are initialized by the driving voltage VDDEL, the first node N1 is initialized by the reference voltage VREF, and the third node N3 is initialized by the initialization voltage VINI.

In the period PVH of the Kth FRAME following the period PIN of the Kth FRAME, the first node N1 maintains the voltage Vnq, the third node N3 maintains the voltage Vnp, and the sixth node N6 maintains the voltage Vnl. The second transistor T2 is in the on state, the current Ion flows, and the off state of the fifth transistor T5 releases the voltage supplied to the second node N2 and the fourth node N4, and gradually decreases (discharges) from the voltage Vnr. When the potential difference Vgs between the voltage supplied to the second node N2 and the voltage supplied to the fourth node N4 and the voltage supplied to the third node N3 becomes the threshold voltage VTH, the second transistor T2 is turned to the off state. In this case, the voltage supplied to the second node N2 and the fourth node N4 is the voltage Vnl (for example, 4 V).

As described above, in the period PVH of the Kth FRAME, by the operation in which the potential difference Vgs of the second transistor T2 becomes the same as the threshold voltage VTH, the threshold voltage VTH of the second transistor T2 is acquired, and a charge corresponding to the threshold voltage VTH is held in the capacitive element CV.

In the period PWR of the Kth FRAME executed in parallel with the period PVH of the Kth FRAME, the image data signal SL(m) (data signal VDATA) is supplied with the voltage VSIGH (4 V). The voltage supplied to the first node N1 maintains the voltage Vnq, the voltage supplied to the second node N2 maintains the voltage Vnl (for example, 4 V), the voltage supplied to the third node N3 maintains the voltage Vnp, and the voltage VSIGH (4 V) is supplied to the sixth node N6. In this case, the capacitive element CD maintains the potential difference (−2 V with respect to the sixth node N6) by holding the charge corresponding to the potential difference between Vnq (reference voltage VREF, 2 V) supplied to the first node N1 and the voltage Vnl (voltage VSIGH, for example, 4 V) supplied to the sixth node N6. The potential difference Vgs is 1 V and is the same as the threshold voltage VTH.

As described above, in the period PWR, the data signal VDATA is written to the pixel 180A (pixel circuit 181A). Further, the capacitive element CD maintains (holds) the voltage included in the data signal VDATA.

In the period PVH of the Kth FRAME after the period PWR of the Kth FRAME, as in “2-3-1. First Example of Method for Driving Display Device 20”, by the operation in which the potential difference Vgs of the second transistor T2 becomes the same as the threshold voltage VTH, the threshold voltage VTH of the second transistor T2 is acquired, and a charge corresponding to the threshold voltage VTH is held in the capacitive element CV.

In the period between the period PVH of the Kth FRAME and the emission period PEM of the Kth FRAME, similar to “2-3-1. First Example of Method for Driving Display Device 20”, the voltage supplied to the third node N3 drops from the voltage Vnp to the voltage Vnd (−2 V), so that the voltage supplied to the second node N2 and the voltage supplied to the sixth node N6 drop from the voltage Vnl to the voltage Vnd (−2 V) by capacitive coupling of the capacitive element CD and the capacitive element CV. The potential difference Vgs is 0 V, the second transistor T2 is in the off state, and the voltage supplied to the first node N1 capacitively coupled by the capacitive element CV and the capacitive element CD drops from the voltage Vnq to the voltage Vnt (−4 V).

In the light emission period PEM of the Kth FRAME, the potential difference Vgs is 0 V and the second transistor T2 is in the off state, so that the current Ion does not flow, similar to “2-3-1. First Example of Method for Driving Display Device 20”. Therefore, the light-emitting element OLED does not emit light. Consequently, the pixel 180A (pixel circuit 181A) emitting red light becomes black. Similar to the pixel 180A that emits red light, the pixel 180A that emits blue light and the pixel 180A that emits green light do not emit light, and therefore, three pixels using the pixel 180A that emit red light, the pixel 180A that emits blue light, and the pixel 180A that emits green light become black.

The third example of the method for driving the display device 20 has the same effects as those described in section of “2-3-1. First Example of Method for Driving Display Device 20”.

### [2-3-4. Fourth Example of Method for Driving Display Device 20]

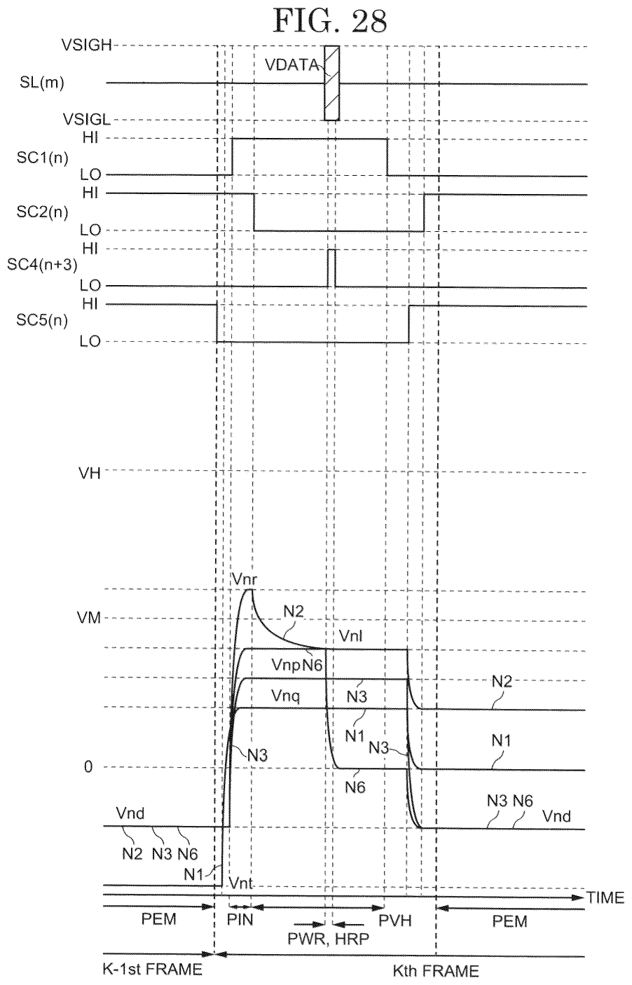

A fourth example of the method for driving the display device 20 will be described with reference to FIG. 28. The driving method shown in the fourth example of the method for driving the pixel circuit 181A includes displaying images of differing colors in successive frames as in the fourth example of the method for driving the display device 10 according to the first embodiment.

The voltage (potential) of each node in a period prior to the light emission period PEM of the K−1st FRAME to the period PWR executed in parallel with the period PVH of the Kth FRAME, the configuration of each scan signal, the operation of each transistor, and the like are the same as those described in section of “2-3-3. Third Example of Method for Driving Display Device 20”. Further, the configuration of each scan signal, the operation of each transistor, and the like are the same as those described in section of “2-3-1. First Example of Method for Driving Display Device 20”. Therefore, configurations and the like similar to those described in sections of “2-3-1. First Example of Method for Driving Display Device 20” and “2-3-3. Third Example of Method for Driving Display Device 20” will be described as necessary.

In the emission period PEM of the K−1st FRAME, similar to “2-3-3. Third Example of Method for Driving Display Device 20”, the voltage supplied to the first node N1 is the voltage Vnt (−4 V), the voltage supplied to the second node N2, the voltage supplied to the third node N3, and the voltage supplied to the sixth node N6 are the voltage Vnd (−2 V), and the potential difference Vgs is 0 V. Therefore, the second transistor T2 is in the off state, the current Ion does not flow, and the light-emitting element OLED does not emit light.

In a period between the light emission period PEM of the K−1st FRAME and the period PIN of the Kth FRAME following the light emission period PEM of the K−1st FRAME, or in the period PIN of the Kth FRAME, similar to the “2-3-3. Third Example of Method for Driving Display Device 20”, the voltage supplied to the first node N1 becomes the voltage Vnq, and the voltage Vnr (the driving voltage VDDEL, 6 V) is supplied to the second node N2 (the gate electrode 622 of the second transistor T2) and the fourth node N4 (the second electrode 626 of the second transistor T2), the voltage Vnp (the initialization voltage VINI, 3 V) is supplied to the third node N3 (the first electrode 624 of the second transistor T2), the sixth node N6 (the second electrode 616 in the first transistor T1) is in a floating state, and due to the capacitive coupling between the first node N1 and the sixth node N6 via the capacitive element CD, the voltage supplied to the sixth node N6 becomes the voltage Vnl (for example, 4 V) from the voltage Vnd (−2 V) so as to maintain the increase in the voltage supplied to the first node N1 (2 V−(−4 V)). Further, the potential difference Vgs is 3 V (6 V−3 V) and the second transistor T2 is in the on state.

As described above, in the period PIN of the Kth FRAME, the second node N2 and the fourth node N4 are initialized by the driving voltage VDDEL, the first node N1 is initialized by the reference voltage VREF, and the third node N3 is initialized by the initialization voltage VINI.

In the period PVH of the Kth FRAME following the period PIN of the Kth FRAME, the first node N1 maintains the voltage Vnq, the third node N3 maintains the voltage Vnp, the sixth node N6 maintains the voltage Vnl, and the voltage supplied to the second node N2 and the fourth node N4 becomes the voltage Vnl (for example, 4 V), similar to “2-3-3. Third Example of Method for Driving Display Device 20”.

As described above, in the period PVH of the Kth FRAME, by the operation in which the potential difference Vgs of the second transistor T2 becomes the same as the threshold voltage VTH, the threshold voltage VTH of the second transistor T2 is acquired, and a charge corresponding to the threshold voltage VTH is held in the capacitive element CV.

In the period PWR in the Kth FRAME executed in parallel with the period PVH of the Kth FRAME, the image data signal SL(m) (data signal VDATA) is supplied with the voltage VSIGL (0 V). The voltage supplied to the first node N1 maintains the voltage Vnq, the voltage supplied to the second node N2 maintains the voltage Vnl (for example, 4 V), the voltage supplied to the third node N3 maintains the voltage Vnp, and the voltage supplied to the sixth node N6 drops from the voltage Vnl to 0 V (voltage VSIGL) and becomes 0 V. In this case, the capacitive element CD holds charges corresponding to the potential difference between Vnq (reference voltage VREF, 2 V) supplied to the first node N1 and 0 V supplied to the sixth node N6, thereby maintaining the potential difference (2 V with respect to the sixth node N6). The potential difference Vgs is 1 V and is the same as the threshold voltage VTH.

As described above, in the period PWR, the data signal VDATA is written to the pixel 180A (pixel circuit 181A). The capacitive element CD maintains (holds) the voltage included in the data signal VDATA.

In the period PVH of the Kth FRAME following the period PWR of the Kth FRAME, the voltage supplied to the first node N1 maintains a voltage Vnq (reference voltage VREF, 2 V), the voltage supplied to the second node N2 maintains the voltage Vnl (for example, 4 V), the voltage supplied to the third node N3 maintains the voltage Vnp, and the voltage supplied to the second node N2 maintains 0 V. In this case, the capacitive element CD holds charges corresponding to the potential difference between Vnq (reference voltage VREF, 2 V) supplied to the first node N1 and 0 V supplied to the sixth node N6, thereby maintaining the potential difference (2 V with respect to the sixth node N6). The potential difference Vgs is 1 V and is the same as the threshold voltage VTH.

As described above, in the period PVH of the Kth FRAME following the period PWR of the Kth FRAME, by the operation in which the potential difference Vgs of the second transistor becomes the same as the threshold voltage VTH, the threshold voltage VTH of the second transistor T2 is acquired, and a charge corresponding to the threshold voltage VTH is held in the capacitive element T2.

In the period between the period PVH of the Kth FRAME and the emission period PEM of the Kth FRAME, by lowering the voltage supplied to the third node N3 from the voltage Vnp (3 V) to the voltage Vnd (−2 V), the voltage supplied to the second node N2 drops from the voltage Vnl to the voltage Vnq (2 V) by capacitive coupling of the capacitive element CD and the capacitive element CV. That is, the potential difference Vgs is 4 V and the second transistor T2 is in the on state. In this case, the voltage supplied to the first node N1 capacitively coupled by the capacitive element CV and the capacitive element CD drops from the voltage Vnq (2 V) to 0 V. The sixth node N6 (the second electrode 616 of the first transistor T1) is connected to the third node N3 by the ninth transistor T9 being in the on state, and the voltage supplied to the sixth node N6 is changed from 0 V to the voltage Vnd (−2 V).

In the emission period PEM of the Kth FRAME, the potential difference Vgs is 4 V and the second transistor T2 is in the on state, so that the current Ion flows. Therefore, the pixel 180A (pixel circuit 181A) emitting red light emits light. Similar to the pixel 180A that emits red light, the pixel 180A that emits blue light and the pixel 180A that emits green light also emit light, and three pixels using the pixel 180A that emits red light, the pixel 180A that emits blue light, and the pixel 180A that emits green light emit white light.

The fourth example of the method for driving the display device 20 has the same effects as those described in section of “2-3-1. First Example of the method for driving the display device 20”.

### 3. Third Embodiment

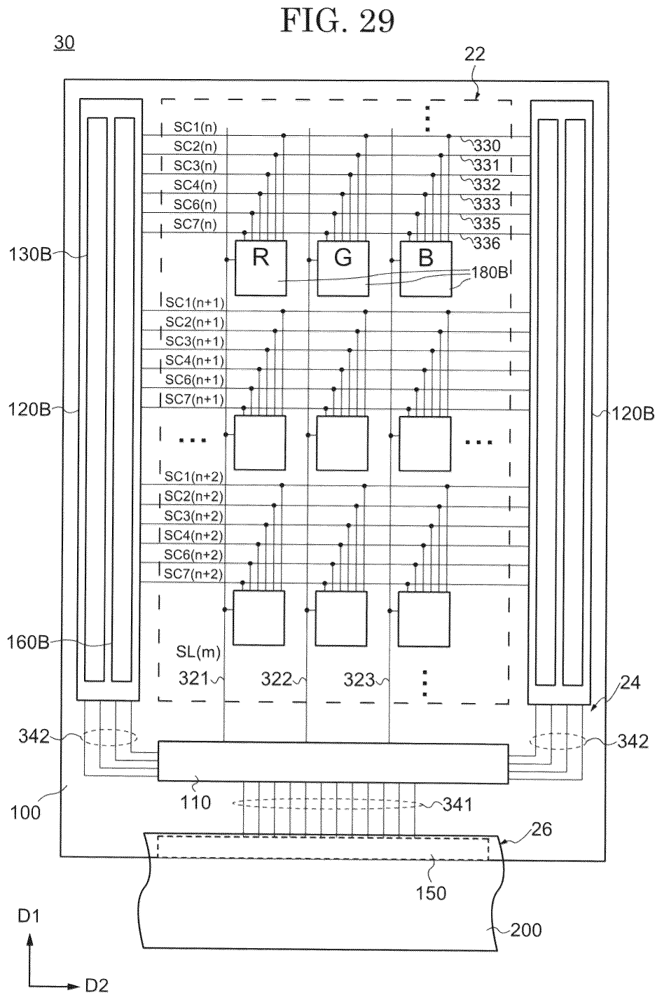

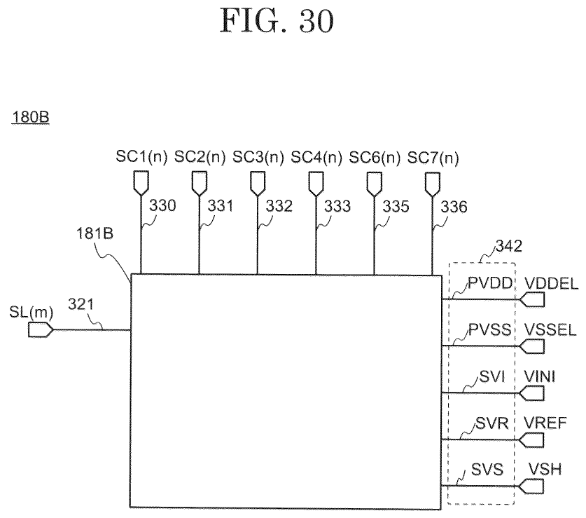

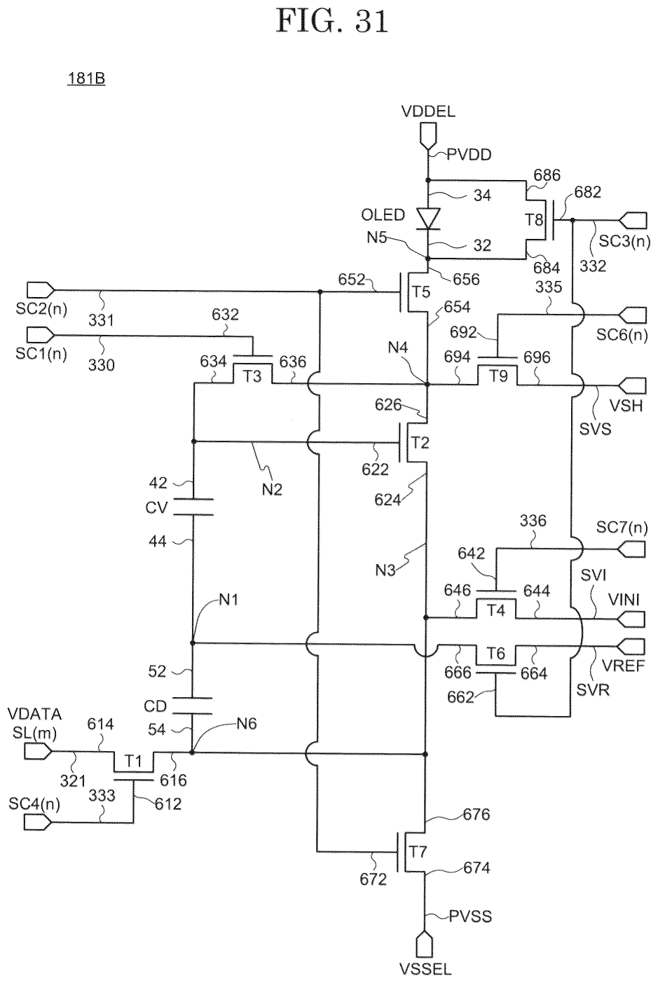

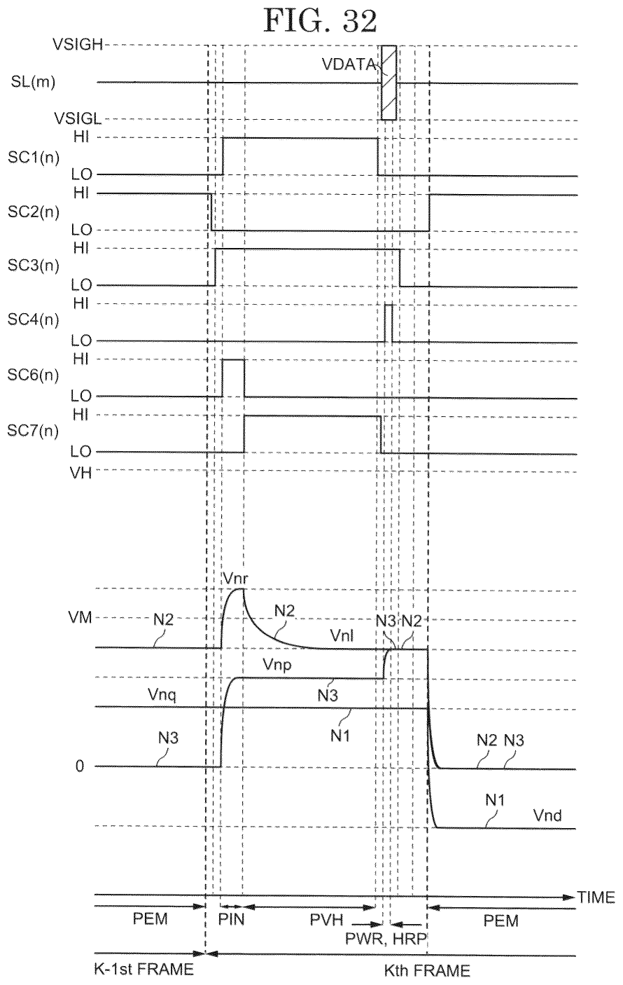

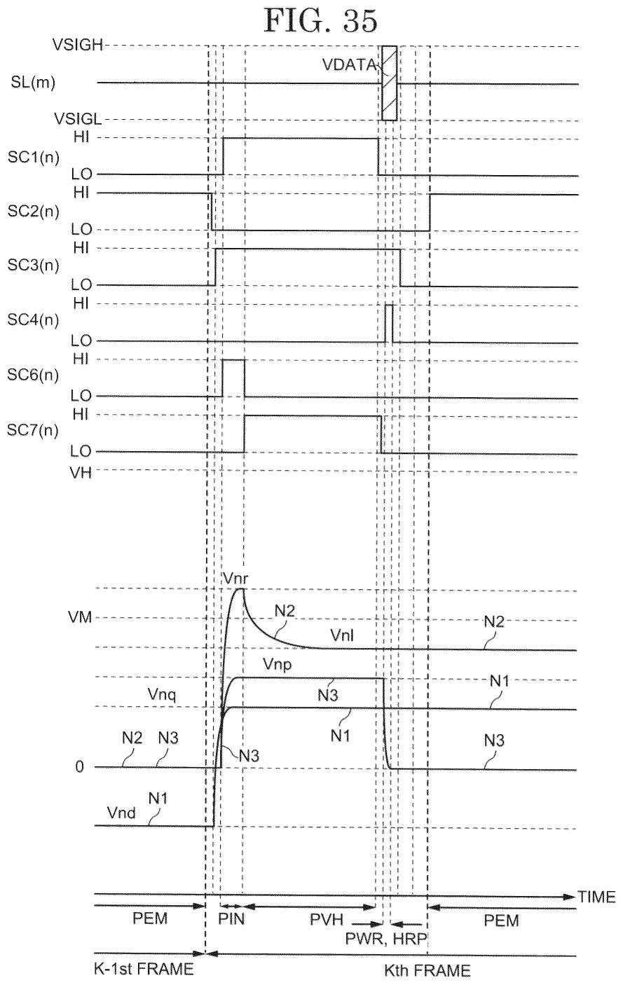

With reference to FIG. 4, FIG. 29, and FIG. 35, an overview of a display device 30 according to a third embodiment will be described. FIG. 29 is a schematic diagram showing a configuration of the display device 30. FIG. 30 is a schematic diagram showing an input signal to a pixel 180B (a pixel circuit 181B) according to the third embodiment, FIG. 31 is a circuit diagram showing a configuration of the pixel circuit 181B, and FIG. 32 to FIG. 35 are timing charts of the display device 30.

The display device 30 includes a control circuit 120B, a pixel 180B, and a pixel circuit 181B. The configuration of the control circuit 120B, the pixel 180B, and the pixel circuit 181B differs from the configuration of the control circuit 120, the pixel 180, and the pixel circuit 181 of the display device 10 according to the first embodiment. Specifically, the display device includes the following configurations (7) to (15). Mainly, the configurations shown in (7) to (15) are different from the configuration of the display device 10 according to the first embodiment.
(7) A configuration and function in which the control circuit 120 of the display device 10 according to the first embodiment are replaced with the control circuit 120B, and a configuration and function related to the control circuit 120B differ from the configuration and the function related to the control circuit 120.
(8) A configuration having a configuration and function in which the pixel 180 (pixel circuit 181) of the display device 10 according to the first embodiment are replaced with the pixel 180B (pixel circuit 181B), and a configuration and a function related to the pixel 180B (pixel circuit 181B) differ from the configuration and the function related to the pixel 180 (pixel circuit 181).
(9) The electrical connection between the control circuit 120B and the pixel 180B (pixel circuit 181B) differs from the electrical connection between the control circuit 120 and the pixel 180 (pixel circuit 181).
(10) The second scan signal SC2(n) also serves as the scan signal SC5(n) according to the first embodiment. That is, the display device 30 does not include the scan signal SC5(n) and the scan signal line 334 to which the scan signal SC5(n) is supplied. The timing of falling and rising of the second scan signal SC2(n) differs from the timing of falling and rising of the second scan signal SC2(n) according to the first embodiment.
(11) A scan signal line 335 and the sixth scan signal SC6(n) supplied to the scan signal line 335 are added.
(12) A scan signal line 336 and the seventh scan signal SC7(n) supplied to the scan signal line 336 are added.
(13) A constant voltage VSH and a constant voltage power supply line SVS to which the constant voltage VSH is supplied are added.
(14) The pixel 180A (pixel circuit 181A) includes the ninth transistor T9. The ninth transistor T9 is electrically connected between the fourth node N4 and the constant voltage power supply line SVS, and the gate electrode 692 of the ninth transistor T9 is electrically connected to the scan signal line 335.
(15) The gate electrode 642 of the fourth transistor T4 is electrically connected to the scan signal line 336 instead of the scan signal line 330.

Configurations other than those shown in (7) to (15) in the display device 30 and configurations other than those related to the configurations shown in (7) to (15) in the display device 30 are the same as those of the display device 10 according to the first embodiment. In describing the configuration and function of the display device 30, the same configuration and function as those of the display device 10 will be described as necessary.

### [3-1. Configuration of Control Circuit 120B]

Referring to FIG. 29, an overview of the control circuit 120B will be described. Similar to the two control circuits 120, two control circuits 120B are provided along the second direction D2 at positions adjoining both sides of the display region 22. The scan signal line 330, the scan signal line 331, the scan signal line 332, the scan signal line 333, the scan signal line 335, and the scan signal line 336 extend from the control circuit 120B in the second direction D2 and are connected to the plurality of pixels 180B arranged in the second direction D2. As an example, respective scan lines of the display device 30 shown in FIG. 29 are connected to both of the two control circuits 120B. The respective scan lines may be connected to one control circuit 120B of the two control circuits 120B. That is, the n-th scan signal line may be electrically connected to the control circuit 120B on the right side of the display region 22 along the second direction D2, and the n+1-th scan signal line may be electrically connected to the control circuit 120B on the left side of the display region 22 along the second direction D2. The number n is a positive integer.

The control circuit 120B includes a shift register circuit 130B and a scan driver circuit 160B. The scan driver circuit 160B comprises a plurality of scan drivers. For example, the plurality of scan drivers is supplied with a plurality of output signals from the shift register circuit 130B, a plurality of enable signals described in the first embodiment are supplied from the IC chip 110 via the plurality of connection wirings 342, the driving voltage VDDEL is supplied via the drive power line PVDD, and the standard voltage VSSEL is supplied via the standard voltage line PVSS. The plurality of scan drivers sequentially supply scan signals having different timings (for example, the first scan signal SC1(n), the second scan signal SC2(n), the third scan signal SC3(n), the fourth scan signal SC4(n), the sixth scan signal SC6(n), and the seventh scan signal SC7(n)) to the respective scan signal lines based on the plurality of output signals and the plurality of enable signals, and drive the pixel 180B (pixel circuit 181B) electrically connected to the respective scan signal lines. For example, the fourth scan signal SC4(n) and the scan signal line 333 to which the fourth scan signal SC4(n) is supplied are a so-called scan signal and scan signal line.

The configuration of the control circuit 120B other than that described in section of “3-1. Configuration of Control Circuit 120B” is the same as the configuration of the control circuit 120.

The constant voltage power supply line SVS may be referred to as a control voltage power supply line, and the constant voltage VSH may be referred to as a control voltage.

### [3-2. Configuration of Pixel 180B]

Referring to FIG. 29 to FIG. 31, an overview of the pixel 180B and the pixel circuit 181B will be described.

The pixel circuit 181B is connected to the scan signal lines 335 and 336 and the constant voltage power supply line SVS.

The constant voltage VSH is supplied to the constant voltage power supply line SVS. For example, the constant voltage power supply line SVS is electrically connected to the connection wiring 342 that differs from the initialization voltage power supply line SVI, the reference voltage power supply line SVR, the drive power supply line PVDD, and the standard voltage line PVSS among the connection wirings 342. The constant voltage power supply line SVS may be one of the connection wirings 342. For example, the constant voltage VSH may be supplied from an external device to the IC chip 110, and may be supplied from the IC chip 110 to a plurality of pixels 180B (pixel circuits 181B) via the connection wiring 342 and the constant voltage power supply line SVS. Although not shown, the constant voltage VSH may be connected from an external device to the constant voltage power supply line SVS via the FPC 200, the terminal portion 150, and the connection wiring 341 without passing through the IC chip 110 and the connection wiring 342, and may be supplied to the plurality of pixels 180B (pixel circuits 181B).

The gate electrode 642 of the fourth transistor T4 is electrically connected to the scan signal line 336. As described above, the seventh scan signal SC7(n) is supplied to the scan signal line 336. The fourth transistor T4 is switched using the seventh scan signal SC7(n). In other words, in the fourth transistor T4, the conduction state (on state) and the non-conduction state (off state) are controlled by the seventh scan signal SC7(n). In the case where the signal supplied to the seventh scan signal SC7(n) is LO, the fourth transistor T4 becomes non-conductive, and in the case where the signal supplied to the seventh scan signal SC7(n) is HI, the fourth transistor T4 becomes conductive. The seventh scan signal SC7(n) may be referred to as a seventh control signal.

The gate electrode 672 of the seventh transistor T7 is electrically connected to the scan signal line 331 to which the second scan signal SC2(n) is supplied. The seventh transistor T7 is switched using the second scan signal SC2(n). In other words, in the seventh transistor T7, the conduction state (on state) and the non-conduction state (off state) are controlled by the second scan signal SC2(n). In the case where the signal supplied to the second scan signal SC2(n) is LO, the seventh transistor T7 becomes non-conductive, and in the case where the signal supplied to the second scan signal SC2(n) is HI, the seventh transistor T7 becomes conductive.

The ninth transistor T9 has a function of conducting the fourth node N4 and the constant voltage power supply line SVS to provide the constant voltage VSH to the fourth node N4. The ninth transistor T9 includes the gate electrode 692, the first electrode 694, and the second electrode 696. The gate electrode 692 is electrically connected to the scan signal line 335. The first electrode 694 is electrically connected to the fourth node N4, the first electrode 654 of the fifth transistor T5, the second electrode 636 of the third transistor T3 and the second electrode 626 of the second transistor T2. The second electrode 696 is electrically connected to the constant voltage power supply line SVS. As described above, the sixth scan signal SC6(n) is supplied to the scan signal line 335. The switching of the ninth transistor T9 is controlled using the sixth scan signal SC6(n). In other words, in the ninth transistor T9, the conduction state (on state) and the non-conduction state (off state) are controlled by the sixth scan signal SC6(n). In the case where the signal supplied to the sixth scan signal SC6(n) is LO, the ninth transistor T9 becomes non-conductive, and in the case where the signal supplied to the sixth scan signal SC6(n) is HI, the ninth transistor T9 becomes conductive. The sixth scan signal SC6(n) may be referred to as a third control signal.

The configurations and functions of the pixel circuit 181B other than the configuration and the function described in section of “3-2. Configuration of Pixel 180B” are the same as those of the pixel circuit 181.

### [3-3. Method of Driving Pixel Circuit 181B]

A method for driving the display device 30 will be described with reference to FIG. 32 to FIG. 35. Configurations that are the same as or similar to those in FIG. 1 to FIG. 31 will be described as necessary. The horizontal axis of the timing charts indicates time (TIME).

The method for driving the display device 30 includes a period similar to the method for driving the display device 10 according to the first embodiment shown in FIG. 4.

In one horizontal period (the horizontal period HRP) in the method for driving the display device 30, the pixel 180B (pixel circuit 181B) receives the image data signal SL(m) including the first scan signal SC1(n), the second scan signal SC2(n), the third scan signal SC3(n), the fourth scan signal SC4(n), the sixth scan signal SC6(n), the seventh scan signal SC7(n), and the data signal VDATA. For example, the pixel 180B (pixel circuit 181B) is selected according to timings of the first scan signal SC1(n), the second scan signal SC2(n), the third scan signal SC3(n), the fourth scan signal SC4(n), the sixth scan signal SC6(n), and the seventh scan signal SC7(n). The image data signal SL(m) is input to the selected pixel 180B (pixel circuit 181B) in accordance with the timings of the respective signals. A similar operation is performed on all the pixels 180B (pixel circuits 181B), and an image of the current frame corresponding to the 1FRAME is displayed in the display region 22 of the display device 10 on the basis of the image data signal SL(m) input to all the pixel 180B (pixel circuit 181B).

For example, the voltages (potentials) supplied to the respective signals and the respective nodes of respective frames in the timing charts shown in FIG. 32 to FIG. 35 are shown in Table 2.

TABLE 2

| | Setting Value [V] |
|---|---|
| VTH | 1 |
| VSIGL(black) | 4 |
| VSIGH(white) | 0 |
| HI | 10 |
| LO | −3 |
| VINI | 3 |
| VREF | 2 |
| VSH | 6 |
| VDDEL | 8 |
| VSSEL | 0 |

For example, as shown in Table 2, the voltage VH (HI) is 10 V, the voltage VL (LO) is −3 V, the constant voltage VSH is 6 V, the driving voltage VDDEL is 8 V, the standard voltage VSSEL is 5 V, and the voltage VN is −5 V. That is, the reference voltage VREF is different from the initialization voltage VINI, and the reference voltage VREF and the initialization voltage VINI are larger than the standard voltage VSSEL and smaller than the driving voltage VDDEL. The other voltage setting values are the same as the setting values shown in Table 1 described in section of “1-5. Method for Driving Display Device 10”.

### [3-3-1. First Example of Method for Driving Display Device 30]

Referring to FIG. 32 and Table 2, a first example of the method for driving the display device 30 will be described. The first example of the method for driving the display device 30 includes displaying images of different colors in consecutive frames as in the first example of the method for driving the display device 10 according to the first embodiment. Configurations that are the same as or similar to those in FIG. 1 to FIG. 31 will be described as necessary.

As in the first example of the method for driving the display device 10 according to the first embodiment, the image data signal SL(m) including the data signal VDATA is input to each pixel 180B (pixel circuit 181B) in accordance with each period. The data signal VDATA is analog data including a voltage equal to or higher than the voltage VSIGL and equal to or lower than the voltage VSIGH. For example, in the period PWR, a voltage supplied to the selected pixel 180B (pixel circuit 181B) is supplied to the image data signal SL(m). For example, in a period excluding the period PWR, the data signal VDATA is supplied with a voltage supplied to pixels other than the selected pixel 180B (pixel circuit 181B).

The emission period PEM of the K−1st FRAME is a period in which the pixel 180B (pixel circuit 181B) emits light corresponding to the potential difference Vgs of the second transistor T2 (the voltage supplied to the second node N2 (voltage V (N2))−the voltage supplied to the third node N3 (voltage V (N3)). For example, the pixel 180 (the pixel circuit 181) emits red light, and three pixels using the pixel 180 emitting red light, the pixel 180 emitting blue light, and the pixel 180 emitting green light emit white light.

For example, in the light emission period PEM of the K−1st FRAME, the image data signal SL(m) (data signal VDATA) is supplied with the voltage supplied to pixels other than the pixel 180B (pixel circuit 181B), the first scan signal SC1(n), the third scan signal SC3(n), the fourth scan signal SC4(n), the sixth scan signal SC6(n), and the seventh scan signal SC7(n) are supplied with LO, and the second scan signal SC2(n) is supplied with HI. The first transistor T1, the third transistor T3, the fourth transistor T4, the sixth transistor T6, the eighth transistor T8, and the ninth transistor T9 are in the off state, and the fifth transistor T5 and the seventh transistor T7 are in the on state. Further, for example, the voltage supplied to the third node N3 is 0 V, the voltage supplied to the second node N2 is the voltage Vnl (for example, 4 V), and the potential difference Vgs is 4 V. Therefore, the second transistor T2 is in the on state, and the current Ion based on the potential difference Vgs and the potential difference Vds according to the voltage VSIGH input in the horizontal period HRP of the K−1st FRAME can be passed from the drive power line PVDD to the light emitting element OLED and the reference voltage line PVSS. Consequently, the light-emitting element OLED emits light. In addition, the voltage supplied to the first node N1 becomes 2 V by capacitive coupling by the capacitive element CV and the capacitive element CD. For example, the pixel 180B (pixel circuit 181B) emits red light, and three pixels using the pixel 180B that emits red light, the pixel 180B that emits blue light, and the pixel 180B that emits green light emit white light.

In the period between the light emission period PEM of the K−1st FRAME and the period PIN of the Kth FRAME following the light emission period PEN of the K−1st FRAME, or in the period PIN of the Kth FRAME, the voltage of the data signal VDATA supplied to pixels other than the selected pixel 180 (pixel circuit 181) is supplied to the image data signal SL(m) (data signal VDATA). First, the second scan signal SC2(n) changes from a state where HI is supplied to a state where LO is supplied. In the case where LO is supplied to the second scan signal SC2(n), the third scan signal SC3(n) changes from a state where LO is supplied to a state where HI is supplied. In the case where the third scan signal SC3(n) is supplied with HI, the first scan signal SC1(n) and the sixth scan signal SC6(n) change from a state where LO is supplied to a state where HI is supplied. The fourth scan signal SC4(n) and the seventh scan signal SC7(n) are supplied with LO.

Consequently, in a period between the light emission period PEM of the K−1st FRAME and the period PIN of the Kth FRAME, or in the period PIN of the Kth FRAME, the fifth transistor T5 and the seventh transistor T7 are turned from the on state to the off state, and the current Ion do not flow from the drive power supply line PVDD to the light-emitting elements OLED and the standard voltage line PVSS. The eighth transistor T8 is turned from the off state to the on state, the potential difference between the first electrode 32 and the second electrode 34 of the light-emitting element OLED becomes 0 V, and the light emission of the light-emitting element OLED is stopped. In addition, the sixth transistor T6 is turned from the off state to the on state, and the voltage supplied to the first node N1 is supplied with the reference voltage VREF (2 V, the voltage Vnq) to maintain the voltage Vnq. The third transistor T3 and the ninth transistor T9 are turned from the off state to the on state, the fourth transistor T4 and the first transistor T1 are maintained in the off state, the second node N2 and the fourth node N4 are conducted, and the constant voltage VSH (6 V, the voltage Vnr) is supplied to the second node N2 (the gate electrode 622 of the second transistor T2) and the fourth node N4 (the second electrode 626 of the second transistor T2). Also, temporarily, the potential difference Vgs becomes 6 V (6 V−0 V), the second transistor T2 is in the on state, and the voltage supplied to the third node N3 (the first electrode 624 of the second transistor T2) and the sixth node N6 (the second electrode 616 of the first transistor T1) starts to rise. However, since the fourth transistor T4 is in the off state, the current does not continue to flow, and the voltage supplied to the third node N3 (the first electrode 624 of the second transistor T2) and the sixth node N6 (the second electrode 616 of the first transistor T1) remains approximately at the voltage Vnp (3 V), and the driving of the display device 30 shifts from the period PIN to the period PVH.

As described above, in the period PIN, the second node N2 and the fourth node N4 are initialized by the constant voltage VSH, and the first node N1 is initialized by the reference voltage VREF. In this case, since the fourth transistor T4, the fifth transistor T5, and the seventh transistor T7 are in the off state, the constant voltage power supply line SVS and the initialization voltage power supply line SVI are not conducted, and the constant voltage power supply line SVS, the drive power supply line PVDD, and the standard voltage line PVSS are not conducted. Therefore, since the current flowing between the power supply lines in the period PIN is interrupted, the power consumed by the display device 30 is suppressed from increasing.

In the period PVH following the period PIN, the image data signal SL(m) (data signal VDATA) is supplied with the voltage of the data signal VDATA supplied to pixels other than the selected pixel 180B (pixel circuit 181B). The sixth scan signal SC6(n) changes from a state where HI is supplied to a state where LO is supplied. In the case where LO is supplied to the sixth scan signal SC6(n), the seventh scan signal SC7(n) changes from a state where LO is supplied to a state where HI is supplied. The rest of the scan signals are in the same condition as the period PIN. The ninth transistor T9 is turned from the on state to the off state, the fourth transistor T4 is turned from the off state to the on state, and the rest of the transistors are in the same state as the period PIN.

Consequently, in the period PVH, the third node N3 (the sixth node N6) is supplied with the initialization voltage VINI (3 V, the voltage Vnp), the voltage supplied to the third node N3 (the sixth node N6) becomes the voltage Vnp, the second transistor T2 is in the on state, the current Ion flows, and the voltage supplied to the first node N1 maintains the voltage Vnq. Further, since the fifth transistor T5 and the seventh transistor T7 are in the off state, the fourth transistor T4 is in the on state, and the ninth transistor T9 is in the off state, the voltage supplied to the second node N2 and the fourth node N4 is released, the current flows from the second node N2 and the fourth node N4 to the initialization voltage power supply line SVI, and the voltage supplied to the second node N2 and the fourth node N4 gradually decreases (discharges) from the voltage Vnr. When the potential difference Vgs between the voltage supplied to the second node N2 and the fourth node N4 and the voltage supplied to the third node N3 (the sixth node N6) becomes the threshold voltage VTH, the second transistor T2 is turned off. In this case, since the third node N3 (the sixth node N6) is supplied with the initialization voltage VINI (3 V), in the case where the potential difference Vgs becomes the threshold voltage VTH, the voltage supplied to the second node N2 and the fourth node N4 is the voltage Vnl (for example, 4 V).

As described above, in the period PVH, by an operation in which the second transistor T2 of the potential difference Vgs becomes the same as the threshold voltage VTH, the second transistor T2 is acquired, and a charge corresponding to the threshold voltage VTH is held in the capacitive element CV.

In a period between the period PVH and the period PWR following the period PVH, or in the period PWR, the image data signal SL(m) (data signal VDATA) is supplied with the voltage VSIGH (for example, 4 V, voltage Vnl). First, the first scan signal SC1(n) changes from a state where HI is supplied to a state where LO is supplied. In the case where the first scan signal SC1(n) is supplied with LO, the seventh scan signal SC7(n) changes from a state where HI is supplied to a state where LO is supplied. In the case where LO is supplied to the seventh scan signal SC7(n), the fourth scan signal SC4(n) changes from a state where LO is supplied to a state where HI is supplied. The third scan signal SC3(n) is in a state where HI is supplied, and the second scan signal SC2(n) and the sixth scan signal SC6(n) are supplied with LO. The first transistor T1 is turned from the off state to the on state, and the third transistor T3 and the fourth transistor T4 are turned from the on state to the off state. The rest of the transistors are similar to the period PVH. The second node N2 is supplied with the voltage VSIGH (for example, 4 V, voltage Vnl), maintains the voltage Vnl (for example, 4 V), maintains the voltage Vnq (for example, reference voltage VREF, 2 V) supplied to the first node N1, the voltage supplied to the third node N3 (the sixth node N6) rises from the voltage Vnp toward the voltage VSIGH (for example, 4 V, the voltage Vnl), and becomes the voltage Vnl (for example, 4 V). In this case, the capacitive element CD maintains the potential difference (2 V with respect to the sixth node N6) by holding charges corresponding to the potential difference between Vnq (the reference voltage VREF, 2 V) supplied to the first node N1 and the voltage Vnl (for example, 4 V) supplied to the third node N3 (sixth node N6). In addition, the potential difference Vgs is 0 V, and the second transistor T2 is in the off state.

As described above, in the period PWR, the data signal VDATA is written to the pixel 180 (the pixel circuit 181). The capacitive element CD maintains (holds) the voltage included in the data signal VDATA.

During a period after the period PWR, the third scan signal SC3(n) is in a state where LO is supplied from a state where HI is supplied. The sixth transistor T6 and the eighth transistor T8 are turned from the on state to the off state. The other scan signals and the other transistors are the same as the period PWR. The voltage supplied to the second node N2 and the voltage supplied to the third node N3 (the sixth node N6) maintain the voltage Vnl, the potential difference Vgs maintains 0 V, and the voltage supplied to the first node N1 capacitively coupled by the capacitive element CV and the capacitive element CD maintains the voltage 0 V.

In the light emission period PEM of the Kth FRAME following the period PWR of the Kth FRAME, the image data signal SL(m) (data signal VDATA) is supplied with the voltage of the data signal VDATA supplied to pixels other than the selected pixel 180 (pixel circuit 181). The second scan signal SC2(n) changes from a state where LO is supplied to a state where HI is supplied. Therefore, the fifth transistor T5 and the seventh transistor T7 are turned from the off state to the on state. The other scan signals and the other transistors are in the same condition as the period after the period PWR of the Kth FRAME. The fifth transistor T5 and the seventh transistor T7 are turned on, and the first electrode 32 of the light-emitting element OLED is electrically connected to the second electrode 626 (fourth node N4) of the second transistor T2. By the third node N3 being connected to the standard voltage VSSEL, the voltage supplied to the second node N2 and the voltage supplied to the third node N3 (the sixth node N6) drop from the voltage Vnl to 0 V, and the voltage supplied to the first node N1 drops from the voltage Vnq to the voltage Vnd (−2 V). That is, the potential difference Vgs is a sum of the potential difference held in the capacitive element CD and the potential difference held in the capacitive element CV (the initialization voltage VINI (3 V)−the voltage of the data signal VDATA (voltage VSIGH, 4 V)+threshold voltage VTH (1 V)=0 V). In the pixel 180B (pixel circuit 181B) in which the data signal VDATA includes the voltage VSIGH, since the potential difference Vgs is 0 V and the second transistor T2 is in the off state, the current Ion does not flow. Therefore, the light-emitting element OLED does not emit light. As a result, the pixel 180 (the pixel circuit 181) emitting red light becomes black. Further, similar to the pixel 180 that emits red light, the pixel 180 that emits blue light and the pixel 180 that emits green light do not emit light, and therefore, three pixels that use the pixel 180 that emits red light, the pixel 180 that emits blue light, and the pixel 180 that emits green light become black.

The standard voltage VSSEL in the display device 30 is 0 V, which is higher than the standard voltage VSSEL (−2 V) of the display device 10, and a difference between a writing potential of the display device 30 and the standard voltage VSSEL is smaller than that of the display device 10. As a result, the potential fluctuation at the time of the transition from writing to light emission in the display device 30 becomes smaller than that in the display device 10, and power consumption of the display device 30 can be lowered more than that in the display device 10. In addition, the display device 30 includes a configuration in which the constant voltage VSH is supplied to the second node N2 and the fourth node N4. Consequently, the display device 30 may make the increase of the voltages of the first node N1, the second node N2, and the third node N3 (the sixth node N6) in the period PIN lower than the increase of the voltages of the first node N1, the second node N2, and the third node N3 (the sixth node N6) in the display device 10. In addition, the display device 30 may make the decrease of the voltages of the first node N1, the second node N2, and the third node N3 (the sixth node N6) from the period PWR to the emission period PEM lower than the decrease of the voltages of the first node N1, the second node N2, and the third node N3 (the sixth node N6) in the display device 10. Therefore, the display device 30 can lower the power consumption in the period PIN and the power consumption from the period PWR to the light emission period PEM more than the display device 10.

### [3-3-2. Second Example of Method for Driving Display Device 30]

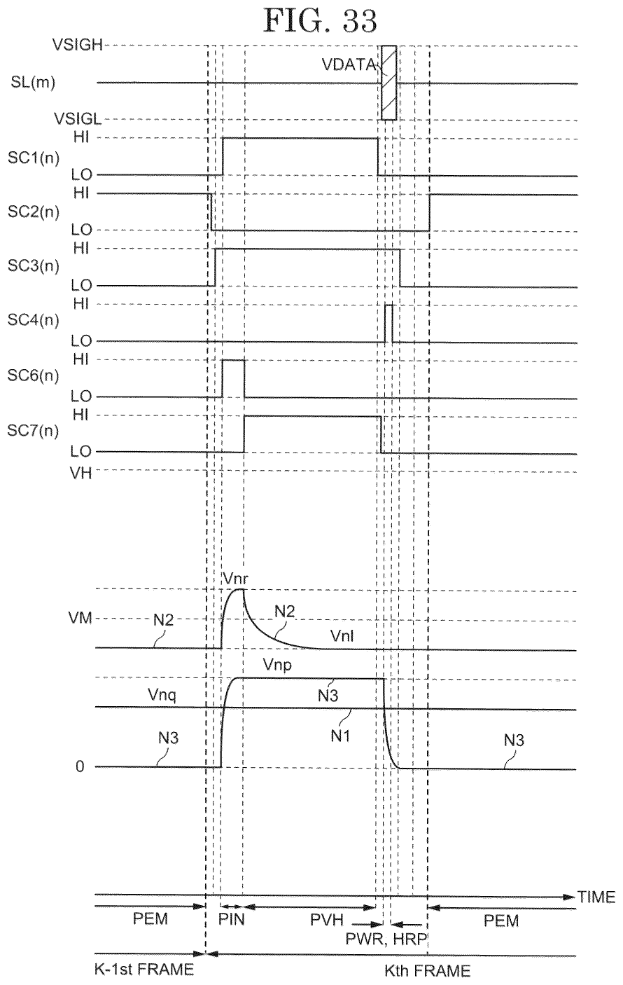

A second example of the method for driving the display device 30 will be described with reference to FIG. 33. The driving method shown in the second example of the display device 30 includes displaying an image of the same color (white color) in consecutive frames as in the second example of the method for driving the display device 10 according to the first embodiment. Configurations that are the same as or similar to those in FIG. 1 to FIG. 32 will be described as necessary.

The voltage (potential) of the respective nodes in the light emission period PEM of the K−1thFRAME to the period PVH of the Kth FRAME and a period between the period PVH of the Kth FRAME and the period PWR of the Kth FRAME are the same as the configurations described in section of “3-3-1. First Example of Method for Driving Display Device 30”. The configuration of each scan signal and the operation of each transistor in each period are the same as the configuration described in section of “3-3-1. First Example of Method for Driving Display Device 30”. Therefore, configurations and the like similar to those described in section of “3-3-1. First Example of Method for Driving Display Device 30” will be described as necessary. In addition, the image data signal SL(m) is supplied with the data signal VDATA including VSIGL (0 V) corresponding to the white color in the period PWR of the Kth FRAME, and the same data signal VDATA as the configuration described in section of “3-3-1. First Example of Method for Driving Display Device 30” is supplied in a period other than the period PWR of the Kth FRAME.

In the emission period PEM of the K−1st FRAME, similar to the configuration described in section of “3-3-1. First Example of Method for Driving Display Device 30”, the pixel 180 (pixel circuit 181) emits red light, and three pixels using the pixel 180 emitting red light, the pixel 180 emitting blue light, and the pixel 180 emitting green light emit white light.

In the period PIN of the Kth FRAME, the second node N2 and the fourth node N4 are initialized by the constant voltage VSH, and the first node N1 is initialized by the reference voltage VREF, similar to the configuration described in section of “3-3-1. First Example of Method for Driving Display Device 30”.

In the period PVH following the period PIN, by the operation in which the potential difference Vgs of the second transistor T2 becomes the same as the threshold voltage VTH, the threshold voltage VTH of the second transistor T2 is acquired, and a charge corresponding to the threshold voltage VTH is held in the capacitive element CV, similar to the configuration described in section of “3-3-1. First Example of Method for Driving Display Device 30”.

In a period between the period PVH and the period PWR following the period PVH, or in the period PWR, the image data signal SL(m) (the data signal VDATA) is supplied with the voltage VSIGL (0 V). The voltage supplied to the second node N2 maintains the voltage Vnl (for example, 4 V), and the voltage supplied to the first node N1 maintains the voltage Vnq (reference voltage VREF, 2 V). The voltage supplied to the third node N3 (the sixth node N6) gradually drops from the voltage Vnp (the initialization voltage VINI, 3 V) and becomes 0 V (the voltage VSIGL). In this case, the capacitive element CD maintains the potential difference (2 V) by holding charges corresponding to the potential difference between the voltage Vnq (reference voltage VREF, 2 V) supplied to the first node N1 and 0 V (voltage VSIGL) supplied to the third node N3 (sixth node N6). Further, the capacitive element CV maintains the potential difference (2V with respect to the first node N1) by holding a charge corresponding to the potential difference between the voltage Vnl (for example, 4 V) supplied to the second node N2 and the voltage Vnq (reference voltage VREF, 2 V) supplied to the first node N1. That is, the potential difference Vgs is a sum of the potential difference held in the capacitive element CD and the capacitive element CV connected in series, and is 4 V.

As described above, in the period PWR, the data signal VDATA is written to the pixel 180 (the pixel circuit 181). The capacitive element CD maintains (holds) the voltage included in the data signal VDATA.

In a period after the period PWR, the voltage supplied to the first node N1 maintains the voltage Vnq (reference voltage VREF, 2 V), the voltage supplied to the second node N2 maintains the voltage Vnl (for example, 4 V), and the voltage supplied to the third node N3 (sixth node N6) maintains 0 V. Further, similar to the period PWR, in the period after the period PWR, the capacitive element CD holds a charge corresponding to a potential difference between the voltage supplied to the first node N1 and the voltage supplied to the third node N3 (the sixth node N6), thereby maintaining the potential difference (2 V with respect to the sixth node N6), and the capacitive element CV maintains the potential difference (2 V with respect to the first node N1) by holding a charge corresponding to a potential difference between the voltage Vnl (for example, 4 V) supplied to the second node N1 and 2 V supplied to the first node N1. That is, the potential difference Vgs is 4 V as a sum of the potential difference held in the capacitive element CD and the capacitive element CV connected in series.

In the emission period PEM of the Kth FRAME subsequent to a period after the period PWR of the Kth FRAME, the potential difference Vgs during the period PWR and the period after the period PWR is held by the two capacitance elements CD and CV, and becomes a sum of the potential difference held in the capacitive element CD and the potential difference held in the capacitive element CV (the initialization voltage VINI (3 V)−the voltage included in the data signal VDATA+the threshold voltage VTH (1 V)=4 V). In other words, the pixel 180B (pixel circuit 181B) can display images based on the data signal VDATA and the corrected threshold voltage. In the case where the data signal VDATA includes the voltage VSIGL, the potential difference Vgs is 4 V and the second transistor T2 is in the on state, so that the current Ion flows from the drive power supply line PVDD to the light-emitting element OLED and the standard voltage line PVSS, and the light-emitting element OLED emits light. For example, the pixel 180B that emits red light, the pixel 180B that emits blue light, and the pixel 180B that emits green light emit light respectively, and three pixels using the pixel 180B that emits red light, the pixel 180B that emits blue light, and the pixel 180B that emits green light become white.

The second example of the method for driving the display device 30 has the same effects as those described in section of “3-3-1. First Example of Method for Driving Display Device 30”.

### [3-3-3. Third Example of Method for Driving Display Device 30]

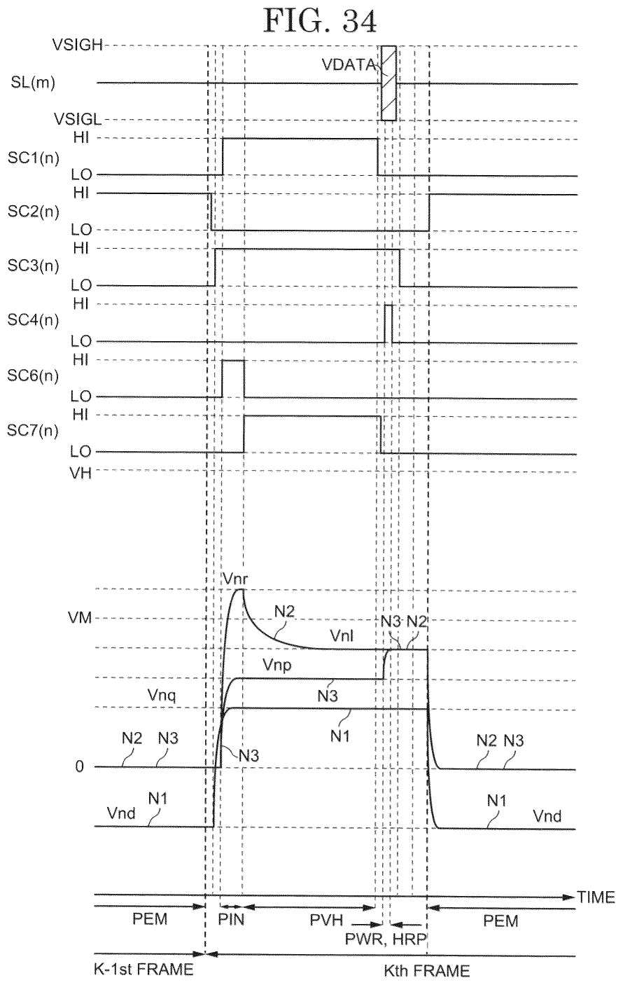

A third example of the method for driving the display device 30 will be described with reference to FIG. 34. The driving method shown in the third example of the method for driving the display device 30 includes displaying images of the same color (black) in consecutive frames as in the third example of the method for driving the display device 10 according to the first embodiment. Configurations that are the same as or similar to those in FIG. 1 to FIG. 33 will be described as necessary.

The voltages (potentials) and the like of the respective nodes in the emission period PVH of the Kth FRAME to the period PEM of Kth FRAME are the same as the configurations described in section of “3-3-1. First Example of Method for Driving Display Device 30”. The configuration of each scan signal and the operation of each transistor in each period are the same as the configuration described in section of “3-3-1. First Example of Method for Driving Display Device 30”. Therefore, configurations and the like similar to those described in section of “3-3-1. First Example of Method for Driving Display Device 30” will be described as necessary.

In the emission period PEM of the K−1st FRAME, for example, the voltage supplied to the first node N1 is the voltage Vnd (−2 V). Further, the voltage supplied to the second node N2 and the voltage supplied to the third node N3 (the sixth node N6) are 0 V, and the potential difference Vgs is 0 V. Therefore, the second transistor T2 is in the off state, the current Ion does not flow, and the light emitting element OLED does not emit light.

Consequently, the pixel 180B (pixel circuit 181B) emitting red light becomes black. Further, similar to the pixel 180B that emits red light, the pixel 180B that emits blue light and the pixel 180B that emits green light do not emit light, and therefore, three pixels using the pixel 180B that emits red light, the pixel 180B that emits blue light, and the pixel 180B that emits green light become black.

In the period between the light emission period PEM of the K−1st FRAME and the period PIN of the Kth FRAME following the light emission period PEM of the K−1st FRAME, or the period PIN of the Kth FRAME, the potential difference between the first electrode 32 and the second electrode 34 of the light-emitting element OLED becomes 0 V and the voltage supplied to the first node N1 increases from the voltage Vnd (−2 V) toward the voltage Vnq (reference voltage VREF, 2 V) to become the voltage Vnq. The second node N2 and the fourth node N4 become conductive, and the voltage supplied to the second node N2 (the gate electrode 622 of the second transistor T2) and the fourth node N4 (the second electrode 626 of the second transistor T2) increases from 0 V toward the voltage VSH (6 V, the voltage Vnr), and becomes the voltage Vnr. Also, the voltage supplied to the third node N3 (the first electrode 624 of the second transistor T2) and the sixth node N6 (the second electrode 616 of the first transistor T1) starts to rise from the voltage Vnd (−2 V). However, since the fourth transistor T4 is in the off state, the current does not continue to flow, and the voltage supplied to the third node N3 (the first electrode 624 of the second transistor T2) and the sixth node N6 (the second electrode 616 of the first transistor T1) remains approximately at the voltage Vnp (3 V), and the driving of the display device 30 shifts from the period PIN to the period PVH.

As described above, in the period PIN, the second node N2 and the fourth node N4 are initialized by the driving voltage VDDEL, and the first node N1 is initialized by the reference voltage VREF.

In the period PVH following the period PIN, similar to the configuration described in section of “3-3-1. First Example of Method for Driving Display Device 30”, by the operation in which the potential difference Vgs of the second transistor T2 becomes the same as the threshold voltage VTH, the threshold voltage VTH of the second transistor T2 is acquired, and the charge corresponding to the threshold voltage VTH is held in the capacitive element CV.

In the period PWR following the period PVH, the data signal VDATA is written in the pixel 180B (pixel circuit 181B) in the same manner as in the configuration described in section of “3-3-1. First Example of Method for Driving Display Device 30”. The capacitive element CD maintains (holds) the voltage included in the data signal VDATA.

In a period after the period PWR and a period after the period PWR, and in the light emission period PEM of the Kth FRAME following the period after the period PWR, the pixel circuit 181B operates in the same manner as in the configuration described in section of “3-3-1. First Example of Method for Driving Display Device 30”, and since the potential difference Vgs is 0 V and the second transistor T2 is in the off state, the current Ion does not flow and the light-emitting element OLED does not emit light. As a consequence, three pixels using the pixel 180B that emits red light, the pixel 180B that emits blue light, and the pixel 180B that emits green light become black.

The third example of the method for driving the display device 10 has the same effects as those described in section of “3-3-1. First Example of Method for Driving Display Device 30”.

### [3-3-4. Fourth Example of Method for Driving Display Device 30]

A fourth example of the method for driving the display device 30 will be described with reference to FIG. 35. The driving method shown in the fourth example of the method for driving the display device 30 includes displaying images of different colors in consecutive frames as in the fourth example of the method for driving the display device 10 according to the first embodiment. Configurations that are the same as or similar to those in FIG. 1 to FIG. 34 will be described as necessary.

The voltage (potential) of each node in the light emission period PEM of the K−1st FRAME to the period PVH of the Kth FRAME, the configuration of each scan signal, the operation of each transistor, and the like are the same as those described in section of “3-3-3. Third Example of Method for Driving Display Device 30”. Further, the voltage (potential) of each node in the period after the period PVH of the Kth FRAME to the light emission period PEM of the Kth FRAME, the configuration of each scan signal, the operation of each transistor, and the like are the same as those described in section of “3-3-2. Second Example of Method for Driving Display Device 30”. Therefore, the description thereof will be omitted.

The fourth example of the driving method of the display device 30 has the same effects as those described in section of “3-3-1. First Example of the driving method of the display device 30”.

### 4. Fourth Embodiment

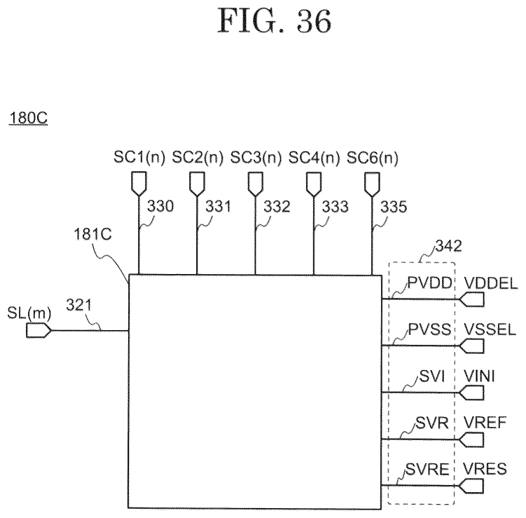

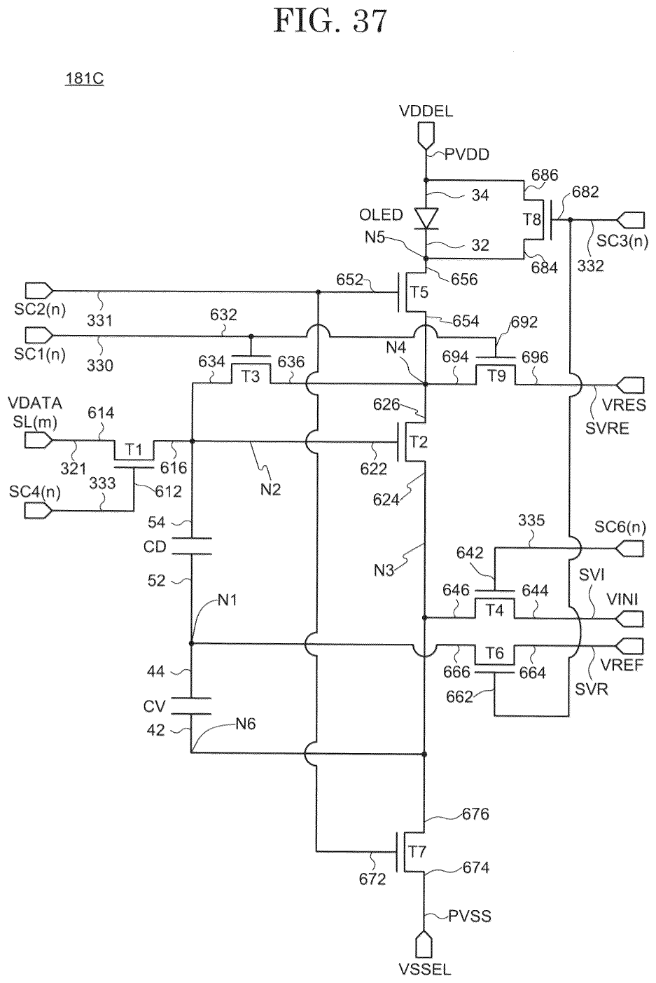

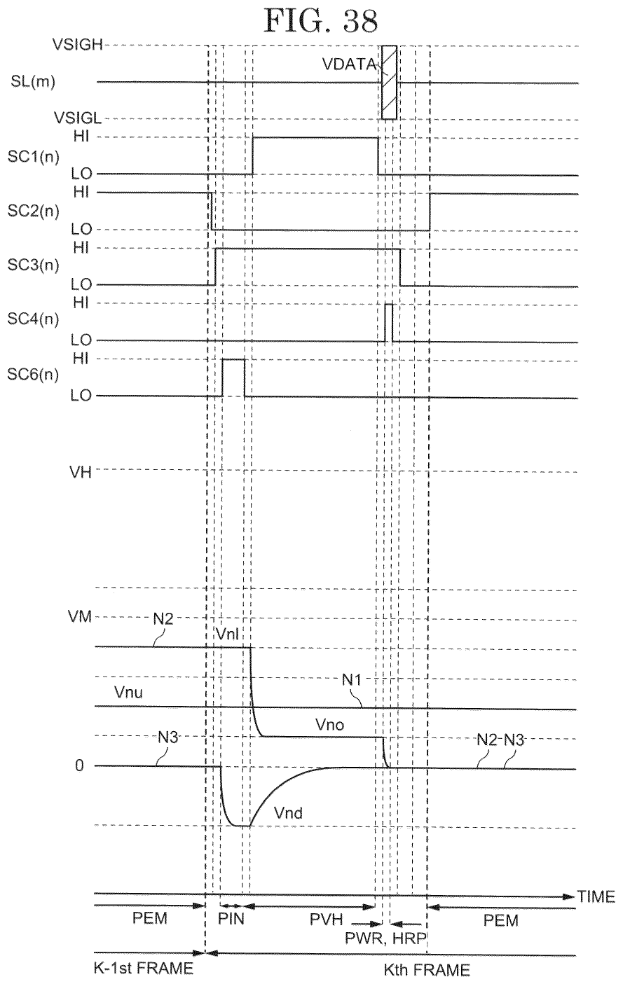

With reference to FIG. 4, FIG. 29, and FIG. 36 to FIG. 41, an overview of a display device according to a fourth embodiment will be described. FIG. 36 is a schematic diagram showing an input signal to the pixel 180C (pixel circuit 181C) according to the fourth embodiment, FIG. 37 is a circuit diagram showing a configuration of the pixel circuit 181C, and FIG. 38 to FIG. 41 are timing charts of the display device 30.

The display device according to the fourth embodiment includes the same configuration as the display device 30 according to the third embodiment shown in FIG. 29. The display device according to the fourth embodiment includes the pixel 180C (pixel circuit 181C). Specifically, the display device according to the fourth embodiment includes the following configurations (16) to (21). Mainly, the configurations shown in (16) to (21) are different from the configuration of the display device 30 according to the third embodiment.
(16) A configuration and function in which the pixel 180B (pixel circuit 181B) of the display device 30 according to the third embodiment is replaced with the pixel 180C (pixel circuit 181C), and a configuration and function related to the pixel 180C (pixel circuit 181C) differ from the configuration and the function related to the pixel 180B (pixel circuit 181B).
(17) The electrical connection between the control circuit 120 and the pixel 180C (pixel circuit 181C) differs from the electrical connection between the control circuit 120B and the pixel 180B (pixel circuit 181B).
(18) The gate electrode 692 of the ninth transistor T9 is electrically connected to the scan signal line 330, and the first scan signal SC1(n) supplied to the scan signal line 330 is supplied to the gate electrode 692 of the ninth transistor T9. Further, the timing of a falling edge and a rising edge of the first scan signal SC1(n) differs from the timing of the falling edge and the rising edge of the first scan signal SC1(n) according to the third embodiment.
(19) The gate electrode 642 of the fourth transistor T4 is electrically connected to the scan signal line 335, and the sixth scan signal SC6(n) supplied to the scan signal line 335 is supplied to the gate electrode 642 of the fourth transistor T4. Therefore, the display device according to the fourth embodiment does not include the seventh scan signal SC7(n) supplied to the scan signal line 336 and the scan signal line 336 according to the third embodiment.
(20) A reset voltage VRES and a reset voltage power supply line SVRE to which the reset voltage VRES is supplied are added. The reset voltage power supply line SVRE is electrically connected to the second terminal 696 of the ninth transistor T9. Therefore, the display device according to the fourth embodiment does not include the constant voltage VSH and the constant voltage power supply line SVS to which the constant voltage VSH according to the third embodiment is supplied.
(21) The first transistor T1, the capacitive element CV, and the capacitive element CD differ from the first transistor T1, the capacitive element CV, and the capacitive element CD in the pixel 180B (pixel circuit 181B) in electrical connection with the respective nodes and transistors.

Configurations other than those shown in (16) to (21) in the display device according to the fourth embodiment and configurations other than those related to the configurations shown in (16) to (21) in the display device according to the fourth embodiment are the same as those of the display device 30 according to the third embodiment. In describing the configuration and function of the display device according to the fourth embodiment, the same configuration and function as those of the display device 30 according to the third embodiment will be described as necessary.

### [4-1. Configuration of Pixel 180C]

Referring to FIG. 29, FIG. 36, and FIG. 37, the overview of the pixel 180C and the pixel circuit 181C will be described.

The pixel circuit 181C is connected to the reset voltage power supply line SVRE. The pixel circuit 181C is not connected to the scan signal line 336 and the constant voltage power supply SVS.

The reset voltage VRES is supplied to the reset voltage power supply line SVRE. For example, the reset voltage power supply line SVRE is electrically connected to the connection wiring 342 that differs from the initialization voltage power supply line SVI, the reference voltage power supply line SVR, the drive power supply line PVDD, and the standard voltage line PVSS among the connection wirings 342. Further, the reset voltage power supply line SVRE may be one of the connection wirings 342. For example, the reset voltage VRES may be supplied from an external device to the IC chip 110, and may be supplied from the IC chip 110 to a plurality of pixels 180C (pixel circuits 181C) via the connection wiring 342 and the reset voltage power supply line SVRE. In addition, although not shown, the reset voltage VRES may be connected from an external device to the reset voltage power supply line SVRE via the FPC 200, the terminal portion 150, and the connection wiring 341 without passing through the IC chip 110 and the connection wiring 342, and may be supplied to the plurality of pixels 180C (pixel circuits 181C).

For example, the first transistor T1 is a selection transistor. The first transistor T1 has a function of supplying the image data signal SL(m) to the second node N2. The first transistor T1 includes the gate electrode 612, the first electrode 614, and the second electrode 616. The gate electrode 612 is electrically connected to the scan signal line 333. The first electrode 614 is electrically connected to the image data signal line 321. The second electrode 616 is electrically connected to the second node N2, the gate electrode 622 of the second transistor T2, the first electrode 634 of the third transistor T3, and the second electrode 54 of the capacitive element CD. The fourth scan signal SC4(n) is supplied to the scan signal line 333. Switching of the first transistor T1 is controlled using the fourth scan signal SC4(n). In other words, in the first transistor T1, the conduction state (on state) and the non-conduction state (off state) are controlled by the fourth scan signal SC4(n). In the case where the signal supplied to the fourth scan signal SC4(n) is LO, the first transistor T1 becomes non-conductive. In the case where the signal supplied to the fourth scan signal SC4(n) is HI, the first transistor T1 becomes conductive.

The gate electrode 642 of the fourth transistor T4 is electrically connected to the scan signal line 335. As described above, the sixth scan signal SC6(n) is supplied to the scan signal line 335. The fourth transistor T4 is switched using the sixth scan signal SC6(n). In other words, in the fourth transistor T4, the conduction state (on state) and the non-conduction state (off state) are controlled by the sixth scan signal SC6(n). In the case where the signal supplied to the sixth scan signal SC6(n) is LO, the fourth transistor T4 becomes non-conductive, and in the case where the signal supplied to the sixth scan signal SC6(n) is HI, the fourth transistor T4 becomes conductive.

The ninth transistor T9 has a function of conducting the fourth node N4 and the reset voltage power supply line SVRE to provide the reset voltage VRES to the fourth node N4. The ninth transistor T9 includes the gate electrode 692, the first electrode 694, and the second electrode 696. The gate electrode 692 is electrically connected to the scan signal line 330. The first electrode 694 is electrically connected to the fourth node N4, the first electrode 654 of the fifth transistor T5, the second electrode 636 of the third transistor T3 and the second electrode 626 of the second transistor T2. The second electrode 696 is electrically connected to the reset voltage power supply line SVRE. As described above, the first scan signal SC1(n) is supplied to the scan signal line 330. The ninth transistor T9 is switched using the first scan signal SC1(n). In other words, in the ninth transistor T9, the conduction state (on state) and the non-conduction state (off state) are controlled by the first scan signal SC1(n). In the case where the signal supplied to the first scan signal SC1(n) is LO, the ninth transistor T9 becomes non-conductive, and in the case where the signal supplied to the first scan signal SC1(n) is HI, the ninth transistor T9 becomes conductive.

The capacitive element CV has a function of holding (storing) charges corresponding to the threshold voltage VTH of the second transistor T2. In addition, the sixth node N6 of the pixel circuit 181C is connected to the third node N3, and in the display device according to the fourth embodiment, the threshold voltage VTH is acquired from the first electrode 624 (source electrode) side of the second transistor T2. The capacitive element CV includes the first electrode 42 and the second electrode 44. The first electrode 42 is electrically connected to the third node N3 (the sixth node N6), the first electrode 624 of the second transistor T2, the second electrode 646 of the fourth transistor T4 and the second electrode 676 of the seventh transistor T7. The second electrode 44 is electrically connected to the first node N1, the second electrode 666 of the sixth transistor T6, and the first electrode 52 of the capacitive element CD.

The capacitive element CD has a function of holding (storing) charges corresponding to a data voltage (a voltage equal to or higher than the voltage VSIGL (see FIG. 38) and equal to or lower than the voltage VSIGH (see FIG. 38)) included in the image data signal SL(m) supplied to the second node N2. The capacitive element CD includes the first electrode 52 and the second electrode 54.

The configuration and the function of the pixel circuit 181C other than the configuration and the function described in section of “4-1. Configuration of Pixel 180C” are the same as those of the pixel circuit 181B.

### [4-2. Method for Driving Display Device According to Fourth Embodiment]

Referring to FIG. 38 to FIG. 41, methods for driving the display device (pixel circuit 181C) according to the fourth embodiment will be described. Configurations that are the same as or similar to those in FIG. 1 to FIG. 37 will be described as necessary. The horizontal axis of the timing charts indicates time (TIME).

The method for driving the display device according to the fourth embodiment includes a period similar to the method for driving the display device 10 according to the first embodiment shown in FIG. 4.

In one horizontal period (horizontal period HRP) in the method for driving the display device according to the fourth embodiment, the pixel 180C (pixel circuit 181C) receives the image data signal SL(m) including the first scan signal SC1(n), the second scan signal SC2(n), the third scan signal SC3(n), the fourth scan signal SC4(n), the sixth scan signal SC6(n), and the data signal VDATA. For example, the pixel 180C (pixel circuit 181C) is selected according to timings of the first scan signal SC1(n), the second scan signal SC2(n), the third scan signal SC3(n), the fourth scan signal SC4(n), and the sixth scan signal SC6(n). The image data signal SL(m) is input to the selected pixel 180C (pixel circuit 181C) in accordance with the timings of the respective signals. A similar operation is performed on all the pixels 180C (pixel circuits 181C), and an image of the frame corresponding to the 1FRAME is displayed in the display region 22 of the display device 10 on the basis of the image data signal SL(m) input to all the pixels 180C (pixel circuits 181C).

For example, each signal of each frame and the voltage (potential) supplied to each node in the timing charts shown in FIG. 38 to FIG. 41 are shown in Table 3.

TABLE 3

| | Setting Value [V] |
|---|---|
| VTH | 1 |
| VSIGL(black) | 0 |
| VSIGH(white) | 4 |
| HI | 10 |
| LO | −3 |
| VINI | −2 |
| VREF | 2.2 |
| VRES | 1 |
| VDDEL | 8 |
| VSSEL | 0 |

For example, as shown in Table 3, the voltage VSIGH is 4 V, the voltage VSIGL is 0 V, the initialization voltage VINI is −2 V, the reference voltage VREF is 2.2 V, and the reset voltage VRES is 1 V. That is, the reset voltage VRES, the reference voltage VREF, and the initialization voltage VINI are different from each other, and the reset voltage VRES and the reference voltage VREF are larger than the standard voltage VSSEL and smaller than the driving voltage VDDEL. The initialization voltage VINI is smaller than the standard voltage VSSEL and the driving voltage VDDEL. The other voltage setting values are the same as the setting values shown in Table 1 described in section of “1-5. Driving Method of Display Device 10”.

### [4-2-1. First Example of Method for Driving Display Device According to Fourth Embodiment]

Referring to FIG. 38 and Table 3, a first example of the method for driving the display device according to the fourth embodiment will be described. The first example of the method for driving the display device according to the fourth embodiment includes displaying images of different colors in consecutive frames as in the first example of the driving method of the display device 10 according to the first embodiment. Configurations that are the same as or similar to those in FIG. 1 to FIG. 37 will be described as necessary.

As in the first example of the method for driving the display device 10 according to the first embodiment, the image data signal SL(m) including the data signal VDATA is input to each pixel 180C (pixel circuit 181C) in accordance with each period. The data signal VDATA is analog data including a voltage equal to or higher than the voltage VSIGL and equal to or lower than the voltage VSIGH. For example, in the period PWR, a voltage equal to or higher than the voltage VSIGL and equal to or lower than the voltage VSIGH is selected by using a selection signal (not shown), and is supplied to the image data signal SL(m). For example, in the period excluding the period PWR, the data signal VDATA is supplied with a voltage other than the selected pixel 180C (pixel circuit 181C).

The emission period PEM of the K−1st FRAME is a period in which the pixel 180C (pixel circuit 181C) emits light according to the potential difference Vgs of the second transistor T2 (the voltage supplied to the second node N2 (voltage V (N2))−the voltage supplied to the third node N3 (voltage V (N3)). For example, the pixel 180C (pixel circuit 181C) emits red light, and three pixels using the pixel 180C that emits red light, the pixel 180C that emits blue light, and the pixel 180C that emits green light emit white light.

For example, in the light emission period PEM of the K−1st FRAME, the image data signal SL(m) (data signal VDATA) is supplied with the voltage of the data signal VDATA supplied to pixels other than the selected pixel 180C (the pixel circuit 181C), the first scan signal SC1(n), the third scan signal SC3(n), the fourth scan signal SC4(n), and the sixth scan signal SC6(n) are supplied with LO, and the second scan signal SC2(n) is supplied with HI. The first transistor T1, the third transistor T3, the fourth transistor T4, the sixth transistor T6, the eighth transistor T8, and the ninth transistor T9 are in the off state, and the fifth transistor T5 and the seventh transistor T7 are in the on state. Further, for example, the voltage supplied to the third node N3 is 0 V, the voltage supplied to the second node N2 is the voltage Vnl (for example, 4 V), and the potential difference Vgs is 4 V. Therefore, the second transistor T2 is in the on state, and the light-emitting element OLED and the reference voltage line PVSS can be supplied with the current Ion based on the potential difference Vgs and the potential difference Vds corresponding to the voltage VSIGH input in the horizontal-period HRP of the K−1st FRAME from the drive power supply line PVDD. Consequently, the light-emitting element OLED emits light. In addition, the voltage supplied to the first node N1 is a voltage Vnu (2.2 V, the reference voltage VREF) by capacitive coupling by the capacitive element CV and the capacitive element CD. For example, the pixel 180C (pixel circuit 181C) emits red light, and three pixels using the pixel 180C that emits red light, the pixel 180C that emits blue light, and the pixel 180C that emits green light emit white light.

In the period between the light emission period PEM of the K−1st FRAME and the period PIN of the Kth FRAME following the light emission period PEM of the K−1st FRAME or in the period PIN of the Kth FRAME, the data signal SL(m) is supplied with the voltage of the data signal VDATA supplied to pixels other than the selected pixel 180 (pixel circuit 181). First, the second scan signal SC2(n) changes from a state where HI is supplied to a state where LO is supplied. In the case where LO is supplied to the second scan signal SC2(n), the third scan signal SC3(n) changes from a state where LO is supplied to a state where HI is supplied. In the case where the third scan signal SC3(n) is supplied with HI, the sixth scan signal SC6(n) changes from a state where LO is supplied to a state where HI is supplied. The first scan signal SC1(n) and the fourth scan signal SC4(n) are supplied with LO.

Consequently, in the period between the light emission period PEM of the K−1st FRAME and the period PIN of the Kth FRAME, or in the period PIN of the Kth FRAME, the fifth transistor T5 and the seventh transistor T7 change from the on state to the off state, and the current Ion does not flow from the drive power supply line PVDD to the light-emitting elements OLED and the standard voltage line PVSS. The eighth transistor T8 is turned from the off state to the on state, the potential difference between the first electrode 32 and the second electrode 34 of the light-emitting element OLED becomes 0 V, and the light emission of the light-emitting element OLED is stopped. The sixth transistor T6 is turned from the off state to the on state, and the first node N1 is supplied with the reference voltage VREF (2.2 V, the voltage Vnu) to maintain the voltage Vnu. The fourth transistor T4 is turned from the off state to the on state, and the third node N3 (the sixth node N6) is supplied with the initialization voltage VINI (−2 V, the voltage Vnd) to be the voltage Vnd. The first transistor T1, the third transistor T3, the fifth transistor T5, and the ninth transistor T9 remain in the off state. The voltage supplied to the second node N2 (the gate electrode 622 of the second transistor T2) maintains the voltage Vnl (for example, 4 V). The potential difference Vgs temporarily becomes 6 V (4 V−(−2 V)), the second transistor T2 is in the on state, however, no current continues to flow because the fifth transistor T5 is in the off state. Therefore, the voltage supplied to the fourth node N4 becomes the voltage Vnd (−2 V).

As described above, in the period PIN, the third node N3 (the sixth node N6) and the fourth node N4 are initialized by the initialization voltage VINI, and the first node N1 is initialized by the reference voltage VREF.

In the period PVH following the period PIN, the image data signal SL(m) (data signal VDATA) is supplied with the voltage of the data signal VDATA supplied to pixels other than the selected pixel 180C (pixel circuit 181C). The sixth scan signal SC6(n) changes from a state where HI is supplied to a state where LO is supplied. In the case where LO is supplied to the sixth scan signal SC6(n), the first scan signal SC1(n) changes from the state where LO is supplied to a state where HI is supplied. The rest of the scan signals are in the same condition as the period PIN. The third transistor T3 and the ninth transistor T9 are switched from the off state to the on state, the fourth transistor T4 is switched from the on state to the off state, and the rest of the transistors are in the same state as the period PIN.

Consequently, in the period PVH, the third transistor T3 and the ninth transistor T9 are in the on state, the second node N2, the fourth node N4, and the reset voltage power supply line SVRE are conducted, and the reset voltage VRES (1 V, a voltage Vno) is supplied to the second node N2 and the fourth node N4, so that the voltage Vno is acquired. The first node N1 maintains the voltage Vnq. Further, the fourth transistor T4, the fifth transistor T5, and the seventh transistor T7 are in the off state, the second transistor T2 is in the on state, the current Ion flows, and the fourth transistor T4 is turned off, whereby the third node N3 is released, the current Ion flows to the third node N3 (the sixth node N6), the third node N3 (the sixth node T4) is charged, and the potential of the third node N3 (the sixth node N6) rises. When the potential difference Vgs between the voltage supplied to the second node N2 and the fourth node N4 and the voltage supplied to the third node N3 (the sixth node N6) becomes the threshold voltage VTH, the second transistor T2 is turned off. In this case, since the reset voltage VRES (1 V, the voltage Vno) is supplied to the second node N2 and the fourth node N4, the voltage supplied to the third node N3 (the sixth node N6) in the case where the potential difference Vgs becomes the threshold voltage VTH is 0 V. That is, the potential of the third node N3 is the reset voltage VRES (1 V, the voltage Vno)−the threshold voltage VTH. The threshold voltage VTH varies in manufacturing, for example, in the case where the threshold voltage VTH becomes 1.1 V, the potential of the third node N3 becomes −0.1 V, and the threshold voltage VTH is corrected by operating in the period PVH.

As described above, in the period PVH, by the operation in which the potential difference Vgs of the second transistor T2 becomes the same as the threshold voltage VTH, the second transistor T2 is acquired, and a charge corresponding to the threshold voltage VTH is held in the capacitive element CV.

In the period between the period PVH and the period PWR following the period PVH, or in the period PWR, the image data signal SL(m) (the data signal VDATA) is supplied with the voltage VSIGL (0 V). First, the first scan signal SC1(n) changes from a state where HI is supplied to a state where LO is supplied. In the case where the first scan signal SC1(n) is supplied with LO, the fourth scan signal SC4(n) changes from a state where LO is supplied to a state where HI is supplied. The third scan signal SC3(n) is supplied with HI, and the second scan signal SC2(n) and the sixth scan signal SC6(n) are supplied with LO. The first transistor T1 is turned from the off state to the on state, and the third transistor T3 and the ninth transistor T9 are turned from the on state to the off state. The rest of the transistors are similar to the period PVH. The voltage supplied to the second node N2 drops from the voltage Vno toward the voltage VSIGL (0 V) due to the application of the voltage VSIGL (0 V) of the image data signal SL(m) (data signal VDATA), and becomes 0 V, the voltage supplied to the first node N1 maintains the voltage Vnu (reference voltage VREF, 2.2 V), and the voltage supplied to the third node N3 (the sixth node N6) maintains 0 V. In this case, the capacitive element CD maintains the potential difference (−2.2 V with respect to the first node N1) by holding charges corresponding to the potential difference between Vnu (the reference voltage VREF, 2.2 V) supplied to the first node N1 and 0 V supplied to the second node N2. Further, the capacitive element CV maintains the potential difference (2.2 V with respect to the sixth node N6) by holding charges corresponding to the potential difference between Vnu (reference voltage VREF, 2.2 V) supplied to the first node N1 and 0 V supplied to the third node N3 (sixth node N6). The sum (−2.2 V+2.2 V) of the potential difference held in the capacitive element CD and the potential difference held in the capacitive element CV is 0 V, that is, the potential difference Vgs becomes 0 V, and the second transistor T2 is in the off state.

As described above, in the period PWR, the data signal VDATA is written to the pixel 180C (pixel circuit 181C). The capacitive element CD maintains (holds) the voltage included in the data signal VDATA.

In the period after the period PWR, the fourth scan signal SC4(n) changes from a state where HI is supplied to a state where LO is supplied. In the case where the fourth scan signal SC4(n) is supplied with LO, the third scan signal SC3(n) changes from a state where HI is supplied to a state where LO is supplied. The first transistor T1, the sixth transistor T6, and the eighth transistor T8 are turned from the on state to the off state. The other scan signals and the other transistors are the same as the period PWR. The voltage supplied to the first node N1 maintains the voltage Vnu (reference voltage VREF, 2.2 V), and the voltage supplied to the second node N2 and the third node N3 (sixth node N6) maintains 0 V. A potential difference (a potential difference between the second node N2 and the third node N3) acquired by combining the capacitive element CD and the capacitive element CV maintains 0 V. That is, the potential difference Vgs is 0 V, and the second transistor T2 is in the off state.

In the light emission period PEM of the Kth FRAME following the period PWR of the Kth FRAME, the image data signal SL(m) (data signal VDATA) is supplied with the voltage of the data signal VDATA supplied to pixels other than the selected pixel 180C (pixel circuit 181C). Further, the second scan signal SC2(n) changes from a state where LO is supplied to a state where HI is supplied. Therefore, the fifth transistor T5 and the seventh transistor T7 are turned from the off state to the on state. The other scan signals and the other transistors are in the same condition as the period after the period PWR of the Kth FRAME. The fifth transistor T5 and the seventh transistor T7 are turned to the on state, and the first electrode 32 of the light-emitting element OLED is electrically connected to the second electrode 626 (fourth node N4) of the second transistor T2. In the case where the seventh transistor T7 is turned to the on state, the third node N3 (the sixth node N6) is connected to the standard voltage VSSEL, the voltage supplied to the third node N3 (the sixth node N6) is turned to 0 V, and 0 V of the second node N2 is maintained by the capacitive coupling of the capacitive element CD and the capacitive element CV. The first node N1 also maintains 2.2 V by the capacitive coupling between the capacitive element CD and the capacitive element CV. In addition, for example, in the case where the threshold voltage VTH is 1 V (set value) by manufacturing, even if the seventh transistor T7 is turned on, the voltage supplied to the third node N3 (the sixth node N6) remains 0 V and does not change, and in the case where the threshold voltage VTH is 1.1 V due to manufacturing variations, the voltage supplied to the third node N3 (sixth node N6) becomes −0.1 V, and the seventh transistor T7 turns on, so that the voltage supplied to the third node N3 (the sixth node N6) changes from −0.1 V to 0 V. The potential difference Vgs is a sum of the potential difference held in the capacitive element CD and the potential difference held in the capacitive element CV (the voltage (voltage VSIGL, 0 V) of the data signal VDATA−the reset voltage VRES (1 V)+the threshold voltage VTH (1 V)=0 V). In the pixel 180C (pixel circuit 181C) in which the data signal VDATA includes the voltage VSIGL, since the potential difference Vgs is 0 V and the second transistor T2 is in the off state, the current Ion does not flow. Therefore, the light-emitting element OLED does not emit light. Consequently, the pixel 180C (pixel circuit 181C) emitting red light becomes black. Similar to the pixel 180C that emits red light, the pixel 180C that emits blue light and the pixel 180C that emits green light do not emit light, and therefore, three pixels using the pixel 180C that emit red light, the pixel 180C that emits blue light, and the pixel 180C that emits green light become black.

The standard voltage VSSEL in the display device according to the fourth embodiment is 0 V, and the display device according to the fourth embodiment includes a configuration in which the reset voltage VRES is supplied to the second node N2 and the fourth node N4. With the reset voltage VRES as a reference, by applying information (data) of the threshold voltage VTH to the low potential side of the potential difference Vgs of the second transistor T2, applying the voltage (data) of the data signal VDATA to the high potential side of the potential difference Vgs of the second transistor T2, and arranging the light emitting element OLED on the drain side (driving voltage VDDEL side) opposite to the potential difference Vgs side of the second transistor T2, it is possible to minimize the fluctuations in voltage (potential fluctuations) of the first node N1, the second node N2, and the third node N3 (sixth node N6) from the period PWR to the light emission period PEM. Therefore, the display device according to the fourth embodiment can suppress the power consumed in the light emission period PEM from the period PWR, and also reduces charge redistribution caused by the gate capacitance of the second transistor T2 due to potential fluctuations at the second node N2, thereby minimizing voltage loss that occurs when the write voltage drops during light emission.

### [4-2-2. Second Example of Method for Driving Display Device According to Fourth Embodiment]

A second example of the method for driving the display device according to the fourth embodiment will be described with reference to FIG. 39. The driving method shown in the second example of the display device according to the fourth embodiment includes displaying an image of the same color (white) in consecutive frames as in the second example of the method for driving the display device 10 according to the first embodiment. Configurations that are the same as or similar to those in FIG. 1 to FIG. 38 will be described as necessary.

The voltage (potential) of the respective nodes the light emission period PEM of the K−1thFRAME to the period PVH of the Kth FRAME and in the period between the period PVH of the Kth FRAME and the period PWR of the Kth FRAME are the same as the configurations described in section of “4-2-1. First Example of Method for Driving Display Device according to Fourth Embodiment”. The configuration of each scan signal and the operation of each transistor in each period are the same as the configuration described in section of “4-2-1. First Example of Method for Driving Display Device according to Fourth Embodiment”. Therefore, configurations and the like similar to those described in section of “4-2-1. First Example of Method for Driving Display Device according to Fourth Embodiment” will be described as necessary. In addition, the image data signal SL(m) is supplied with the data signal VDATA including the VSIGH (4 V) corresponding to white in the period PWR of the Kth FRAME, and supplied with the data signal VDATA similar to the configuration described in section of “4-2-1. First Example of Method for Driving Display Devices according to Fourth Embodiment” in the periods other than the period PWR of the Kth FRAME.

In the light emission period PEM of the K−1st FRAME, similar to the configuration described in section of “4-2-1. First Example of Method for Driving Display Device according to Fourth Embodiment”, the pixel 180C (pixel circuit 181C) emits red light, and three pixels using the pixel 180C that emits red light, the pixel 180C that emits blue light, and the pixel 180C that emits green light emit white light.

In the period PIN of the Kth FRAME, similar to the configuration described in section of “4-2-1. First Example of Method for Driving Display Device according to Fourth Embodiment”, the third node N3 (the sixth node N6) is initialized by the initialization voltage VINI, and the first node N1 is initialized by the reference voltage VREF.

In the period PVH following the period PIN, similar to the configuration described in section of “4-2-1. First Example of Method for Driving Display Device according to Fourth Embodiment”, the threshold voltage VTH of the second transistor T2 is acquired by the operation in which the potential difference Vgs of the second transistor T2 becomes the same as the threshold voltage VTH, and the charge corresponding to the threshold voltage VTH is held in the capacitive element CV.

In the period between the period PVH and the period PWR following the period PVH, or in the period PWR, the image data signal SL(m) (the data signal VDATA) is supplied with the voltage VSIGH (4 V). The voltage supplied to the second node N2 rises from the voltage Vno toward the voltage VSIGH (for example, 4 V, voltage Vnl) and becomes the voltage Vnl, the voltage supplied to the first node N1 maintains the voltage Vnu (reference voltage VREF, 2.2 V), and the voltage supplied to the third node N3 (sixth node N6) maintains 0 V. In this case, the capacitive element CD maintains the potential difference (1.8 V with respect to the first node N1) by holding a charge corresponding to a potential difference between the voltage Vnu (reference voltage VREF, 2.2 V) supplied to the first node N1 and the voltage Vnl (for example, 4 V, voltage VSIGH) supplied to the second node N2. Further, the capacitive element CV maintains the potential difference (2.2 V with respect to the sixth node N6) by holding charges corresponding to the potential difference between the voltage Vnu (the reference voltage VREF, 2.2 V) supplied to the first node N1 and 0 V supplied to the third node N3 (the sixth node N6). That is, the potential difference Vgs is 4 V.

As described above, in the period PWR, the data signal VDATA is written to the pixel 180C (pixel circuit 181C). Further, the capacitive element CD maintains (holds) the voltage included in the data signal VDATA.

During a period after the period PWR, the voltage supplied to the first node N1 maintains the voltage Vnu (reference voltage VREF, 2.2 V), the voltage supplied to the second node N2 maintains a voltage Vnl (for example, 4 V), and the voltage supplied to the third node N3 (sixth node N6) maintains 0 V. Further, similar to the period PWR, in the period after the period PWR, the capacitive element CD maintains the potential difference (1.8 V with respect to the first node N1) by holding the charge corresponding to the potential difference between the voltage supplied to the first node N6 and the voltage supplied to the third node N3 (the sixth node N6), and the capacitive element CV maintains the potential difference (2.2 V with respect to the sixth node N6) by holding the charge corresponding to the potential difference between the voltage supplied to the first node N1 and the voltage supplied to the third node N3 (the sixth node N6). That is, the potential difference Vgs is 4 V.

In the emission period PEM of the Kth FRAME after the period PWR of the Kth FRAME, the potential difference Vgs is a sum of the potential difference held in the capacitive element CD and the potential difference held in the capacitive element CV (the voltage (voltage VSIGH, 4 V) of the data signal VDATA−the reset voltage VRES (1 V)+the threshold voltage VTH (1 V)=4 V). In the pixel 180C (pixel circuit 181C) in which the data signal VDATA includes the voltage VSIGH, since the potential difference Vgs is 4 V and the second transistor T2 is in the on state, the current Ion flows from the drive power supply line PVDD to the light emitting element OLED and the standard voltage line PVSS, and the light emitting element OLED emits light. For example, the pixel 180C that emits red light, the pixel 180C that emits blue light, and the pixel 180C that emits green light emit light respectively, and three pixels using the pixel 180C that emits red light, the pixel 180C that emits blue light, and the pixel 180C that emits green light become white.

The second example of the display device according to the fourth embodiment has the same effects as those described in section of “4-2-1. First Example of Method for Driving Display Device according to Fourth Embodiment”.

### [4-2-3. Third Example of Method for Driving Display Device According to Fourth Embodiment]

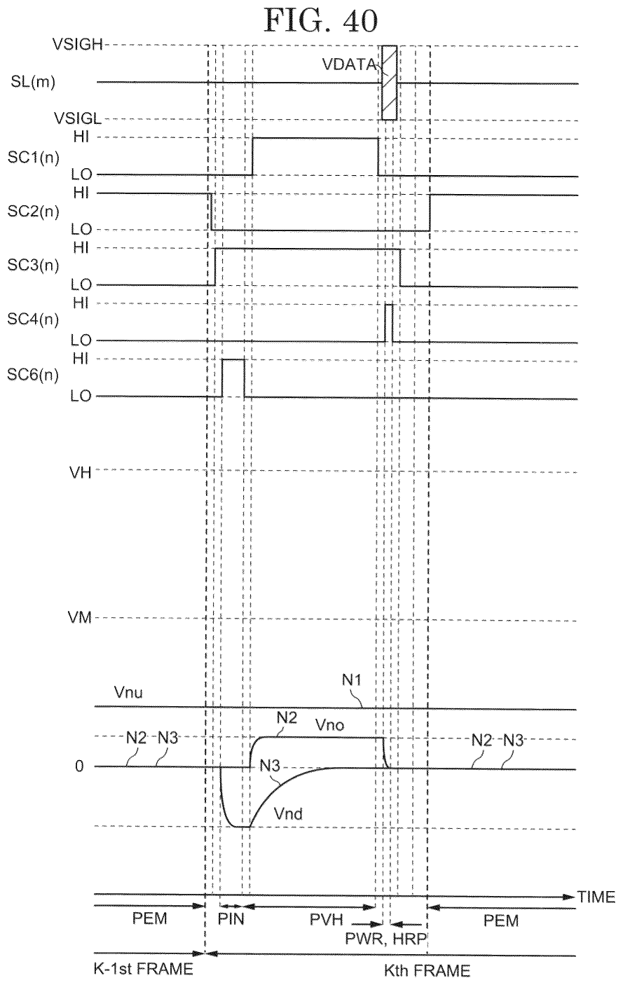

A third example of the display device according to the fourth embodiment will be described with reference to FIG. 40. A driving method shown in the third example of the display device according to the fourth embodiment includes displaying images of the same color (black) in consecutive frames as in the third example of the method for driving the display device 10 according to the first embodiment. Configurations that are the same as or similar to those in FIG. 1 to FIG. 39 will be described as necessary.

The voltage (potential) and the like of the respective nodes from the period PVH of the Kth FRAME to the emission period PEM of the Kth FRAM are the same as those described in section of “4-2-1. First Example of Method for Driving Display Device according to Fourth Embodiment”. Further, the configuration of each scan signal and the operation of each transistor in each period are the same as those described in section of “4-2-1. First Example of Method for Driving Display Device according to Fourth Embodiment”. Therefore, configurations and the like similar to those described in section of “4-2-1. First Example of Method for Driving Display Device according to Fourth Embodiment” will be described as necessary.

In the emission period PEM of the K−1 st FRAME, the voltage supplied to the first node N1 is the voltage Vnu (reference voltage VREF, 2.2 V). Further, the voltage supplied to the second node N2 and the voltage supplied to the third node N3 (the sixth node N6) are 0 V, and the potential difference Vgs is 0 V. Therefore, the second transistor T2 is in the off state, the current Ion does not flow, and the light-emitting element OLED does not emit light.

Consequently, the pixel 180C (pixel circuit 181C) emitting red light becomes black. Similar to the pixel 180C that emits red light, the pixel 180C that emits blue light and the pixel 180C that emits green light do not emit light, and therefore, three pixels using the pixel 180C that emits red light, the pixel 180C that emits blue light, and the pixel 180C that emits green light become black.

In the period between the light emission period PEM of the K−1st FRAME and the period PIN of the Kth FRAME following the light emission period PEM of the K−1 st FRAME, or in the period PIN of the Kth FRAME, the potential difference between the first electrode 32 and the second electrode 34 of the light-emitting element OLED becomes 0 V, the first node N1 is supplied with the reference voltage VREF (2.2 V, the voltage Vnu) and maintains the voltage Vnu, the third node N3 (the sixth node N6) is supplied with the initialization voltage VINI (−2 V, the voltage Vnd), and the voltage supplied to the third node N3 and the sixth node N6 becomes the voltage Vnd. The voltage supplied to the second node N2 (the gate electrode 622 of the second transistor T2) maintains 0 V. The potential difference Vgs temporarily becomes 2 V (0 V−(−2 V)), the second transistor T2 is in the on state, and the voltage supplied to the fourth node N4 is the voltage Vnd (−2 V).

As described above, in the period PIN, the third node N3 (the sixth node N6) and the fourth node N4 are initialized by the initialization voltage VINI, and the first node N1 is initialized by the reference voltage VREF.

In the period PVH following the period PIN, the second node N2 and the fourth node N4 are supplied with the reset voltage VRES (1 V, the voltage Vno), and the voltage supplied to the second node N2 and the fourth node N4 becomes the voltage Vno. The first node N1 maintains the voltage Vnq. Further, the fourth transistor T4, the fifth transistor T5, and the seventh transistor T7 are in the off state, the second transistor T2 is in the on state, the current Ion flows, and the fourth transistor T4 is in the off state, whereby the third node N3 is released, the current Ion flows to the third node N3 (the sixth node N6), the third node N3 (the sixth node N6) is charged, and the potential of the third node N3 (the sixth node N6) rises. When the potential difference Vgs between the voltage supplied to the second node N2 and the fourth node N4 and the voltage supplied to the third node N3 (the sixth node N6) becomes the threshold voltage VTH, the second transistor T2 is turned to the off state. In this case, since the reset voltage VRES (1 V, the voltage Vno) is supplied to the second node N2 and the fourth node N4, the voltage supplied to the third node N3 (the sixth node N6) in the case where the potential difference Vgs becomes the threshold voltage VTH is 0 V.

As described above, in the period PVH, similar to the configuration described in section of “4-2-1. First Example of Method for Driving Display Device according to Fourth Embodiment”, by the operation in which the potential difference Vgs of the second transistor T2 becomes the same as the threshold voltage VTH, the threshold voltage VTH of the second transistor T2 is acquired, and a charge corresponding to the threshold voltage VTH is held in the capacitive element CV.

In the period PWR following the period PVH, the data signal VDATA is written in the pixel 180C (pixel circuit 181C) in the same manner as in the configuration described in section of “4-2-1. First Example of Method for Driving Display Device according to Fourth Embodiment”. The capacitive element CD maintains (holds) the voltage included in the data signal VDATA.

In the period after the period PWR and the emission period PEM of the Kth FRAME following the period after the period PWR, the pixel circuit 181C operates in the same manner as in the configuration described in section of “4-2-1. First Example of Method for Driving Display Device according to Fourth Embodiment”, the potential difference Vgs is 0 V, and the second transistor T2 is in the off state, so that the current Ion does not flow and the light-emitting element OLED does not emit light. As a consequence, three pixels using the pixel 180C that emits red light, the pixel 180C that emits blue light, and the pixel 180C that emits green light become black.

The third example of the display device according to the fourth embodiment has the same effects as those described in section of “4-2-1. First Example of Method for Driving Display Device according to Fourth Embodiment”.

### [4-2-4. Fourth Example of Method for Driving the Display Device According to Fourth Embodiment]

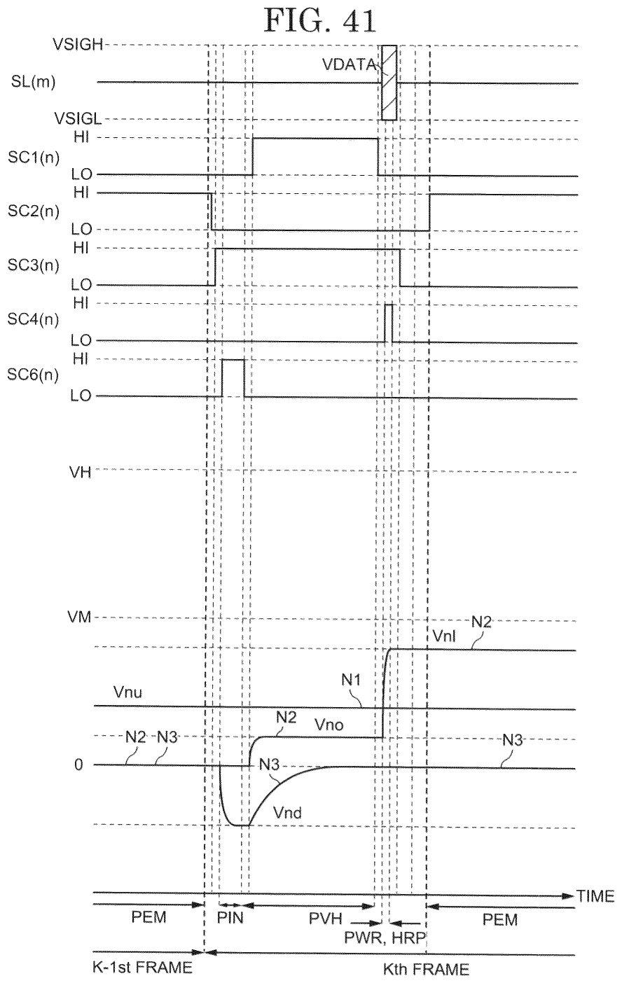

A fourth example of the display device according to the fourth embodiment will be described with reference to FIG. 41. A driving method shown in the fourth example of the display device according to the fourth embodiment includes displaying images of different colors in consecutive frames as in the fourth example of the method for driving the display device 10 according to the first embodiment. Configurations that are the same as or similar to those in FIG. 1 to FIG. 40 will be described as necessary.

The voltage (potential) of each node from the emission period PEM of the K−1st FRAME to the period PVH of the Kth FRAME, the configuration of each scan signal, the operation of each transistor, and the like are the same as those described in section of “4-2-3. Third Example of Method for Driving Display Device according to Fourth Embodiment”. Further, the voltage (potential) of each node, the configuration of each scan signal, the operation of each transistor, and the like from the period after the period PVH of the Kth FRAME to the light emission period PEM of the Kth FRAME are the same as those described in section of “4-2-2. Second Example of Method for Driving Display Device according to Fourth Embodiment”. Therefore, the description thereof will be omitted.

The fourth example of the display device according to the fourth embodiment has the same operational effects as those described in section of “4-2-1. First Example of Method for Driving Display Device according to Fourth Embodiment”.

As the embodiment of the present invention, each of the embodiments described above or a part of each of the embodiments described above can be appropriately combined as long as they do not conflict with each other.

It is understood that another effect different from that provided by each of the aforementioned embodiments is achieved by the present invention if the effect is obvious from the description in the specification or readily conceived by persons ordinarily skilled in the art.

What is claimed is:

1. A display device comprising:
a plurality of pixels arranged in a matrix in a first direction and a second direction intersecting the first direction;
an image data signal line, a second terminal of a second capacitive element, and a second terminal of a fourth transistor supplied with a data voltage;
an initialization voltage power supply line supplied with an initialization voltage;
a reference voltage power supply line and a first terminal of the second capacitive element supplied with a reference voltage;
a standard voltage line supplied with a standard voltage; and
a power supply line, a first terminal of a first capacitive element, a first terminal of a fifth transistor, and a first terminal of a light-emitting element supplied with a constant voltage,
wherein
each of the plurality of pixels includes
a first transistor controlled by a first control signal and electrically connected between the image data signal line and the second terminal of the second capacitive element,
a second transistor including a gate electrode electrically connected to the first terminal of the first capacitive element and electrically connected between the second terminal of the fourth transistor electrically connected to the second terminal of the second capacitive element and the first terminal of the fifth transistor,
a third transistor controlled by a second control signal and electrically connected between the first terminal of the first capacitive element and the first terminal of the fifth transistor,
the fourth transistor controlled by a third control signal and electrically connected between the initialization voltage power supply line and a first terminal of the second transistor,
the fifth transistor controlled by a fourth control signal and electrically connected between a second terminal of the second transistor and the first terminal of the light-emitting element,
a sixth transistor controlled by a fifth control signal and electrically connected between the reference voltage power supply line and the first terminal of the second transistor,
a seventh transistor controlled by a sixth control signal and electrically connected between the reference voltage line and the second terminal of the fourth transistor,
an eighth transistor controlled by the fifth control signal and electrically connected between the power supply line and the first terminal of the light-emitting element,
the first capacitive element electrically connected between the first terminal of the second capacitive element and the gate electrode,
the second capacitive element electrically connected between the second terminal of the first capacitive element and a second terminal of the first transistor, and
a light-emitting element electrically connected between the power supply line and a second terminal of the fifth transistor.

2. The display device according to claim 1,
wherein
the second control signal also serves as the third control signal.

3. The display device according to claim 2, further comprising a control circuit outputting the first control signal, the second control signal, the fourth control signal, the fifth control signal, and the sixth control signal,
wherein the control circuit is configured to control holding a potential difference corresponding to the data voltage in the second capacitive element after holding a potential difference corresponding to a threshold voltage of the second transistor in the first capacitive element.

4. The display device according to claim 1, further comprising a ninth transistor whose switching is controlled by the sixth control signal and electrically connected between the second terminal of the second capacitive element and the second terminal of the fourth transistor,
wherein the second control signal serves as both the third control signal and the fifth control signal.

5. The display device according to claim 4, further comprising a control circuit outputting the first control signal, the second control signal, the fourth control signal, and the sixth control signal,
wherein the control circuit is configured to control the simultaneous execution of holding a potential difference corresponding to a threshold voltage of the second transistor in the first capacitive element and to hold a potential difference corresponding to the data voltage in the second capacitive element.

6. The display device according to claim 5,
wherein the control circuit is configured to control turning on the first transistor using the first control signal and supplying the data voltage to the second terminal of the second capacitive element before the simultaneous execution.

7. The display device according to claim 5,
wherein the control circuit includes a shift register circuit and a scan driver circuit electrically connected to the shift register circuit,
wherein the scan driver circuit is configured to control generating a plurality of the first control signals, the second control signals, the fourth control signals, and the sixth control signals at different timings for a plurality of the pixels adjacent in the second direction in response to an output signal output by the shift register circuit.

8. The display device according to claim 1, further comprising:
a control voltage power supply line supplied with a control voltage different from the initialization voltage; and
a ninth transistor controlled by a seventh control signal and electrically connected between a control voltage power line supplied with a control voltage different from the initialization voltage and the second terminal of the second transistor.

9. The display device according to claim 1, further comprising a control circuit outputting the first control signal, the second control signal, the third control signal, the fourth control signal, the fifth control signal, and the seventh control signal,
wherein the control circuit is configured to control holding a potential difference corresponding to the data voltage in the second capacitive element after holding a potential difference corresponding to the threshold voltage of the second transistor in the first capacitive element.

10. The display device according to claim 9,
wherein
the control circuit is configured to control turning off the first transistor using the first control signal, turning off the fourth transistor using the third control signal, turning off the fifth transistor and the seventh transistor using the fourth control signal, turning on the sixth transistor using the fifth control signal, supplying the reference voltage to the first terminal of the second capacitive element, turning on the third transistor using the second control signal, turning on the ninth transistor using the seventh control signal, and supplying the control voltage to the gate electrode and the second terminal of the second transistor before the first capacitive element holds a potential difference equivalent to the threshold voltage of the second transistor.

11. A display device comprising:
a plurality of pixels arranged in a matrix in a first direction and a second direction intersecting the first direction;
an image data signal line, a first terminal of a first capacitive element, and a second terminal of a fourth transistor supplied with a data voltage;
an initialization voltage power supply line supplied with an initialization voltage;
a reference voltage power supply line and a second terminal of the first capacitive element supplied with a reference voltage;
a standard voltage line supplied with a standard voltage;
a power supply line, a second terminal of a second capacitive element, a first terminal of a fifth transistor, and a first terminal of a light-emitting element supplied with a constant voltage; and
a reset voltage power supply line supplied with a reset voltage,
wherein
each of the plurality of pixels includes
a first transistor controlled by a first control signal and electrically connected between the image data signal line and the second terminal of the second capacitive element,
a second transistor having a gate electrode electrically connected to the second terminal of the second capacitive element and electrically connected between the second terminal of the fourth transistor and the first terminal of the fifth transistor,
a third transistor controlled by a second control signal and electrically connected between the gate electrode and the first terminal of the fifth transistor,
the fourth transistor controlled by a third control signal and electrically connected between the initialization voltage power supply line and a second terminal of the fourth transistor,
the fifth transistor controlled by a fourth control signal and electrically connected between the second terminal of the second transistor and the first terminal of the light-emitting element,
a sixth transistor controlled by a fifth control signal and electrically connected between the reference voltage power supply line and the second terminal of the first capacitive element,
a seventh transistor controlled by the fourth control signal and electrically connected between the reference voltage power supply line and the second terminal of the fourth transistor,
an eighth transistor controlled by the fifth control signal and electrically connected between the power supply line and the first terminal of the light-emitting element,
a ninth transistor controlled by the second control signal and electrically connected between the reset voltage power supply line and the first terminal of the fifth transistor,
the second capacitive element electrically connected between the second terminal of the first capacitive element and the gate electrode,
the first capacitive element electrically connected between a first terminal of the second capacitive element and the second terminal of the fourth transistor, and
the light-emitting element electrically connected between the power supply line and a second terminal of the fifth transistor.

12. The display device according to claim 11, further comprising a control circuit outputting the first control signal, the second control signal, the third control signal, the fourth control signal, and the fifth control signal,
wherein the control circuit is configured to control holding a potential difference corresponding to the data voltage in the second capacitive element after holding a potential difference corresponding to a threshold voltage of the second transistor in the first capacitive element.

13. The display device according to claim 11,
wherein the reference voltage is different from the initialization voltage,
wherein the reference voltage and the initialization voltage are greater than the standard voltage and less than the constant voltage.

14. The display device according to claim 11,
wherein the data voltage is an analog voltage equal to or greater than a first voltage and equal to or less than a second voltage greater than the first voltage,
wherein the reference voltage is an intermediate potential between the first voltage and the second voltage.

15. The display device according to claim 11,
wherein a capacitance value of the second capacitive element is greater than a capacitance value of the first capacitance element.

16. The display device according to claim 1,
wherein the first transistor, the second transistor, the third transistor, the fourth transistor, the fifth transistor, the sixth transistor, the seventh transistor, and the eighth transistor are n-channel type field effect transistors,
wherein each channel region of the first transistor, the second transistor, the third transistor, the fourth transistor, the fifth transistor, the sixth transistor, the seventh transistor, and the eighth transistor includes an oxide semiconductor.

17. The display device according to claim 8,
wherein the first transistor, the second transistor, the third transistor, the fourth transistor, the fifth transistor, the sixth transistor, the seventh transistor, the eighth transistor, and the ninth transistor are n-channel type field effect transistors,
wherein each channel region of the first transistor, the second transistor, the third transistor, the fourth transistor, the fifth transistor, the sixth transistor, the seventh transistor, the eighth transistor, and the ninth transistor includes an oxide semiconductor.

18. The display device according to claim 11,
wherein the first transistor, the second transistor, the third transistor, the fourth transistor, the fifth transistor, the sixth transistor, the seventh transistor, the eighth transistor, and the ninth transistor are n-channel type field effect transistors,
wherein each channel region of the first transistor, the second transistor, the third transistor, the fourth transistor, the fifth transistor, the sixth transistor, the seventh transistor, the eighth transistor, and the ninth transistor includes an oxide semiconductor.
